(19) United States
(12) Patent Application Publication
(10) Pub. No.: US 2025/0241300 A1
(43) Pub. Date: Jul. 31, 2025

(54) AGRICULTURAL COMPOSITIONS FOR IMPROVED CROP PRODUCTIVITY AND ENHANCED PHENOTYPES

(71) Applicant: Spogen Biotech Inc., St. Louis, MO (US)

(72) Inventor: Brian M. Thompson, Creve Coeur, MO (US)

(21) Appl. No.: 19/182,418

(22) Filed: Apr. 17, 2025

Related U.S. Application Data
(63) Continuation of application No. 15/944,259, filed on Apr. 3, 2018, now abandoned.
(60) Provisional application No. 62/481,116, filed on Apr. 3, 2017.

(51) Int. Cl. A01N 25/30; A01N 25/02; A01N 31/02; A01N 37/02; A01N 37/44; A01N 43/36; A01N 43/54; A01N 43/653; A01N 59/02; A01N 59/26; C05G 3/00

(52) U.S. Cl. CPC A01N 25/30; A01N 25/02; A01N 31/02; A01N 37/02; A01N 37/44; A01N 43/36; A01N 43/54; A01N 43/653; A01N 59/02; A01N 59/26; C05G 3/00

(57) ABSTRACT

Provided herein are agricultural compositions, kits, and methods for improving crop productivity and enhancing plant phenotypes. Generally, the compositions and kits comprise an osmoprotectant and one or both of an anti-desiccant and an anti-respirant. Additional compositions and kits are provided that comprise an anti-dessicant and an anti-respirant. Further compositions and kits are provided that comprise a first osmoprotectant and a second osmoprotectant, the first and second osmoprotectants being different from one another. The methods provided herein generally comprise exogenously applying the agricultural composition to a plant.

### CROSS-REFERENCE TO RELATED APPLICATION

This application is a continuation of U.S. application Ser. No. 15/944,259, filed Apr. 3, 2018, which claims the benefit of U.S. Provisional Application Ser. No. 62/481,116, filed Apr. 3, 2017, the entire contents of which are incorporated herein by reference.

### FIELD OF THE INVENTION

The present disclosure generally relates to agricultural compositions for improved crop productivity and enhanced phenotypes.

### BACKGROUND OF THE INVENTION

Osmoprotectants or compatible solutes are small molecules that act as osmolytes or osmotic regulatory agents and can provide benefits to plants and plant parts during periods of osmotic stress. In general, certain osmoprotectants play key roles in planta and function in osmotic regulation and adjustments during times of abiotic stress. Metabolites that function as osmoprotectants include betaines, such as glycine betaine and betaine hydrochloride, sugars, sugar alcohols, and select amino acids, such as proline. Many osmoprotectants accumulate in plants under abiotic stress conditions, such as water deficit, heat, drought, flood, cold, salt, humidity, radiation, and UV stresses.

Osmolytes can accumulate in plants during exposure to abiotic or environmental stress and can impart stress tolerance to plants by maintaining cell turgor and osmotic balance. In addition, certain osmoprotectants are effective in plants exposed to periodic abiotic stresses and function in providing stress tolerance by the stabilization of plant membranes, thereby promoting membrane integrity, which acts to prevent electrolyte leakage and protein denaturation. Increase in osmolytes in plants exposed to stress can also function as an anti-oxidative defense that acts to buffer oxidative reactions and cellular redox potential under stress conditions. Therefore, the accumulation of select compounds exhibiting osmoprotectant properties in a plant can contribute to stress tolerance in plants exposed to a range of abiotic stresses without having a detrimental effect on plant metabolism.

A decrease in water availability to a plant due to drought, heat, cold and salt stresses can have a direct impact on crop growth and productivity. Some plants have evolved to mitigate the effects of some of these stresses. However, the impacts from prolonged exposure of crops/plants to anyone of these abiotic stressors identified with water availability can have negative effects on growth, productivity and yield.

The present invention seeks to provide agricultural compositions comprising an osmoprotectant, and methods of using these agricultural compositions, in order to help protect plants against abiotic stressors while also providing improved crop productivity and enhanced phenotypic characteristics.

### SUMMARY OF THE INVENTION

In one aspect of the present invention, an agricultural composition is provided comprising an osmoprotectant, an anti-desiccant, and an anti-respirant, wherein each of the osmoprotectant, the anti-desiccant, and the anti-respirant are different from one another.

Alternatively, the agricultural composition can comprise an osmoprotectant and an anti-desiccant or an osmoprotectant and an anti-respirant. Where the composition comprises an osmoprotectant and an anti-respirant, the osmoprotectant and the anti-desiccant are different from one another. Where the composition comprises an osmoprotectant and an anti-respirant, the osmoprotectant and the anti-repsirant are different from one another.

A further agricultural composition is provided. The agricultural composition comprises a first osmoprotectant and a second osmoprotectant. The first and second osmoprotectants are different from one another.

Also provided herein are agricultural compositions comprising an anti-desiccant and an anti-respirant, wherein the anti-desiccant and the anti-respirant are different from one another.

Also provided herein is a kit comprising an osmoprotectant, an anti-desiccant, an anti-respirant, and instructions for applying the osmoprotectant, the anti-desiccant, and the anti-respirant to a plant for increasing crop productivity. The the osmoprotectant, the anti-desiccant, and the anti-respirant are different from one another.

Further provided is a kit comprising an osmoprotectant, an anti-desiccant, and instructions for applying the osmoprotectant and the anti-desiccant to a plant for increasing crop productivity. The osmoprotectant and the anti-desiccant are different from one another.

Also provided herein is a kit comprising an osmoprotectant, an anti-respirant, and instructions for applying the osmoprotectant and the anti-respirant to a plant for increasing crop productivity. The osmoprotectant and the anti-respirant are different from one another.

Also provided herein is a kit comprising a first osmoprotectant, a second osmoprotectant, and instructions for applying the first osmoprotectant and the second osmoprotectant to a plant for increasing crop productivity. The first osmoprotectant and the second osmoprotectant are different from one another.

Further provided herein is a kit comprising an anti-desiccant, an anti-respirant, and instructions for applying the anti-desiccant and the anti-repsirant to a plant for increasing crop productivity. The anti-desiccant and anti-respirant are different from one another.

Also provided herein is a method for increasing crop productivity of a plant as compared with an untreated plant. The method comprises optionally diluting in a suitable volume of water an effective amount of a composition described herein to form an application composition, and exogenously applying the composition to the plant. The untreated plant is not treated with the composition but is subject to the same conditions as the plant.

Also provided herein is a method for increasing crop productivity of a plant as compared with an untreated plant. The method comprises exogenously applying to the plant an osmoprotectant, an anti-desiccant, and an anti-respirant within a treatment period, the untreated plant not being treated with the osmoprotectant, anti-desiccant, and anti-respirant but subject to the same conditions as the plant.

Also provided herein is a further method for increasing crop productivity of a plant as compared with an untreated plant. The method comprises exogenously applying to the plant an osmoprotectant and an anti-desiccant within a treatment period. The untreated plant is not treated with the osmoprotectant and the anti-desiccant but is subject to the same conditions as the plant.

Also provided herein is a further method for increasing crop productivity of a plant as compared with an untreated plant. The method comprises exogenously applying to the plant an osmoprotectant and an anti-respirant within a treatment period. The untreated plant is not treated with the osmoprotectant and the anti-respirant but is subject to the same conditions as the plant.

Also provided herein is a further method for increasing crop productivity of a plant as compared with an untreated plant. The method comprises applying to the plant an anti-desiccant and an anti-respirant within a treatment period. The untreated plant is not treated with the anti-desiccant and the anti-respirant but is subject to the same conditions as the plant.

Other objects and features will be in part apparent and in part pointed out hereinafter.

### BRIEF DESCRIPTION OF THE DRAWINGS

FIG. 1 is a graph of the bushels of corn harvested per acre (Bu/Ac), treated with betaine and proline compositions at the VT stage of development.

FIG. 2 is a graph of the bushels of corn harvested per acre (Bu/Ac), treated with a betaine composition and a fungicide.

FIG. 3 is a graph of the bushels of corn harvested per acre (Bu/Ac), treated with betaine and proline compositions at the V5-V8 stage of development.

FIG. 4 provides graphs showing the bushels of corn harvested per acre (Bu/Ac), treated at two stages of development with betaine and proline compositions.

FIG. 5 provides graphs of the bushels of corn harvested per acre (Bu/Ac), treated in large scale strip trials with betaine and proline compositions at the V5 stage of development.

FIG. 6 is a graph of the bushels of soybean harvested per acre (Bu/Ac), treated with betaine and proline compositions at the R2 stage of development.

FIG. 7 is a graph of the changes in water movement and turgor in corn treated with a betaine composition.

FIG. 8 provides representative photomicrographs of the outer epidermal section of soybean plants. Panel A of FIG. 8 provides a representative pre-treated control image. Panel B of FIG. 8 provides a representative image from a betaine HCl-treated plant at three minutes post-treatment. Panel C of FIG. 8 provides a representative image from a betaine HCl treated plant at five minutes post-treatment.

FIG. 9 provides representative photomicrographs of the epidermal layers of three onion plants. Panels A, D, and G of FIG. 9 provide images of onion plants that were treated with a deionized water control treatment. Panels B, E, and H of FIG. 9 provide images of onion plants that were exposed to saline stress. Panels C, F, and I of FIG. 9 provide images of onion plants that were treated with agricultural compositions of the present invention.

FIG. 10 is a graph of the number of jalapeno peppers harvested versus the biomass per pepper plant in grams, treated with betaine and proline compositions.

### DETAILED DESCRIPTION OF THE INVENTION

The present invention relates to agricultural compositions for improved crop productivity and enhanced phenotypes and methods for their use. The compositions generally comprise an osmoprotectant and/or an anti-desiccant and/or an anti-respirant. The osmoprotectant and/or the anti-desiccant and/or the anti-respirant are different from one another.

A further agricultural composition is also provided. The composition comprises a first osmoprotectant and a second osmoprotectant. The first and second osmoprotectants are different from one another.

In general, there can be one or more of the osmoprotectant and/or the anti-desiccant and/or the anti-respirant in any of the compositions described herein.

Yet another agricultural composition is provided. The composition comprises an anti-desiccant and an anti-respirant. The anti-desiccant and the anti-respirant are different from one another.

Also provided herein are a kits comprising an osmoprotectant and/or an anti-desiccant and/or an anti-respirant, and instructions for applying the osmoprotectant and/or the anti-desiccant and/or the anti-respirant to a plant for increasing crop productivity. The osmoprotectant and/or the anti-desiccant and/or the anti-respirant are different from one another.

Further kits are provided. The kit comprises a first osmoprotectant, a second osmoprotectant, and instructions for applying the first osmoprotectant and the second osmoprotectant to a plant for increasing crop productivity. The first osmoprotectant and the second osmoprotectant are different from one another.

The methods provided herein generally comprise applying the composition to a plant.

In the compositions, kits, methods of the present invention, the osmoprotectant functions to improve membrane integrity and stability. The anti-desiccant is used to aid in the retention of water in the plant or plant part. The anti-respirant balances photosynthetic gain with respiratory loss and can minimize water loss from transpiration. The application of the combination of an anti-desiccant or an anti-respirant with an osmoprotectant, or an anti-desiccant, an anti-respirant, and an osmoprotectant provides benefits to a plant or plant part, such as improved stress tolerance, enhanced phenotypic characteristics, and improved crop productivity. The compositions may be used prophylactically or in response to a plant's exposure to an abiotic stressor. For example, application of the compositions of the present invention have been shown to result in improved yield, improved plant growth, improved plant size, improved protection against herbicide injury, increased efficacy of an herbicide, and improved tolerance to cold, heat, ultraviolet (UV), oxidative stress and water deficit, and improved water movement, retention, turgor, and osmotic potential, among other benefits.

The composition can be provided in concentrate form.

Alternatively, the composition can be provided in ready-to-use form. By “ready-to-use,” it is meant that the composition is provided in a form that requires no additional dilution by the user, and is ready for application.

An agricultural composition is provided. The composition comprises an osmoprotectant, an anti-desiccant, and an anti-respirant.

Alternatively, the agricultural composition can comprise an osmoprotectant and an anti-desiccant or an osmoprotectant and an anti-respirant.

A further agricultural composition is provided. The agricultural composition comprises a first osmoprotectant and a second osmoprotectant, the first and second osmoprotectants being different from one another.

Yet another agricultural composition is provided. The composition comprises an anti-desiccant and an anti-respirant.

In the compositions described herein, the osmoprotectant(s), anti-desiccant(s) and/or anti-respirant(s) are present in the composition in agriculturally effective amounts.

Kits are also provided herein as described further hereinbelow.

The components of the agricultural composition and concentrations of components described herein apply equally to any of the kits described herein and any of the methods described herein comprising exogenously applying to a plant an osmoprotectant and/or an anti-desiccant and/or an anti-respirant. Thus, any of the kits described herein can contain any of the osmoprotectants, any of the anti-respirants, and/or any of the anti-desiccants described herein, at any of the concentrations described herein. Likewise, in any of the methods described herein, the method can comprise exogenously applying to plant any of the osmoprotectants, any of the anti-respirants, and/or any of the anti-desiccants described herein, at any of the concentrations described herein.

Osmolytes which encompass betaines, prolines, other amino acids, select carbohydrates, and sugar alcohols are compatible with enzymes and can function in the stabilization of cell membranes and in the maintenance of membrane integrity.

The osmoprotectant(s) can comprise a betaine, a proline, an analog or homolog of betaine or proline, a sugar alcohol, a carbohydrate, an amino acid, an amino acid derivative, a quaternary ammonium salt, or a combination of any thereof.

Preferably, the osmoprotectant(s) comprises a betaine, a proline, or a combination, homolog, or analog of any thereof.

Where the composition is provided in concentrate form, the concentrate composition can comprise the osmoprotectant, or the first osmoprotectant and/or the second osmoprotectant, in an amount of from about 0.05% to about 8.5%, based on the total weight/volume (w/v) of the concentrate composition, such as from about 0.08% to about 8.23%, about 0.08% to about 0.27%, from about 0.85% to about 3.17%, or from about 5.66% to about 8.23%, based on the total w/v of the concentrate composition.

For example, the composition can comprise the osmoprotectant, or the first osmoprotectant and/or the second osmoprotectant, in an amount from about 0.05% to about 8.5%, based on the total weight/volume of the concentrate composition.

The composition can comprise the osmoprotectant, or the first osmoprotectant and/or the second osmoprotectant, in an amount from about 0.08% to about 8.23%, based on the total weight/volume of the concentrate composition.

The composition can comprise the osmoprotectant, or the first osmoprotectant and/or the second osmoprotectant, in an amount from about 0.08% to about 0.27%, based on the total weight/volume of the concentrate composition.

The composition can comprise the osmoprotectant, or the first osmoprotectant and/or the second osmoprotectant, in an amount from about 0.85% to about 3.17%, based on the total weight/volume of the concentrate composition.

The composition can comprise the osmoprotectant, or the first osmoprotectant and/or the second osmoprotectant, in an amount from about 5.66% to about 8.23%, based on the total weight/volume of the concentrate composition.

Where the composition is provided in concentrate form, the concentrate composition can comprise the osmoprotectant, or the first osmoprotectant and/or the second osmoprotectant, in an amount of from about 5 mM to about 4 M, based on the total molarity of the concentrate composition, such as from about 5 mM to about 700 mM, 5.57 mM to about 658.62 mM, from about 5.57 mM to about 21.95 mM, from about 55.66 mM to about 83.49 mM, from about 163.88 mM to about 247.37 mM, from about 491.64 mM to about 658.62 mM, from about 35 mM to about 4 M, from about 100 mM to about 4 M, from about 250 mM to about 4 M, or from about 500 mM to about 4 M, based on the total molarity of the concentrate composition.

For example, the concentrate composition can comprise the osmoprotectant, or the first osmoprotectant and/or the second osmoprotectant, in an amount of from about 5 mM to about 4 M, based on the total molarity of the concentrate composition.

For example, the concentrate composition can comprise the osmoprotectant, or the first osmoprotectant and/or the second osmoprotectant, in an amount of from about 5 mM to about 700 mM, based on the total molarity of the concentrate composition.

The concentrate composition can comprise the osmoprotectant, or the first osmoprotectant and/or the second osmoprotectant, in an amount of from about 5.57 mM to about 658.62 mM, based on the total molarity of the concentrate composition.

The concentrate composition can comprise the osmoprotectant, or the first osmoprotectant and/or the second osmoprotectant, in an amount of from about 5.57 mM to about 21.95 mM, based on the total molarity of the concentrate composition.

The concentrate composition can comprise the osmoprotectant, or the first osmoprotectant and/or the second osmoprotectant, in an amount of from about 55.66 mM to about 83.49 mM, based on the total molarity of the concentrate composition.

The concentrate composition can comprise the osmoprotectant, or the first osmoprotectant and/or the second osmoprotectant, in an amount of from about 163.88 mM to about 247.37 mM, based on the total molarity of the concentrate composition.

The concentrate composition can comprise the osmoprotectant, or the first osmoprotectant and/or the second osmoprotectant, in an amount of from about 491.64 mM to about 658.62 mM, based on the total molarity of the concentrate composition.

The concentrate composition can comprise the osmoprotectant, or the first osmoprotectant and/or the second osmoprotectant, in an amount of from about 35 mM to about 4 M, based on the total molarity of the concentrate composition.

The concentrate composition can comprise the osmoprotectant, or the first osmoprotectant and/or the second osmoprotectant, in an amount of from about 100 mM to about 4 M, based on the total molarity of the concentrate composition.

The concentrate composition can comprise the osmoprotectant, or the first osmoprotectant and/or the second osmoprotectant, in an amount of from about 250 mM to about 4 M, based on the total molarity of the concentrate composition.

The concentrate composition can comprise the osmoprotectant, or the first osmoprotectant and/or the second osmoprotectant, in an amount of from about 500 mM to about 4 M, based on the total molarity of the concentrate composition.

When the composition is a ready-to-use composition (also referred to herein as an application composition), the composition comprises the osmoprotectant, or the first osmoprotectant and/or the second osmoprotectant, in an amount of from about 0.00010% to about 17%, based on the total weight/volume (w/v) of the ready-to-use composition, such as from about 0.00010% to about 0.05%, from about 0.00015% to about 0.032%, from about 0.00015% to about 0.05%, from about 0.01% to about 0.02%, from about 0.022% to about 0.032%, from about 0.05% to about 0.25%, from about 1.5% to about 6.0%, or from about 6.5% to about 17%, based on the total weight/volume (w/v) of the ready-to-use composition.

For example, the ready-to-use composition can comprise the osmoprotectant, or the first osmoprotectant and/or the second osmoprotectant, in an amount of from about 0.00010% to about 17%, based on the total weight/volume (w/v) of the ready-to-use composition.

The ready-to-use composition can comprise the osmoprotectant, or the first osmoprotectant and/or the second osmoprotectant, in an amount of from about 0.00010% to about 0.05%, based on the total weight/volume (w/v) of the ready-to-use composition.

The ready-to-use composition can comprise the osmoprotectant, or the first osmoprotectant and/or the second osmoprotectant, in an amount of from about 0.00015% to about 0.032%, based on the total weight/volume (w/v) of the ready-to-use composition.

The ready-to-use composition can comprise the osmoprotectant, or the first osmoprotectant and/or the second osmoprotectant, in an amount of from about 0.00015% to about 0.005%, based on the total weight/volume (w/v) of the ready-to-use composition.

The ready-to-use composition can comprise the osmoprotectant, or the first osmoprotectant and/or the second osmoprotectant, in an amount of from about 0.01% to about 0.02%, based on the total weight/volume (w/v) of the ready-to-use composition.

The ready-to-use composition can comprise the osmoprotectant, or the first osmoprotectant and/or the second osmoprotectant, in an amount of from about 0.022% to about 0.032%, based on the total weight/volume (w/v) of the ready-to-use composition.

The ready-to-use composition can comprise the osmoprotectant, or the first osmoprotectant and/or the second osmoprotectant, in an amount of from about 0.05% to about 0.25%, based on the total weight/volume (w/v) of the ready-to-use composition.

The ready-to-use composition can comprise the osmoprotectant, or the first osmoprotectant and/or the second osmoprotectant, in an amount of from about 1.5% to about 6.0%, based on the total weight/volume (w/v) of the ready-to-use composition.

The ready-to-use composition can comprise the osmoprotectant, or the first osmoprotectant and/or the second osmoprotectant, in an amount of from about 6.5% to about 17%, based on the total weight/volume (w/v) of the ready-to-use composition.

When the composition is a ready-to-use composition (also referred to herein as an application composition), the composition comprises the osmoprotectant, or the first osmoprotectant and/or the second osmoprotectant, in a concentration of from about 5 μM to about 1.3 M, based on the total molarity of the application composition, such as from about 5 μM to about 1300 μM, 10 μM to about 1280 mM, from about 10 μM to about 155 μM, from about 200 μM to about 450 mM, or from about 800 μM to about 1280 μM, based on the total molarity of the application composition.

For example, the ready-to-use composition can comprise the osmoprotectant, or the first osmoprotectant and/or the second osmoprotectant, in a concentration of from about 5 μM to about 1.3 M, based on the total molarity of the ready-to-use composition.

The ready-to-use composition can comprise the osmoprotectant, or the first osmoprotectant and/or the second osmoprotectant, in a concentration of from about 5 μM to about 1300 μM, based on the total molarity of the ready-to-use composition.

The ready-to-use composition can comprise the osmoprotectant, or the first osmoprotectant and/or the second osmoprotectant, in a concentration of from about 10 μM to about 1280 mM, based on the total molarity of the ready-to-use composition.

The ready-to-use composition can comprise the osmoprotectant, or the first osmoprotectant and/or the second osmoprotectant, in a concentration of from about 10 μM to about 155 μM, based on the total molarity of the ready-to-use composition.

The ready-to-use composition can comprise the osmoprotectant, or the first osmoprotectant and/or the second osmoprotectant, in a concentration of from about 200 μM to about 450 mM, based on the total molarity of the ready-to-use composition.

The ready-to-use composition can comprise the osmoprotectant, or the first osmoprotectant and/or the second osmoprotectant, in a concentration of from about 800 μM to about 1280 μM, based on the total molarity of the ready-to-use composition.

The betaine can comprise glycine betaine, glycine betaine aldehyde, β-alanine betaine, betaine hydrochloride, cetyl betaine, proline betaine, choline-O-sulfate betaine, cocaamidopropyl betaine, oleyl betaine, sulfobetaine, lauryl betaine, octyl betaine, caprylamidopropyl betaine, lauramidopropyl betaine, isostearamidopropyl betaine, or a combination, homolog, or analog of any thereof.

For example, the betaine can comprise glycine betaine, glycine betaine aldehyde, β-alanine betaine, betaine hydrochloride, cetyl betaine, choline-O-sulfate betaine, cocaamidopropyl betaine, oleyl betaine, sulfobetaine, lauryl betaine, octyl betaine, caprylamidopropyl betaine, lauramidopropyl betaine, isostearamidopropyl betaine, or a combination, homolog, or analog of any thereof.

The betaine can be derived from a plant source such as wheat (e.g., wheat germ or wheat bran) or a plant of the genus Beta (e.g., Beta vulgaris (beet)).

The betaine homolog or analog can comprise ectoine, choline, phosphatidylcholine, acetylcholine, cytidine disphosphate choline, dimethylethanolamine, choline chloride, choline salicylate, glycerophosphocholine, phosphocholine, a sphingomyelin, choline bitartrate, propio betaine, deanol betaine, homodeanol betaine, homoglycerol betaine, diethanol homobetaine, triethanol homobetaine, or a combination of any thereof.

Where the osmoprotectant comprises the betaine, betaine homolog, or betaine analog, the betaine, betaine homolog, or betaine analog can be present in a concentrate composition in a concentration of from about 0.05% to about 8.5%, based on the total weight/volume (w/v) of the concentrate composition, such as from about 0.05% to about 0.086%, from about 0.86% to about 2.57%, or from about 2.74% to about 8.23%, based on the total w/v of the concentrate composition.

For example, the betaine, betaine homolog, or betaine analog can be present in a concentrate composition in a concentration of from about 0.05% to about 8.5%, based on the total weight/volume (w/v) of the concentrate composition.

The betaine, betaine homolog, or betaine analog can be present in a concentrate composition in a concentration of from about 0.05% to about 0.086%, based on the total weight/volume (w/v) of the concentrate composition.

The betaine, betaine homolog, or betaine analog can be present in a concentrate composition in a concentration of from about 0.86% to about 2.57%, based on the total weight/volume (w/v) of the concentrate composition.

The betaine, betaine homolog, or betaine analog can be present in a concentrate composition in a concentration of from about 2.74% to about 8.23%, based on the total weight/volume (w/v) of the concentrate composition.

Specific exemplary concentrations of betaine in concentrate form for use applied to plants and plant products include about 0.5%, about 0.8%, about 0.85%, about 1.0%, about 1.2%, about 1.25% and about 1.5% active ingredient. Alternatively, where the osmoprotectant comprises the betaine, betaine homolog, or betaine analog, the betaine, betaine homolog, or betaine analog may be present in a concentration of from about 5 mM to about 700 mM, based on the total molarity of the concentrate composition, such as from about 5 mM to about 550 mM, from about 50 mM to about 100 mM, from about 150 mM to about 300 mM or from about 165 mM to about 700 mM based on the total molarity of the concentrate composition.

For example, the betaine, betaine homolog, or betaine analog may be present in a concentration of from about 5 mM to about 700 mM, based on the total molarity of the concentrate composition.

The betaine, betaine homolog, or betaine analog may be present in a concentration of from about 5 mM to about 550 mM, based on the total molarity of the concentrate composition.

The betaine, betaine homolog, or betaine analog may be present in a concentration of from about 50 mM to about 100 mM, based on the total molarity of the concentrate composition.

The betaine, betaine homolog, or betaine analog may be present in a concentration of from about 150 mM to about 300 mM, based on the total molarity of the concentrate composition.

The betaine, betaine homolog, or betaine analog may be present in a concentration of from about 165 mM to about 700 mM, based on the total molarity of the concentrate composition.

Where the osmoprotectant comprises the betaine, betaine homolog, or betaine analog, the betaine, betaine homolog, or betaine analog can be present in a ready-to-use composition in a concentration from about 0.00015% to about 0.5%, based on the total weight/volume (w/v) of the ready-to-use composition. Specific exemplary concentrations of betaine in ready-to-use form for use applied to plants and plant products include about 0.00015% to about 0.5%, about 0.00016% to about 0.05%, about 0.01%, to about 0.05%, and about 0.00016% to about 0.032% active ingredient based on the total w/v of the ready-to-use composition.

For example, the betaine, betaine homolog, or betaine analog can be present in a ready-to-use composition in a concentration of from about 0.00015% to about 0.5% active ingredient, based on the total weight/volume (w/v) of the ready-to-use composition.

The betaine, betaine homolog, or betaine analog can be present in a ready-to-use composition in a concentration of from about 0.00016% to about 0.5% active ingredient, based on the total weight/volume (w/v) of the ready-to-use composition.

The betaine, betaine homolog, or betaine analog can be present in a ready-to-use composition in a concentration of from about 0.01% to about 0.05% active ingredient, based on the total weight/volume (w/v) of the ready-to-use composition.

The betaine, betaine homolog, or betaine analog can be present in a ready-to-use composition in a concentration of from about 0.00016% to about 0.032% active ingredient, based on the total weight/volume (w/v) of the ready-to-use composition.

Alternatively, where the osmoprotectant comprises the betaine, betaine homolog, or betaine analog, the betaine, betaine homolog, or betaine analog can be present in a ready-to-use composition in a concentration of from about 5 μM to about 3 mM, from about 5 μM to about 1.5 mM, from about 5 μM to about 500 μM, from about 10 μM to about 100 μM, from about 150 mM to about 400 μM, from about 400 μM to about 500 μM, or from about 400 μM to about 3 mM active ingredient based on the total molarity of the ready-to-use composition.

For example, the betaine, betaine homolog, or betaine analog can be present in a ready-to-use composition in a concentration of from about 5 μM to about 3 mM active ingredient, based on the total molarity of the ready-to-use composition.

The betaine, betaine homolog, or betaine analog can be present in a ready-to-use composition in a concentration of from about 5 μM to about 1.5 mM active ingredient, based on the total molarity of the ready-to-use composition.

The betaine, betaine homolog, or betaine analog can be present in a ready-to-use composition in a concentration of from about 5 μM to about 500 μM active ingredient, based on the total molarity of the ready-to-use composition.

The betaine, betaine homolog, or betaine analog can be present in a ready-to-use composition in a concentration of from about 10 μM to about 100 μM active ingredient, based on the total molarity of the ready-to-use composition.

The betaine, betaine homolog, or betaine analog can be present in a ready-to-use composition in a concentration of from about 150 μM to about 400 μM active ingredient, based on the total molarity of the ready-to-use composition.

The betaine, betaine homolog, or betaine analog can be present in a ready-to-use composition in a concentration of from about 400 μM to about 500 μM active ingredient, based on the total molarity of the ready-to-use composition.

The betaine, betaine homolog, or betaine analog can be present in a ready-to-use composition in a concentration of from about 400 μM to about 3 mM active ingredient, based on the total molarity of the ready-to-use composition.

The proline can comprise L-proline, D-proline, hydroxyproline, hydroxyproline derivatives, proline betaine, or a combination, derivative, homolog, or analog of any thereof.

The proline homolog or analog can comprise a-methyl-L-proline, a-benzyl-L-proline, trans-4-hydroxy-L-proline, cis-4-hydroxy-L-proline, trans-3-hydroxy-L-proline, cis-3-hydroxy-L-proline, trans-4-amino-L-proline, 3,4-dehydro-a-proline, (2S)-aziridine-2-carboxylic acid, (2S)-azetidine-2-carboxylic acid, L-pipecolic acid, proline betaine, 4-oxo-L-proline, thiazolidine-2-carboxylic acid, (4R)-thiazolidine-4-carboxylic acid, or a combination of any thereof.

Where the osmoprotectant comprises the proline, proline homolog, or proline analog, the proline, proline homolog, or proline analog can be present in a concentrate composition at a concentration of from about 5 mM to about 1700 mM, based on the total molarity of the concentrate composition, such as from about 5 mM to about 500 mM, from about 10 mM to about 165 mM, or from about 160 mM to about 1640 mM, based on the total molarity of the concentrate composition.

For example, the proline, proline homolog, or proline analog can be present in a concentrate composition at a concentration of from about 5 mM to about 1700 mM, based on the total molarity of the concentrate composition.

The proline, proline homolog, or proline analog can be present in a concentrate composition at a concentration of from about 5 mM to about 500 mM, based on the total molarity of the concentrate composition.

The proline, proline homolog, or proline analog can be present in a concentrate composition at a concentration of from about 10 mM to about 165 mM, based on the total molarity of the concentrate composition.

The proline, proline homolog, or proline analog can be present in a concentrate composition at a concentration of from about 160 mM to about 1640 mM, based on the total molarity of the concentrate composition.

Alternatively, where the osmoprotectant comprises the proline, proline homolog, or proline analog, the proline, proline homolog, or proline analog can be present in a concentrate composition at a concentration of from about 0.05% to about 6%, based on the total weight/volume (w/v) of the concentrate composition, such as from about 0.1% to about 5.66%, about 0.15%, to about 1.50%, about 1.4% to about 1.8%, about 1.88% to about 2.0%, about 2.2% to about 2.6% or about 3.2% to about 5.66%, based on the total weight/volume (w/v) of the concentrate composition.

For example, the proline, proline homolog, or proline analog can be present in a concentrate composition at a concentration of from about 0.05% to about 6%, based on the total weight/volume (w/v) of the concentrate composition.

The proline, proline homolog, or proline analog can be present in a concentrate composition at a concentration of from about 0.1% to about 5.66%, based on the total weight/volume (w/v) of the concentrate composition.

The proline, proline homolog, or proline analog can be present in a concentrate composition at a concentration of from about 0.15% to about 1.50%, based on the total weight/volume (w/v) of the concentrate composition.

The proline, proline homolog, or proline analog can be present in a concentrate composition at a concentration of from about 1.4% to about 1.8%, based on the total weight/volume (w/v) of the concentrate composition.

The proline, proline homolog, or proline analog can be present in a concentrate composition at a concentration of from about 1.88% to about 2.0%, based on the total weight/volume (w/v) of the concentrate composition.

The proline, proline homolog, or proline analog can be present in a concentrate composition at a concentration of from about 2.2% to about 2.6%, based on the total weight/volume (w/v) of the concentrate composition.

The proline, proline homolog, or proline analog can be present in a concentrate composition at a concentration of from about 3.2% to about 5.66%, based on the total weight/volume (w/v) of the concentrate composition.

Alternatively, where the osmoprotectant comprises the proline, proline homolog, or proline analog, the proline, proline homolog, or proline analog can be present in a ready-to-use composition at a concentration of from about 0.0005% to about 1%, based on the total weight/volume (w/v) of the ready-to-use composition, such as from about 0.0005% to about 0.05%. Specific exemplary concentrations of proline in ready-to-use form for use applied to plants and plant products include from about 0.001% to about 0.020%, about 0.015% to about 0.030%, about 0.01% to about 0.05%, and about 0.05% to about 1.0% active ingredient based on the total w/v of the ready-to-use composition.

For example, the proline, proline homolog, or proline analog can be present in a ready-to-use composition at a concentration of from about 0.0005% to about 1%, based on the total weight/volume (w/v) of the ready-to-use composition.

The proline, proline homolog, or proline analog can be present in a ready-to-use composition at a concentration of from about 0.0005% to about 0.05%, based on the total weight/volume (w/v) of the ready-to-use composition.

The proline, proline homolog, or proline analog can be present in a ready-to-use composition at a concentration of from about 0.001% to about 0.020%, based on the total weight/volume (w/v) of the ready-to-use composition.

The proline, proline homolog, or proline analog can be present in a ready-to-use composition at a concentration of from about 0.015% to about 0.030%, based on the total weight/volume (w/v) of the ready-to-use composition.

The proline, proline homolog, or proline analog can be present in a ready-to-use composition at a concentration of from about 0.01% to about 0.05%, based on the total weight/volume (w/v) of the ready-to-use composition.

The proline, proline homolog, or proline analog can be present in a ready-to-use composition at a concentration of from about 0.05% to about 1.0%, based on the total weight/volume (w/v) of the ready-to-use composition.

Additionally, where the osmoprotectant comprises the proline, proline homolog, or proline analog, the proline, proline homolog, or proline analog can be present in a ready-to-use composition in a concentration from about 5 μM to about 1.3 M, from about 5 μM to about 500 mM, from about 5 μM to about 1300 μM, based on the total molarity of the composition, such as from about 10 μM to about 42 μM, from about 30 μM to about 424 μM, or from about 400 μM to about 1270 μM, based on the total molarity of the composition.

For example, the proline, proline homolog, or proline analog can be present in a ready-to-use composition in a concentration of from about 5 μM to about 1.3 M, based on the total molarity of the composition.

The proline, proline homolog, or proline analog can be present in a ready-to-use composition in a concentration of from about 5 μM to about 500 mM, based on the total molarity of the composition.

The proline, proline homolog, or proline analog can be present in a ready-to-use composition in a concentration of from about 5 μM to about 1300 μM, based on the total molarity of the composition.

The proline, proline homolog, or proline analog can be present in a ready-to-use composition in a concentration of from about 10 μM to about 42 μM, based on the total molarity of the composition.

The proline, proline homolog, or proline analog can be present in a ready-to-use composition in a concentration of from about 30 μM to about 424 μM, based on the total molarity of the composition.

The proline, proline homolog, or proline analog can be present in a ready-to-use composition in a concentration of from about 400 μM to about 1270 μM, based on the total molarity of the composition.

When the osmoprotectant comprises a sugar alcohol, the sugar alcohol can comprise D-mannitol, D-sorbitol, maltitol, erythritol, L-arabitol, xylitol, 1D-chiro-inositol, inositol, myo-inositol, galactinol, L-quebrachitol, D-pinitol, D-ononitol, D-myo-inositol-1,3-diphosphate, galactinol, or a combination of any thereof.

Further, when the osmoprotectant comprises a carbohydrate, the carbohydrate can comprise alpha-D-galactose, alpha-D-mannose, beta-D-mannose, beta-D-glucose, alpha-D-glucose, aldehydo-D-altrose, sucrose, D-fructose, trehalose, stachyose, raffinose, melibiose, beta-palatinose, beta-gentiobiose, beta-turanose, beta-maltose, alpha-maltose, cellobiose, or a combination of any thereof.

Where the osmoprotectant comprises the carbohydrate, the carbohydrate can be present in a ready-to-use composition at a concentration of from about 0.05% to about 17% based on the total weight/volume (w/v) of the ready-to-use composition, such as from about 0.05% to about 0.25%, from about 1.5% to about 6.0%, or from about 6.5% to about 17%, based on the total weight/volume (w/v) of the ready-to-use composition, or can be present in a concentrate composition at a concentration of from about 0.5% to about 20%, based on the total weight/volume (w/v) of the concentrate composition, such as from about 0.5% to about 17%, from about 0.5% to about 1.5%, from about 1.5% to about 10.0%, or from about 6.5% to about 17%, based on the total weight/volume (w/v) of the concentrate composition.

For example, the carbohydrate can be present in a ready-to-use composition at a concentration of from about 0.05% to about 17%, based on the total weight/volume (w/v) of the ready-to-use composition.

The carbohydrate can be present in a ready-to-use composition at a concentration of from about 0.05% to about 0.25%, based on the total weight/volume (w/v) of the ready-to-use composition.

The carbohydrate can be present in a ready-to-use composition at a concentration of from about 1.5% to about 6.0%, based on the total weight/volume (w/v) of the ready-to-use composition.

The carbohydrate can be present in a ready-to-use composition at a concentration of from about 6.5% to about 17%, based on the total weight/volume (w/v) of the ready-to-use composition.

Alternatively, the carbohydrate can be present in a concentrate composition at a concentration of from about 0.5% to about 20%, based on the total weight/volume (w/v) of the concentrate composition.

The carbohydrate can be present in a concentrate composition at a concentration of from about 0.5% to about 17%, based on the total weight/volume (w/v) of the concentrate composition.

The carbohydrate can be present in a concentrate composition at a concentration of from about 0.5% to about 1.5%, based on the total weight/volume (w/v) of the concentrate composition.

The carbohydrate can be present in a concentrate composition at a concentration of from about 1.5% to about 10.0%, based on the total weight/volume (w/v) of the concentrate composition.

The carbohydrate can be present in a concentrate composition at a concentration of from about 6.5% to about 17%, based on the total weight/volume (w/v) of the concentrate composition.

Alternatively, where the osmoprotectant comprises the carbohydrate, the carbohydrate can be present in a concentration of from about 0.01 mM to about 300 mM, such as from about 0.01 mM to about 250 mM, from about 0.01 mM to about 30 mM, from about 35 mM to about 50 mM, or from about 75 mM to about 250 mM, based on the total molarity of the concentrate composition.

For example, the carbohydrate can be present in a concentration of from about 0.01 mM to about 300 mM, based on the total molarity of the concentrate composition.

The carbohydrate can be present in a concentration of from about 0.01 mM to about 250 mM, based on the total molarity of the concentrate composition.

The carbohydrate can be present in a concentration of from about 0.01 mM to about 30 mM, based on the total molarity of the concentrate composition.

The carbohydrate can be present in a concentration of from about 35 mM to about 50 mM, based on the total molarity of the concentrate composition.

The carbohydrate can be present in a concentration of from about 75 mM to about 250 mM, based on the total molarity of the concentrate composition.

The carbohydrate can be present in a ready-to-use compositions in a concentration of from about 10 μM to about 3 mM, such as from about 10 μM to about 2 mM, from about 10 μM to about 1 mM, from about about 10 μM to about 500 μM, from about 10 μM to about 250 μM, or from about 10 μM to about 100 μM, based on the total molarity of the ready-to-use composition.

For example, the carbohydrate can be present in a concentration of from about 10 μM to about 3 mM, based on the total molarity of the ready—

The amino acid or amino acid derivative can comprise L-methionine, D-methionine, L-glycine, L-alanine, D-alanine, beta-alanine, L-arginine, L-serine, L-tryptophan, L-lysine, D-lysine, L-proline, D-proline, L-asparagine, D-asparagine, L-glutamate, D-glutamate, L-isoleucine, D-isoleucine, L-leucine, D-leucine, L-arginine, D-arginine, L-threonine, D-threonine, L-glutamine, D-glutamine, L-valine, D-valine, L-ornithine, D-ornithine, D-octopine, N6-acetyl-L-lysine, N-acetyl-L-glutamate, aspartate, sacrosine, S-methyl-L-methionine, a complex amino acid blend such as a plant extract, a yeast extract, a plant hydrolysate such as a soybean wheat, rice, cottonseed, pea, corn, or potato hydrolysate, a seaweed extract, a seaweed hydrolysate, an animal hydrolysate, or a combination of any thereof.

Where the osmoprotectant comprises the amino acid or amino acid derivative, the amino acid or amino acid derivative can be present in a concentrate composition at a concentration of from about 0.05% to about 10%, based on the total weight/volume (w/v) of the composition, such as from about 0.05% to about 1.0%, from about 0.5% to about 5.0%, or from about 5.0% to about 10%, based on the total weight/volume (w/v) of the composition, or can be present in a ready-to-use composition at a concentration of from about 0.00010% to about 1.0%, based on the total weight/volume (w/v) of the ready-to-use composition, from about 0.00015% to about 0.05%, from about 0.01% to about 0.25%, or from about 0.25% to about 1.0%, based on the total weight/volume (w/v) of the ready-to-use composition.

For example, the amino acid or amino acid derivative can be present in a concentrate composition at a concentration of from about 0.05% to about 10%, based on the total weight/volume (w/v) of the composition.

The amino acid or amino acid derivative can be present in a concentrate composition at a concentration of from about 0.05% to about 1.0%, based on the total weight/volume (w/v) of the composition.

The amino acid or amino acid derivative can be present in a concentrate composition at a concentration of from about 0.05% to about 5.0%, based on the total weight/volume (w/v) of the composition.

The amino acid or amino acid derivative can be present in a concentrate composition at a concentration of from about 5.0% to about 10%, based on the total weight/volume (w/v) of the composition.

Alternatively, the amino acid or amino acid derivative can be present in a ready-to-use composition at a concentration of from about 0.00010% to about 1.0%, based on the total weight/volume (w/v) of the composition.

The amino acid or amino acid derivative can be present in a ready-to-use composition at a concentration of from about 0.00015% to about 0.05%, based on the total weight/volume (w/v) of the composition.

The amino acid or amino acid derivative can be present in a ready-to-use composition at a concentration of from about 0.01% to about 0.25%, based on the total weight/volume (w/v) of the composition.

The amino acid or amino acid derivative can be present in a ready-to-use composition at a concentration of from about 0.25% to about 1.0%, based on the total weight/volume (w/v) of the composition.

Alternatively, where the osmoprotectant comprises the amino acid or amino acid derivative, the amino acid or amino acid derivative can be present in a concentrate composition at a concentration of from about 1 mM to about 600 mM, such as from about 1 mM to about 5 mM, from about 10 mM to about 60 mM, from about 75 mM to about 200 mM, or from about 245 mM to about 600 mM, based on the total molarity of the concentrate composition.

For example, the amino acid or amino acid derivative can be present in a concentrate composition at a concentration of from about 1 mM to about 600 mM, based on the total molarity of the concentrate composition.

The amino acid or amino acid derivative can be present in a concentrate composition at a concentration of from about 1 mM to about 5 mM, based on the total molarity of the concentrate composition.

The amino acid or amino acid derivative can be present in a concentrate composition at a concentration of from about 10 mM to about 60 mM, based on the total molarity of the concentrate composition.

The amino acid or amino acid derivative can be present in a concentrate composition at a concentration of from about 75 mM to about 200 mM, based on the total molarity of the concentrate composition.

The amino acid or amino acid derivative can be present in a concentrate composition at a concentration of from about 245 mM to about 600 mM, based on the total molarity of the concentrate composition.

In ready-to-use compositions, the amino acid or amino acid derivative can be present at a concentration of from about 0.5 μM to about 3 mM, such as from about 0.5 μM to about 2 mM, from about 0.5 μM to about 1 mM, from about 0.5 μM to about 500 μM, from about 0.5 μM to about 250 μM, or from about 0.5 μM to about 100 μM, based on the total molarity of the ready-to-use composition.

For example, the amino acid or amino acid derivative can be present in a ready-to-use composition at a concentration of from about 0.5 μM to about 3 mM, based on the total molarity of the ready-to-use composition.

The amino acid or amino acid derivative can be present in a ready-to-use composition at a concentration of from about 0.5 μM to about 2 mM, based on the total molarity of the ready-to-use composition.

The amino acid or amino acid derivative can be present in a ready-to-use composition at a concentration of from about 0.5 μM to about 1 mM, based on the total molarity of the ready-to-use composition.

The amino acid or amino acid derivative can be present in a ready-to-use composition at a concentration of from about 0.5 μM to about 500 μM, based on the total molarity of the ready-to-use composition.

The amino acid or amino acid derivative can be present in a ready-to-use composition at a concentration of from about 0.5 μM to about 250 μM, based on the total molarity of the ready-to-use composition.

The amino acid or amino acid derivative can be present in a ready-to-use composition at a concentration of from about 0.5 μM to about 100 μM, based on the total molarity of the ready-to-use composition.

When the osmoprotectant comprises a quaternary ammonium salt, the quaternary ammonium salt can comprise choline chloride.

In compositions comprising a first osmoprotectant and a second osmoprotectant, the first osmoprotectant can comprise betaine hydrochloride and the second osmoprotectant can comprise L-proline.

In compositions comprising first and second osmoprotectants, the first osmoprotectant can comprise glycine betaine and the second osmoprotectant can comprise L-proline.

In compositions comprising first and second osmoprotectants, the first osmoprotectant can comprise betaine hydrochloride and the second osmoprotectant can comprise proline betaine.

In compositions comprising first and second osmoprotectants, the first osmoprotectant can comprise ectoine and the second osmoprotectant can comprise L-proline.

In compositions comprising first and second osmoprotectants, the first osmoprotectant can comprise ectoine and the second osmoprotectant can comprise proline betaine.

In compositions comprising first and second osmoprotectants, the first osmoprotectant can comprise betaine hydrochloride and the second osmoprotectant can comprise trehalose.

In compositions comprising first and second osmoprotectants, the first osmoprotectant can comprise a betaine and the second osmoprotectant can comprise sucrose.

In compositions comprising first and second osmoprotectants, the first osmoprotectant can comprise a proline and the second osmoprotectant can comprise sucrose.

Where the composition comprises an anti-desiccant or in methods of exogenously applying an anti-desiccant to a plant, the anti-desiccant can comprise potassium salt, calcium chloride, glycerol, glycerol monostearate, or a combination of any thereof.

Preferably, where the composition or method comprises an anti-desiccant, the anti-desiccant comprises a potassium salt.

For example, the anti-desiccant can comprise potassium phosphate monobasic, potassium phosphate dibasic, potassium phosphate tribasic, potassium acetate, potassium chloride, potassium nitrate, potassium sulfate, dipotassium phosphate, potassium ammonium phosphate, potassium bicarbonate or a combination of any thereof.

The potassium salt can be derived from a fertilizer composition.

For example, the anti-desiccant comprises potassium phosphate tribasic.

As another example, the anti-desiccant comprises potassium acetate.

As a further example, the anti-desiccant comprises potassium sulfate.

The anti-desiccant can comprise a calcium salt. For example, the calcium salt can comprise calcium chloride.

Anti-desiccants are also referred to in the art as “humectants.” The terms “anti-desiccant” and “humectant” are used interchangeably herein. Humectants are hygroscopic substances that assist with the retention of moisture.

The humectant can comprise, for example, glycerol, glycerin, a glycerol derivative, such as glycerol monosterate, glycerol triacetate, triacetin, propylene glycol, hexylene glycol, butylene glycol, triethylene glycol, tripolypropylene glycol, glyceryl triacetate, sucrose, tagatose, a sugar alcohol or a sugar polyol (e.g., sorbitol, xylitol, mannitol, or mantitol), a polymeric polyol (e.g., polydextrose), a collagen, an aloe or an aloe vera gel, an alpha hydroxy acid (e.g., lactic acid), honey, molasses, a quillaia, a sodium hexametaphosphate, a lithium chloride, urea, calcium chloride, or a combination of any thereof.

Synthetic humectants can also be used as anti-desiccants. Synthetic humectants include butylene glycol, a tremella extract, dicyanamide, sodium pyroglutamic acid, sodium lactate, or a combination of any thereof.

For example, the anti-desiccant can comprise glycerol.

The anti-desiccant can be present in a ready-to-use composition in a concentration of from about 0.002% to about 20%, from about 0.002% to about 10%, from about 0.002% to about 5%, from about 0.002% to about 1%, from about 0.002% to about 0.5%, from about 0.002% to about 0.005%, or from about 0.005% to about 0.5%, based on the total weight/volume (w/v) of the ready-to-use composition.

For example, the anti-desiccant can be present in a ready-to-use composition in a concentration of from about 0.002% to about 20%, based on the total weight/volume (w/v) of the ready-to-use composition.

The anti-desiccant can be present in a ready-to-use composition in a concentration of from about 0.002% to about 10%, based on the total weight/volume (w/v) of the ready-to-use composition.

The anti-desiccant can be present in a ready-to-use composition in a concentration of from about 0.002% to about 5%, based on the total weight/volume (w/v) of the ready-to-use composition.

The anti-desiccant can be present in a ready-to-use composition in a concentration of from about 0.002% to about 1%, based on the total weight/volume (w/v) of the ready-to-use composition.

The anti-desiccant can be present in a ready-to-use composition in a concentration of from about 0.002% to about 0.5%, based on the total weight/volume (w/v) of the ready-to-use composition.

The anti-desiccant can be present in a ready-to-use composition in a concentration of from about 0.002% to about 0.005%, based on the total weight/volume (w/v) of the ready-to-use composition.

The anti-desiccant can be present in a ready-to-use composition in a concentration of from about 0.005% to about 0.5%, based on the total weight/volume (w/v) of the ready-to-use composition.

Alternatively, the anti-desiccant can be present in a ready-to-use composition at a concentration of from about 50 μM to about 3 M, such as from about 50 μM to about 300 μM, from about 50 μM to about 225 μM, from about 85 μM to about 200 μM, from about 200 μM to about 300 μM, or from about 200 μM to about 3 M, based on the total molarity of the ready-to-use composition.

For example, the anti-desiccant can be present in a ready-to-use composition at a concentration of from about 50 μM to about 3 M, based on the total molarity of the ready-to-use composition.

The anti-desiccant can be present in a ready-to-use composition at a concentration of from about 50 μM to about 300 μM, based on the total molarity of the ready-to-use composition.

The anti-desiccant can be present in a ready-to-use composition at a concentration of from about 50 μM to about 225 mM, based on the total molarity of the ready-to-use composition.

The anti-desiccant can be present in a ready-to-use composition at a concentration of from about 85 μM to about 200 mM, based on the total molarity of the ready-to-use composition.

The anti-desiccant can be present in a ready-to-use composition at a concentration of from about 200 μM to about 300 mM, based on the total molarity of the ready-to-use composition.

The anti-desiccant can be present in a ready-to-use composition at a concentration of from about 200 μM to about 3 M, based on the total molarity of the ready-to-use composition.

The anti-desiccant can be present in a concentrate composition in a concentration of from about 0.5% to about 100%, from about 1.0% to about 67%, or from about 2% to about 25%, based on the total weight/volume (w/v) of the concentrate composition.

For example, the anti-desiccant can be present in a concentrate composition in a concentration of from about 0.5% to about 100%, based on the total weight/volume (w/v) of the concentrate composition.

The anti-desiccant can be present in a concentrate composition in a concentration of from about 1.0% to about 67%, based on the total weight/volume (w/v) of the concentrate composition.

The anti-desiccant can be present in a concentrate composition in a concentration of from about 2% to about 25%, based on the total weight/volume (w/v) of the concentrate composition.

Alternatively, anti-desiccant can be present in a concentrate composition at a concentration of from about 30 mM to about 100 mM, from about 30 mM to about 60 mM, or from about 50 mM to about 60 mM, based on the total molarity of the concentrate composition.

For example, the anti-desiccant can be present in a concentrate composition at a concentration of from about 30 mM to about 100 mM, based on the total molarity of the concentrate composition.

The anti-desiccant can be present in a concentrate composition at a concentration of from about 30 mM to about 60 mM, based on the total molarity of the concentrate composition.

The anti-desiccant can be present in a concentrate composition at a concentration of from about 50 mM to about 60 mM, based on the total molarity of the concentrate composition.

When the composition is applied to a plant or plant part, the anti-respirants in the composition spread out to form a thin film on the surface. Application of a composition containing an anti-respirant reduces respiratory losses while keeping the carbon dioxide concentration higher in the plant tissues undergoing photosynthesis, thus increasing the overall respiration efficiency of a plant.

The anti-respirant can comprise a surfactant.

Anti-respirants also act as anti-transpirants in plants to minimize water loss from transpiration.

The anti-respirant agents are further used to increase adhesion in the soil of agricultural compositions and increase the delivery and the absorption of the composition into the plant or plant part. These actives should also absorb and hold water in the tissues or apoplast (extracellular milieu surrounding plant cells), reducing loss of water vapor and enhancing water retention within the tissues. The anti-respirant agents help to slow or prevent excessive water loss or minimize water loss through transpiration.

Where the composition comprises an anti-respirant, the anti-respirant can comprise a non-ionic surfactant.

Alternatively, the anti-respirant can comprise a cationic surfactant, an anionic surfactant, an amphoteric surfactant, or a combination of any thereof.

In particular, the anti-respirant can comprise an anionic surfactant.

Further, the anti-respirant can comprise an alkylene glycol, a polyoxyalkylene or derivative thereof, an organosilicone, an alcohol ethoxylate, an alkyl aryl ethoxylate, a sulfosuccinic acid-based surfactant, an anti-transpirant, or a combination of any thereof.

For example, the organosilicone can comprise a non-blended organosilicone surfactant.

The polyoxyalkylene can comprise any polymer of an alkylene glycol or alkylene oxide. For example, the polyoxyalkylene can comprise a polyoxyalkylene, an alkoxypolyoxyalkylene, a C₈-C₃₀ alkyl polyoxyalkylene, or a combination of any thereof. The term “polyoxyalkylene” as used herein includes a polyalkylene glycol such as polyethylene glycol or polypropylene glycol or a polyalkylene oxide such as polyethylene oxide or polypropylene oxide.

The anti-respirant can comprise the alkylene glycol, such as ethylene glycol, propylene glycol, polyethylene glycol, alkyl and alkyl lauryl polyoxyethylene glycol, an alkyl polysaccharide, an alkyl polyglucoside ester, polyethylene-polypropylene glycol, polyoxyethylene-polyoxypropylene and polyethylene glycol, hexylene glycol, or a combination of any thereof.

Preferably, the alkylene glycol includes ethylene glycol.

The alkylene glycol can also preferably comprise polyethylene glycol.

The anti-respirant can comprise the polyoxyalkylene or derivative thereof, and the polyoxyalkylene or derivative thereof can comprise alkyl polyoxyethylene, methoxypolyoxyethylene, octyl polyoxyethylene, nonyl polyoxyethylene, decyl polyoxyethylene, undecyl polyoxyethylene, lauryl polyoxyethylene, tridecyl polyoxyethylene, tetradecyl polyoxyethylene, pentadecyl polyoxyethylene, hexadecyl polyoxyethylene, heptadecyl polyoxyethylene, octadecyl polyoxyethylene, coco polyoxyethylene, tallow polyoxyethylene, alkyl polyoxyethoxylate ether, alkyl phenol ethoxylate, a polyoxyethylene-polyoxypropylene block copolymer, or a combination or derivative of any thereof.

The anti-transpirant can comprise atrazine, phenyl mercuric acetate, alkenyl succinic acid, succinic acid, an alcohol such as ethyl alcohol, hydrated lime, calcium carbonate, a clay such as kaolinite clay or bentonite clay, magnesium carbonate, zinc sulfate, anionic surfactants, cationic surfactants, zwitterionic surfactants, or a combination of any thereof.

As aforementioned, surfactants that act as anti-respirants that can be included in composition or in the methods of applying an anti-respirant. The surfactant can comprise a heavy petroleum oil, a heavy petroleum distillate, a polyol fatty acid ester, a polyethoxylated fatty acid ester, an aryl alkyl polyoxyethylene glycol, an alkyl amine acetate, an alkyl aryl sulfonate, a polyhydric alcohol, an alkyl phosphate, an alcohol ethoxylate, an alkylphenol ethoxylate, an alkyloxylated polyol, an alkylpolyethoxy ether, alkyl phenol ethoxylate, an alkylpolyoxyethoxylate an alkylphenol ethoxylate, a soybean oil, a ethoxylated soybean oil derivative, a glycerol, a polyoxyethylene polyoxypropylene monobutyl ether, or combination of any thereof.

Surfactants can be included in a range of compositions including those for foliar use.

The anti-respirant can be present in a concentrate composition at a concentration of from about 1.0% to about 99.8%, from about 1.0% to about 75%, from about 1.0% to about 50%, from about 1.0% to about 46%, from about 3.0% to about 40%, or from about 30% to about 38%, based on the total weight/volume (w/v) of the concentrate composition.

For example, the anti-respirant can be present in a concentrate composition at a concentration of from about 1.0% to about 99.8%, based on the total weight/volume (w/v) of the concentrate composition.

The anti-respirant can be present in a concentrate composition at a concentration of from about 1.0% to about 75%, based on the total weight/volume (w/v) of the concentrate composition.

The anti-respirant can be present in a concentrate composition at a concentration of from about 1.0% to about 50%, based on the total weight/volume (w/v) of the concentrate composition.

The anti-respirant can be present in a concentrate composition at a concentration of from about 1.0% to about 46%, based on the total weight/volume (w/v) of the concentrate composition.

The anti-respirant can be present in a concentrate composition at a concentration of from about 3.0% to about 40%, based on the total weight/volume (w/v) of the concentrate composition.

The anti-respirant can be present in a concentrate composition at a concentration of from about 30% to about 38%, based on the total weight/volume (w/v) of the concentrate composition.

The anti-respirant can be present in a ready-to-use composition at a concentration of from about 0.025% to about 15%, from about 0.025% to about 10%, from about 0.01% to about 10%, from about 0.01% to about 5%, 0.05% to about 4.0%, from about 0.1% to about 3.0%, from about 0.1% to about 0.5%, or from about 0.1% to about 0.2%, based on the total weight/volume (w/v) of the composition.

For example, the anti-respirant can be present in a ready-to-use composition at a concentration of from about 0.05% to about 15%, based on the total weight/volume (w/v) of the composition.

The anti-respirant can be present in a ready-to-use composition at a concentration of from about 0.025% to about 10%, based on the total weight/volume (w/v) of the composition.

The anti-respirant can be present in a ready-to-use composition at a concentration of from about 0.01% to about 10%, based on the total weight/volume (w/v) of the composition.

The anti-respirant can be present in a ready-to-use composition at a concentration of from about 0.01% to about 5%, based on the total weight/volume (w/v) of the composition.

The anti-respirant can be present in a ready-to-use composition at a concentration of from about 0.1% to about 3.0%, based on the total weight/volume (w/v) of the composition.

The anti-respirant can be present in a ready-to-use composition at a concentration of from about 0.1% to about 0.5%, based on the total weight/volume (w/v) of the composition.

The anti-respirant can be present in a ready-to-use composition at a concentration of from about 0.1% to about 0.2%, based on the total weight/volume (w/v) of the composition.

In compositions comprising an osmoprotectant, an anti-desiccant, and an anti-respirant or in methods of applying an osmoprotectant, an anti-desiccant, and an anti-respirant, the osmoprotectant can comprise betaine hydrochloride, the anti-desiccant can comprise potassium phosphate tribasic, and the anti-respirant can comprise alkyl and alkyl lauryl polyoxyethylene glycol.

The osmoprotectant can comprise L-proline, the anti-desiccant can comprise potassium phosphate tribasic, and the anti-respirant can comprise alkyl and alkyl lauryl polyoxyethylene glycol.

For example, the osmoprotectant can comprise betaine hydrochloride and L-proline, the anti-desiccant can comprise potassium phosphate tribasic, and the anti-respirant can comprise alkyl and alkyl lauryl polyoxyethylene glycol.

As another example, the osmoprotectant can comprise betaine hydrochloride, the anti-desiccant can comprise potassium phosphate tribasic, and the anti-respirant can comprise alkyl polyoxyethylene.

As a further example, the osmoprotectant can comprise betaine hydrochloride, the anti-desiccant can comprise potassium phosphate tribasic, and the anti-respirant can comprise alkyl polyoxyethoxylate ether.

The osmoprotectant can comprise betaine hydrochloride and L-proline, the anti-desiccant can comprise potassium phosphate tribasic, and the anti-respirant comprise alkyl poloxyethylene.

The osmoprotectant can comprise betaine hydrochloride and L-proline, the anti-desiccant can comprise potassium acetate, and the anti-respirant can comprise alkyl and alkyl lauryl polyoxyethylene glycol.

Alternatively, the osmoprotectant can comprise L-proline, the anti-desiccant can comprise potassium phosphate tribasic, and the anti-respirant can comprise alkyl polyoxyethylene.

For example, the osmoprotectant can comprise proline betaine, the anti-desiccant can comprise potassium phosphate tribasic, and the anti-respirant can comprise alkyl and alkyl lauryl polyoxyethylene glycol.

As another example, the osmoprotectant can comprise ectoine, the anti-desiccant can comprise potassium sulfate, and the anti-respirant can comprise an anionic surfactant.

The osmoprotectant can comprise ectoine, the anti-desiccant can comprise potassium sulfate, and the anti-respirant can comprise an anionic sulfosuccinic acid-based surfactant.

As a further example, the osmoprotectant can comprise choline chloride, the anti-desiccant can comprise calcium chloride, and the anti-respirant can comprise a non-ionic surfactant.

The osmoprotectant can comprise choline chloride, the anti-desiccant can comprise calcium chloride, and the anti-respirant can comprise a polyoxyethylene-polyoxypropylene block copolymer.

As another example, the osmoprotectant can comprise betaine hydrochloride, the anti-desiccant can comprise glycerol, and the anti-respirant can comprise an alkyl polyglucoside ester.

In compositions comprising an osmoprotectant and an anti-respirant or in methods of applying an osmoprotectant and an anti-respirant, the osmoprotectant can comprise betaine hydrochloride and the anti-respirant can comprise alkyl and alkyl lauryl polyoxyethylene glycol.

As an example, the osmoprotectant can comprise L-proline and the anti-respirant can comprise alkyl and alkyl lauryl polyoxyethylene glycol.

As another example, the osmoprotectant can comprise betaine hydrochloride and L-proline and the anti-respirant can comprise alkyl and alkyl lauryl polyoxyethylene glycol.

As a further example, the osmoprotectant can comprise trehalose and the anti-respirant can comprise an organosilicone.

Alternatively, the osmoprotectant can comprise ectoine and the anti-respirant can comprise an anionic surfactant.

For example, the osmoprotectant can comprise ectoine and the anti-respirant can comprise an anionic sulfosuccinic acid-based surfactant.

In compositions comprising an osmoprotectant and an anti-desiccant and methods of applying an osmoprotectant and an anti-desiccant, the osmoprotectant can comprise betaine hydrochloride and the anti-desiccant can comprise glycerol.

In compositions comprising an anti-desiccant and an anti-respirant and in methods of applying an anti-desiccant and an anti-respirant, the anti-desiccant can comprise potassium acetate and the anti-respirant can comprise an organosilicone.

Alternatively, the anti-desiccant can comprise potassium sulfate and the anti-respirant can comprise an anionic surfactant.

For example, the anti-desiccant can comprise potassium sulfate and the anti-respirant can comprise an anionic sulfosuccinic acid-based surfactant.

As another example, the anti-desiccant can comprise calcium chloride and the anti-respirant can comprise a polyoxyethylene-polyoxypropylene block copolymer.

Where the anti-desiccant comprises calcium chloride and the anti-respirant comprises a polyoxyethylene-polyoxypropylene block copolymer, the composition can further comprise an osmoprotectant and the osmoprotectant can comprise choline chloride.

The compositions and methods described herein can also further comprise a wetting agent, an antifoaming agent, a buffering agent, a biocide, a fixing agent, a microbiostat, a coloring agent, a preservative, an antioxidant, a surfactant, a chelating agent or a combination of any thereof.

The term “microbiostat” refers to any agent that inhibits or prevents the growth of one or more microbes, for example, bacteria, yeasts, viruses, and/or fungi.

When present, the wetting agent, the antifoaming agent, the buffering agent, the biocide, the fixing agent, the microbiostat, the coloring agent, the preservative, the antioxidant, the surfactant, the chelating agent, or a combination of any thereof can be present in a concentrate composition at a concentration of from about 0.1 to about 50 wt % of the composition, for example, from about 0.1 to about 20 wt % of the composition, from about 1 to about 20 wt % of the composition, or from about 1 to about 10 wt % of the composition.

For example, the wetting agent, the antifoaming agent, the buffering agent, the biocide, the fixing agent, the microbiostat, the coloring agent, the preservative, the antioxidant, the surfactant, the chelating agent, or a combination of any thereof can be present in a concentrate composition at a concentration of from about 0.1% to about 20 wt % of the composition.

The wetting agent, the antifoaming agent, the buffering agent, the biocide, the fixing agent, the microbiostat, the coloring agent, the preservative, the antioxidant, the surfactant, the chelating agent, or a combination of any thereof can be present in a concentrate composition at a concentration of from about 1% to about 20 wt % of the composition.

The wetting agent, the antifoaming agent, the buffering agent, the biocide, the fixing agent, the microbiostat, the coloring agent, the preservative, the antioxidant, the surfactant, the chelating agent, or a combination of any thereof can be present in a concentrate composition at a concentration of from about 1% to about 10 wt % of the composition.

Suitable wetting agents include all compounds that promote wetting and are typically used in agrochemical compositions, including, for example, an alkylnaphthlaene-sulfonate, such as diisopropylnaphthalene-sulfonate and diisobutylnaphthalene-sulfonate.

Suitable antifoaming agents include all agrochemically effective foam-inhibiting compounds, such as a silicone antifoaming agent, magnesium stearate, a silicone emulsion, a long-chain alcohol, a fatty acid and its salt, and organofluorine compound, or a mixture of any thereof.

Suitable buffering agents include all buffering agents typically used in agricultural compositions, such as, for example, monopotassium phosphate, acrylic acid, glutaric acid, gluconic acid, glycolic acid, lactic acid, carboxylated alcohol ethoxylate, an ethoxylated alkylphenol carboxylate ester, a tristyrylphenol alkoxylate carboxylate ester, a tristyrylphenol alkoxylate phosphate ester, a fatty acid, or a mixture of any thereof.

Suitable fixing agents can be based on a polyvinyl alkyl ether, for example polyvinyl methyl ether or ketones, such as benzophenone or ethylene benzophenone.

Suitable microbiostats and biocides include all microbiostats and biocides typically used in agricultural compositions, such as, for example, an organic acid.

Suitable preservatives include all preservatives typically used in agricultural compositions, such as, for example, a preservative made from dichlorophen and benzyl alcohol hemiformal. Other suitable preservatives include 1,2-benzisothiazolin-3, 1,2-benzisothiazolin-3-one, 5-chloro-2-methyl-4-isothiazolin-3-one, 2-methyl-4-isothiazolin-3-one, or a combination of any thereof.

Suitable antioxidants include all antioxidants typically used in agricultural compositions, such as, for example, butylated hydroxytoluene (BHT), propyl gallate, octyl gallate, dodecyl gallate, butylated hydroxyanisole, propylparaben, sodium benzoate, 4,4′-(2,3-dimethyltetramethylene) dibrenzcatechin (nordihydroguaiaretic acid).

Suitable surfactants include all surfactants typically used in agricultural compositions and may be non-ionic, anionic, cationic, or zwitterionic.

Nonionic surfactants include polyethylene oxide-polypropylene oxide block copolymers, polyethylene-polypropylene glycol, alkylpolyoxyethylene, polyethylene glycol ethers of linear alcohols, reaction products of fatty acids with ethylene oxide and/or propylene oxide, polyvinyl alcohol, polyvinylpyrrolidone, copolymers of polyvinyl alcohol and polyvinylpyrrolidone, copolymers of (meth)acrylic acid and (meth)acrylic esters, alkyl ethoxylates, alkylaryl ethoxylates, which may be optionally phosphated or neutralized with a based, polyoxyamine derivatives, nonylphenol ethoxylates, and a mixture any thereof.

Anionic surfactants include, for example, alkali metal and alkaline earth metal salts of alkylsulfonic acid and alkylarylsuofnic acid, salts of polystyrenesulfonic acid, salts of polyvinyl sulfonic acids, salts of naphthalene sulfonic acid, formaldehyde condensates, salts of condensates of naphthalenesulfonic acid, phenolsulfonic acid and formaldehyde, salts of ligninsulfonic acid, and a mixture any thereof.

The surfactant can comprise an alkyl carboxylate, sodium stearate, sodium lauryl sarcosinate, perfluorononanoate, perfluorooctanoate, ammonium lauryl sulfate, sodium lauryl sulfate, sodium laureth sulfate, sodium myreth sulfate, docusate, perfluorooctanesulfonate, perfluorobutanesulfonate, an alkyl-aryl ether phosphate, an alkyl ether phosphate, octenidine dihydrochloride, cetrimonium bromide, cetylpyridinium chloride, benzalkonium chloride, benzethonium chloride, dimethyldioctadecylammonium chloride, dioctadecyldimethylammonium bromide, 3-[(3-cholamidopropyl)dimethylammonio]-1-propanesulfonate, cocamidopropyl hydroxysultaine, cocamidopropyl betaine, phosphtidylserine, phosphatidylethanolamine, phosphatidylcholine, a shingomyelin, a fatty alcohol, cetyl alcohol, stearyl alcohol, cetostearyl alcohol, oleyl alcohol, a polyoxyethylene glycol alkyl ether, ocatethylene glycol monodecyl ether, pentaethylene glycol monodecyl ether, a polyoxypropylene glycol alkyl ether, a glucoside alkyl ether, decyl glucoside, lauryl glucoside, octyl glucoside, polyoxyethylene gylcol octylphenol ether, an alkylene glycol, such as ethylene glycol, propylene glycol, polyethylene glycol, alkyl and alkyl laruyl polyoxyethylene glycol, an alkyl polysaccharide, an alkyl polyglucoside ester, polyethylene-polyproplyene glycol, polyoxyethylene-polyoxypropylene and polyethylene glycol, hexylene glycol, and polyoxyethylene glycol alkylphenol ether, nonoxynol-9, a glycerol alkyl ester, glyceryl laurate, a polyoxyethylene glycol sorbitan alkyl ester, polysorbate, a sorbitan alkyl ester, cocamide monoethanolanine, cocamide diethanolamine, dodecyldimethylamine oxide, a block copolymer of polyethylene glycol, a block copolymer of polypropylene glycol, poloxamer, polyethoxylated tallow amine, a polyoxyalkylene or derivative thereof, such as alkyl polyoxyethylene, methoxypolyoxyethylene, octyl polyoxyethylene, nonyl polyoxyethylene, decyl polyoxyethylene, undecyl polyoxyethylene, laruyl polyoxyethylene, tridecyl polyoxyethylene, tetradecyl polyoxyethylene, pentadecyl polyoxyethylene, hexadecyl polyoxyethylene, heptadecyl polyoxyethylene, octadecyl polyoxyethylene, coco polyoxyethylene, tallow polyoxyethylene, alkyl polyethoxylate ether, alkyl phenol ethoxylate, and a polyoxyethylene-polyoxypropylene block copolymer, an organosilicone, an alcohol ethoxylate, an alkyl aryl ethoxylate, a sulfosuccinic acid-based surfactant, or a combination of any thereof.

The chelating agent can comprise EDTA.

The composition can also further comprise an additional active ingredient such as a pesticide, a fertilizer, a plant growth regulator, a bio-control agent, a bio-stimulant, seaweed extract or a derivative thereof, or a combination of any thereof. When present, the additional active ingredient can comprise from about 1 to about 99.9 wt % of the composition, for example, from about 5 wt % to about 99 wt %, from about 20 wt % to about 95 wt %, from about 20 wt % to about 60 wt %, from about 1 to about 60 wt %, from about 1 to about 50 wt %, from about 1 to about 40 wt % of the composition, from about 1 to about 25 wt % of the composition, or from about 1 to about 10 wt % of the concentrate composition.

The pesticide can comprise a fungicide, an insecticide, an acaricide, an herbicide, a nematicide, a bactericide, or a combination of any thereof.

When included in the composition, the herbicide can comprise 2,4-D, 2,4-DB, acetochlor, acifluorfen, alachlor, ametryn, atrazine, aminopyralid, benefin, bensulfuron, bensulfuron methyl, bensulide, bentazon, bispyribac sodium, bromacil, bromoxynil, butylate, carfentrazone, 2-chlorophenoxy acetic acid, chlorimuron, chlorimuron ethyl, chlorsulfuron, clethodim, clomazone, clopyralid, clopyralid acid, cloransulam, CMPP-P-DMA, cycloate, DCPA, desmedipham, dicamba, dichlobenil, diclofop, dichlorprop, dichlorprop-P, dichlorophenoxyacetic acid, 2,4-dichlorophenol, diclosulam, diflufenzopyr, dimethenamid, dimethyl amine salt of 2,4-dichlorophenoxyacetic acid, 2,4-dichlorophenoxyacetic acid ester, derivatives of 2,4-dichlorophenoxyacetic acid, diquat, diuron, DSMA, endothall, EPTC, ethalfluralin, ethofumesate, fenoxaprop, fluazifop-P, flucarbazone, flufenacet, flumetsulam, flumiclorac, flumioxazin, fluometuron, fluroxypyr, fluroxypyr 1-methyleptylester, fomesafen, fomesafen sodium salt, foramsulfuron, glufosinate, glufosinate-ammonium, glyphosate, halosulfuron, halosulfuron-methyl, hexazinone, 2-hydroxyphenoxy acetic acid, 4-hydroxyphenoxy acetic acid, imazamethabenz, imazamox, imazapic, imazaquin, imazapyr, imazethapyr, isoxaben, isoxaflutole, lactofen, linuron, MCPA, MCPB, mecoprop, mecoprop-P, mesotrione, metolachlor-s, metribuzin, metsulfuron, metsulfuron-methyl, molinate, MSMA, napropamide, naptalam, nicosulfuron, norflurazon, oryzalin, oxadiazon, oxyfluorfen, paraquat, pelargonic acid, pendimethalin, phenmedipham, picloram, primisulfuron, prodiamine, prometryn, pronamide, propanil, prosulfuron, pyrazon, pyroxasulfone, pyrithiobac, quinclorac, quizalofop, rimsulfuron, sethoxydim, siduron, simazine, sulfentrazone, sulfometuron, tribernuron, tribernuron-methyl, sulfosulfuron, tebuthiuron, terbacil, thiazopyr, thifensulfuron, thifensulfuron-methyl, thiobencarb, tralkoxydim, triallate, triasulfuron, tribenuron, triclopyr, trifluralin, triflusulfuron, or any combination thereof.

When included in the composition, the fungicide can comprise aldimorph, ampropylfos, ampropylfos potassium, andoprim, anilazine, azaconazole, azoxystrobin, benalaxyl, benodanil, benomyl, benzamacril, benzamacryl-isobutyl, benzovindflupyr, bialaphos, binapacryl, biphenyl, bitertanol, blasticidin-S, boscalid, bromuconazole, bupirimate, buthiobate, calcium polysulphide, capsimycin, captafol, captan, carbendazim, carvon, quinomethionate, chlobenthiazone, chlorfenazole, chloroneb, chloropicrin, chlorothalonil, chlozolinate, clozylacon, cufraneb, cymoxanil, cyproconazole, cyprodinil, cyprofuram, debacarb, dichlorophen, diclobutrazole, diclofluanid, diclomezine, dicloran, diethofencarb, dimethirimol, dimethomorph, dimoxystrobin, diniconazole, diniconazole-M, dinocap, diphenylamine, dipyrithione, ditalimfos, dithianon, dodemorph, dodine, drazoxolon, edifenphos, epoxiconazole, etaconazole, ethirimol, etridiazole, famoxadon, fenapanil, fenarimol, fenbuconazole, fenfuram, fenitropan, fenpiclonil, fenpropidin, fenpropimorph, fentin acetate, fentin hydroxide, ferbam, ferimzone, fluazinam, fludioxonil, flumetover, fluoromide, fluquinconazole, flurprimidol, flusilazole, flusulfamide, fluoxastrobin, flutolanil, flutriafol, folpet, fosetyl-aluminium, fosetyl-sodium, fthalide, fuberidazole, furalaxyl, furametpyr, furcarbonil, furconazole, furconazole-cis, furmecyclox, guazatine, hexachlorobenzene, hexaconazole, hymexazole, imazalil, imibenconazole, iminoctadine, iminoctadine albesilate, iminoctadine triacetate, iodocarb, iprobenfos (IBP), iprodione, irumamycin, isoprothiolane, isovaledione, kasugamycin, kresoxim-methyl, copper preparations, such as: copper hydroxide, copper naphthenate, copper oxychloride, copper sulphate, copper oxide, oxine-copper and Bordeaux mixture, mancopper, mancozeb, maneb, meferimzone, mepanipyrim, mepronil, metconazole, methasulfocarb, methfuroxam, metalzxyl, metiram, metomeclam, metsulfovax, mildiomycin, myclobutanil, myclozolin, nickel dimethyldithiocarbamate, nitrothal-isopropyl, nuarimol, ofurace, oxadixyl, oxamocarb, oxolinic acid, oxycarboxim, oxyfenthiin, paclobutrazole, pefurazoate, penconazole, pencycuron, phosdiphen, picoxystrobin, pimaricin, piperalin, polyoxin, polyoxorim, probenazole, prochloraz, procymidone, propamocarb, propanosine-sodium, propiconazole, propineb, prothiocinazole, pyraclostrobin, pyrazophos, pyrifenox, pyrimethanil, pyroquilon, pyroxyfur, quinconazole, quintozene (PCNB), a strobilurin, sulphur and sulphur preparations, tebuconazole, tecloftalam, teenazene, tetcyclasis, tetraconazole, thiabendazole, thicyofen, thifluzamide, thiophanate-methyl, tioxymid, tolclofos-methyl, tolylfluanid, triadimefon, triadimenol, triazbutil, a triazole, triazoxide, trichlamide, triclopyr, tricyclazole, tridemorph, trifloxystrobin, triflumizole, triforine, uniconazole, validamycin A, vinclozolin, viniconazole, zarilamide, zineb, ziram and also Dagger G, OK-8705, OK-8801, a-(1,1-dimethylethyl)-(3-(2-phenoxyethyl)-1H-1,2,4-triazole-1-ethanol, a-(2,4-dichlorophenyl)-[3-fluoro-3-propyl-1H-1,2,4-triazole-1-ethanol, a-(2,4-dichlorophenyl)-[3-methoxy-a-methyl-1H-1,2,4-triazol e-1-ethanol, a-(5-methyl-1,3-dioxan-5-yl)-[3-[[4-(trifluoromethyl)-phenyl]-methylene]-1H-1,2,4-triazole-1-ethanol, (5RS,6RS)-6-hydroxy-2,2,7,7-tetramethyl-5-(1H-1,2,4-triazol-1-yl)-3-octanone, (E)-a-(methoxyimino)-N-methyl-2-phenoxy-phenylacetamide, 1-isopropyl{2-methyl-1-[[[1-(4-methylphenyl)-ethyl]-amino]-carbonyl]-propyl}carbamate, 1-(2,4-dichlorophenyl)-2-(1H-1,2,4-triazol-1-yl)-ethanone-O-(phenyl methyl)-oxime, 1-(2-methyl-1-naphthalenyl)-1H-pyrrole-2,5-dione, 1-(3,5-dichlorophenyl)-3-(2-propenyl)-2,5-pyrrolidindione, 1-[(diiodomethyl)-sulphonyl]-4-methyl-benzene, 1-[[2-(2,4-dichlorophenyl)-1, 3-dioxolan-2-yl]-methyl]-1H-imidazole, 1-[[2-(4-chlorophenyl)-3-phenyloxiranyl]-methyl]-1H-1,2,4-triazole, 1-[1-[2-[(2,4-dichlorophenyl)-methoxy]-phenyl]-ethenyl]-1H-imidazole, 1-methyl-5-nonyl-2-(phenylmethyl)-3-pyrrolidinole, 2′,6′-dibromo-2-methyl-4′-trifluoromethoxy-4′-trifluoro-methyl-1, 3-thiazole-carboxanilide, 2,2-dichloro-N-[1-(4-chlorophenyl)-ethyl]-1-ethyl-3-methyl-cyclopropanecarboxamide, 2,6-dichloro-5-(methylthio)-4-pyrimidinyl-thiocyanate, 2,6-dichloro-N-(4-trifluoromethylbenzyl)-benzamide, 2,6-dichloro-N-[[4-(trifluoromethyl)-phenyl]-methyl]-benzamide, 2-(2,3,3-triiodo-2-propenyl)-2H-tetrazole, 2-[(1-methylethyl)-sulphonyl]-5-(trichloromethyl)-1,3,4-thiadiazole, 2-[[6-deoxy-4-O-(4-0-methyl-(3-D-glycopyranosyl)-a-D-glucopyranos yl]-amino]-4-methoxy-1H-pyrrolo [2,3-d]pyrimidine-5-carbonitrile, 2-aminobutane, 2-bromo-2-(bromomethyl)-pentanedinitrile, 2-chloro-N-(2,3-dihydro-1,1,3-trimethyl-1H-inden-4-yl)-3-pyridinecarboxamide, 2-chloro-N-(2,6-dimethylphenyl)-N-(isothiocyanatomethyl)-acetamide, 2-phenylphenol (OPP), 3,4-dichloro-1-[4-(difluoromethoxy)-phenyl]-pyrrole-2,5-dione, 3,5-dichloro-N-[cyano[(1-methyl-2-propynyl)-oxy]-methyl]-benzamide, 3-(1,1-dimethylpropyl-1-oxo-1H-indene-2-carbonitrile, 3-[2-(4-chlorophenyl)-5-ethoxy-3-isoxazolidinyl]-pyridine, 4-chloro-2-cyano-N,N-dimethyl-5-(4-methylphenyl)-1H-imidazole-1-sulphonamide, 4-methyl-tetrazolo[1,5-a]quinazolin-5(4H)-one, 8-(1,1-dimethylethyl)-N-ethyl-N-propyl-1,4-dioxaspiro[4, 5]decane-2-methanamine, 8-hydroxyquinoline sulphate, 9H-xanthene-2-[(phenylamino)-carbonyl]-9-carboxylic hydrazide, bis-(1-methylethyl)-3-methyl-4-[(3-methylbenzoyl)-oxy]-2,5-thiophenedicarboxylate, cis-1-(4-chlorophenyl)-2-(1H-1,2,4-triazol-1-yl)-cycloheptanol, cis-4-[3-[4-(1,1-dimethylpropyl)-phenyl-2-methylpropyl]-2,6-dimethyl-morpholine hydrochloride, ethyl [(4-chlorophenyl)-azo]-cyanoacetate, potassium bicarbonate, methanetetrathiol-sodium salt, methyl 1-(2,3-dihydro-2,2-dimethyl-inden-1-yl)-1H-imidazole-5-carboxylate, methyl N-(2,6-dimethylphenyl)-N-(5-isoxazolylcarbonyl)-DL-alaninate, methyl N-(chloroacetyl)-N-(2,6-dimethylphenyl)-DL-alaninate, N-(2,3-dichloro-4-hydroxyphenyl)-1-methyl-cyclohexanecarboxamide, N-(2,6-dimethyl phenyl)-2-methoxy-N-(tetra hydro-2-oxo-3-furanyl)-acetamide, N-(2,6-dimethyl phenyl)-2-methoxy-N-(tetrahydro-2-oxo-3-thienyl)-acetamide, N-(2-chloro-4-nitrophenyl)-4-methyl-3-nitro-benzenesulphonamide, N-(4-cyclohexylphenyl)-1,4,5,6-tetrahydro-2-pyrimidinamine, N-(4-hexylphenyl)-1,4,5,6-tetrahydro-2-pyrimidinamine, N-(5-chloro-2-methylphenyl)-2-methoxy-N-(2-oxo-3-oxazolidinyl)-acetamide, N-(6-methoxy)-3-pyridinyl)-cyclopropanecarboxamide, N-[2,2,2-trichloro-1-[(chloroacetyl)-amino]-ethyl]-benzamide, N-[3-chloro-4,5-bis(2-propinyloxy)-phenyl]-N′-methoxy-methanimidamide, N-formyl-N-hydroxy-DL-alanine-sodium salt, 0,0-diethyl [2-(dipropylamino)-2-oxoethyl]-ethylphosphoramidothioate, 0-methyl S-phenyl phenylpropylphosphoramidothioate, S-methyl 1,2,3-benzothiadiazole-7-carbothioate, and spiro[2H]-1-benzopyrane-2,1′(3′H)-isobenzofuran]-3′-one, N-trichloromethyl)thio-4-cyclohexane-1,2-dicarboximide, tetramethylthioperoxydicarbonic diamide, methyl N-(2,6-dimethylphenyl)-N-(methoxyacetyl)-DL-alaninate, 4-(2,2-difluoro-1,3-benzodioxol-4-yl)-1-H-pyrrol-3-carbonitril, or any combination thereof.

Examples of active ingredients include organic phosphorous agents, carbonate agents, carboxylates, chlorinated hydrocarbons, and materials produced from microorganisms. The additional active ingredient may comprise alanycarb, aldicarb, aldoxycarb, allyxycarb, aminocarb, bendiocarb, benfuracarb, bufencarb, butacarb, butocarboxim, butoxycarboxim, carbaryl, carbofuran, carbosulfan, cloethocarb, dimetilan, ethiofencarb, fenobucarb, fenothiocarb, formetanate, furathiocarb, isoprocarb, metam-sodium, methiocarb, methomyl, metolcarb, oxamyl, pirimicarb, promecarb, propoxur, thiodicarb, thiofanox, trimethacarb, XMC, xylylcarb, and triazamate; acephate, azamethiphos, azinphos (-methyl, -ethyl), aromophos-ethyl, aromfenvinfos (-methyl), autathiofos, cadusafos, carbophenothion, chlorethoxyfos, chlorfenvinphos, chlormephos, chlorpyrifos (-methyl-ethyl), coumaphos, cyanofenphos, cyanophos, chlorfenvinphos, demeton-S-methyl, demeton-S-methylsulphone, dialifos, diazinone, dichlofenthione, dichlorvos/DDVP, dierotophos, dimethoate, dimethylvinphos, dioxabenzofos, disulfoton, EPN, ethion, ethoprophos, etrimfos, famphur, fenamiphos, fenitrothion, fensulfothion, fenthion, flupyrazofos, fonofos, formothion, fosmethilan, fosthiazate, heptenophos, iodofenphos, iprobenfos, isazofos, isofenphos, isopropyl O-salicylate, isoxathion, malathion, mecarbam, methacrifos, methamidophos, methidathion, mevinphos, monocrotophos, naled, omethoate, oxydemeton-methyl, parathion (-methyl/-ethyl), phenthoate, phorate, phosalone, phosmet, phosphamidone, phosphocarb, Phoxim, pirimiphos (-methyl/-ethyl), profenofos, propaphos, propetamphos, prothiofos, prothoate, pyraclofos, pyridaphenthion, pyridathion, quinalphos, sebufos, sulfotep, sulprofos, tebupirimfos, temephos, terbufos, tetrachlorvinphos, thiometon, triazophos, triclorfon, vamidothion; acrinathrin, allethrin (d-cis-trans, d-trans), beta-cyfluthrin, bifenthrin, bioallethrin, bioallethrin-S-cyclopentyl-isomer, bioethanomethrin, biopermethrin, bioresmethrin, chlovaporthrin, cis-cypermethrin, cis-resmethrin, cis-permethrin, clocythrin, cycloprothrin, cyfluthrin, cyhalothrin, cypermethrin (alpha-, beta-, theta-, zeta), cyphenothrin, deltamethrin, empenthrin (jR-isomer), esfenvalerate, etofenprox, fenfluthrin, fenpropathrin, fenpyrithrin, fenvalerate, flubrocythrinate, flucythrinate, flufenprox, flumethrin, fluvalinate, fubfenprox, gamma-cyhalothrin, imiprothrin, kadethrin, lambda-cyhalothrin, metofluthrin, permethrin (cis-, trans-), phenothrin (1R-trans isomer), prallethrin, profluthrin, protrifenbute, pyresmethrin, resmethrin, RU 15525, silafluofen, tau-fluvalinate, tefluthrin, terallethrin, tetramethrin (-1R-isomer), tralomethrin, transfluthrin, ZXI 8901, pyrethrins (pyrethrum); DDT; acetamiprid, clothianidin, dinotefuran, imidacloprid, nitenpyram, nithiazine, thiacloprid, thiamethoxam, nicotine, bensultap, cartap; spinosad; camphechlor, chlordane, endosulfan, gamma-HCH, HCH, heptachlor, lindane, methoxychlor; Fiproles, such as for example acetoprole, ethiprole, fipronil, pyrafluprole, pyriprole, and vaniliprole; avermectin, emamectin, emamectin benzoate, ivermectin, milbemycin, latidectin, lepimectin, selamectin, doramectin, eprinomectin, and moxidectin; diofenolan, epofenonane, fenoxycarb, hydroprene, kinoprene, methoprene, pyriproxifen, and triprene; depsipeptides, such as emodepside; chromafenozide, halofenozide, methoxyfenozide, tebufenozide; bistrifluron, chlorfluazuron, diflubenzuron, fluazuron, flucycloxuron, flufenoxuron, hexaflumuron, lufenuron, novaluron, noviflumuron, penfluron, teflubenzuron, triflumuron; buprofezin; cyromazine; diafenthiuron; cyhexatin, fenbutatin-oxide; chlorfenapyr; dinitrophenols, such as for example binapacyrl, dinobuton, dinocap, DNOC; fenazaquin, fenpyroximate, pyrimidifen, pyridaben, tebufenpyrad, tolfenpyrad; hydramethylnon; dicofol; rotenones; acequinocyl, fluacrypyrim; Bacillus thuringiensis strains; tetronic acids, such as spirodiclofen, spiromesifen; tetramic acids, such as spirotetramat, 3-(2,5-dimethylphenyl)-8-methoxy-2-oxo-1-azaspiro[4.5]dec-3-en-4-yl ethyl carbonate; carboxamaides, such as flonicamid; amitraz; flubendiamide; thiocyclam hydrogen oxalate, and thiosultap-sodium.

Suitable bactericides include kasugamycin, tetracycline, oxytetracyline, streptomycin, bacterial control agents, copper fungicides, neem oil, vinegar, or a combination of any thereof.

For example, the fungicide can comprise a strobilurin, a conazole, or a combination thereof.

The fungicide can comprise pyraclostrobin, metconazole, or a combination thereof.

As another example, the fertilizer can comprise azoxystrobin.

Further, the fertilizer can comprise trifloxystrobin, prothioconazole, or a combination thereof.

When a fertilizer is included in the compositions of the present invention, the fertilizer can comprise a foliar nitrogen fertilizer, a foliar phosphorous fertilizer, a foliar manganese fertilizer, or a combination of any thereof.

The pH of the composition can be adjusted to be acidic, alkaline, or neutral, depending on the particular needs of the user. For example, the pH can be from about 4 to about 10.

The components of the compositions described herein can also be provided in a kit. Thus, the present invention also relates to a kit comprising an osmoprotectant and/or an anti-desiccant and/or an anti-respirant, and instructions for applying the osmoprotectant and/or the anti-desiccant and/or the anti-respirant to a plant for increasing crop productivity, wherein the osmoprotectant, the anti-desiccant, and the anti-respirant are different from one another.

For example, provided herein is a kit comprising an osmoprotectant, an anti-desiccant, an anti-respirant, and instructions for applying the osmoprotectant, the anti-desiccant, and the anti-repsirant to a plant for increasing crop productivity. The osmoprotectant, the anti-desiccant, and the anti-respirant are different from one another.

A further kit is provided. The kit comprises an osmoprotectant, an anti-desiccant, and instructions for applying the osmoprotectant and the anti-desiccant to a plant for increasing crop productivity. The the osmoprotectant and the anti-desiccant are different from one another.

Another kit is provided. The kit comprises an osmoprotectant, an anti-respirant, and instructions for applying the osmoprotectant and the anti-respirant to a plant for increasing crop productivity. The osmoprotectant and the anti-repsirant are different from one another.

Yet another kit is provided. The kit comprises a first osmoprotectant, a second osmoprotectant, and instructions for applying the first osmoprotectant and the second osmoprotectant to a plant for increasing crop productivity. The first osmoprotectant and the second osmoprotectant are different from one another.

A further kit is provided. The kit comprises an anti-desiccant, an anti-respirant, and instructions for applying the anti-desiccant and the anti-respirant to a plant for increasing crop productivity. The anti-desiccant and the anti-respirant are different from one another.

Additional compositional components described above can also be included in any of the kits.

Where the components of the compositions described herein can are provided in a kit, each component can be provided in a separate container within the kit. For example, the kit may contain separate containers containing an osmoprotectant, an anti-respirant, and/or an antidesiccant. Similarly, where the kit contains first and second osmoprotectants, the first and second osmoprotectants can be provided in separate containers within the kit.

Where the components of the compositions are provided in separate containers within the kit, the components can then be combined with one another into a single composition by the end-user prior to application to the plant. Alternatively, the end-user can apply the components to the plants sequentially, without combining the components with one another prior to application to the plant.

In addition, where the kit contains concentrated, dry, or granulated forms of one or more of the osmprotectant(s), the anti-desiccant, and/or the anti-respirant, it may be necessary for the end-user to dilute or reconstitute the osmprotectant(s), the anti-desiccant, and/or the anti-respirant prior to application to the plant.

Any of the compositions described herein and any of the chemical components of any of the kits described herein can be provided as a solid or liquid. For example, any of the compositions or any of the chemical components of any of the kits can be in the form of wet or dry granules. For instance, any of the compositions described herein can be in the form of a wet dispersible granule. Likewise, in any of the kits described herein, the osmoprotectant and/or the anti-desiccant and/or the antiperspirant can be in the form of wet or dry granules (e.g., wet dispersible granules.

As another example, any of the compositions provided herein can be in the form of a dry powder. Likewise, in any of the kits described herein, the the osmoprotectant and/or the anti-desiccant and/or the antiperspirant can be in the form of a dry powder.

When the composition, the osmoprotectant, anti-desiccant, or the anti-respirant is provided in solid or dry form (e.g., as a dry powder or a as a wet dispersible granule), the solid or dry form is suitably mixed with any agriculturally acceptable liquid (e.g., water) prior to application to a plant or plant part.

Where the composition is in a solid form (e.g., a dry powder or wet dispersible granule), or where one or more chemical components of a kit are provided in solid form, the active ingredients (e.g., the osmoprotectant and/or the anti-desiccant and/or the osmoprotectant) are present at a combined concentration of from about 0.001% (w/w) to 99.5% (w/w), preferably from about 5% (w/w) to about 98% (w/w), and more preferably from about 40% to about 97.5% (w/w).

For example, where the composition is in a solid form and the composition comprises a betaine, a proline, a carbohydrate, or a betaine or proline homolog or analog, or wherein the kit comprises betaine, a proline, a carbohydrate, or a betaine or proline homolog or analog, the betaine, the betaine homolog, the betaine analog, the proline, the proline homolog, the proline analog, or the carbohydrate can be present at a concentration of about 0.05% (w/w) to about 99% (w/w).

A method for increasing crop productivity of a plant as compared with an untreated plant is also provided herein. The method comprises optionally diluting in a suitable volume of water an effective amount of the composition as described above to form an application composition, and exogenously applying the composition to the plant. The untreated plant has been subject to the same conditions as the plant without being treated with the application composition. When the concentrate composition is used, it is diluted in a suitable volume of water to form the application composition.

Another aspect of the present invention is directed to a method for increasing crop productivity of a plant as compared with an untreated plant, wherein the method comprises exogenously applying to the plant an osmoprotectant, an anti-desiccant, and an anti-respirant within a treatment period. The untreated plant is subject to the same conditions as the plant but has not been treated with the osmoprotectant, the anti-desiccant, and the anti-respirant.

The invention is also directed to a method for increasing crop productivity of a plant as compared with an untreated plant, wherein the method comprises exogenously applying to the plant an osmoprotectant and an anti-desiccant within a treatment period. The untreated plant is subject to the same conditions as the plant but has not been treated with the osmoprotectant and the anti-desiccant.

The invention is further directed to a method for increasing crop productivity of a plant as compared with an untreated plant, wherein the method comprises exogenously applying to the plant an osmoprotectant and an anti-respirant within a treatment period, the untreated plant not being treated with the osmoprotectant and anti-respirant but subject to the same conditions as the plant.

The invention is still further directed to a method for increasing crop productivity of a plant as compared with an untreated plant, wherein the method comprises exogenously applying to the plant an anti-desiccant and an anti-respirant within a treatment period, the untreated plant not being treated with the anti-desiccant and anti-respirant but subject to the same conditions as the plant.

In any of these methods, the increased crop productivity may comprise increased yield, increased plant parts or storage organs, increased water function, increased stress tolerance, increased protection against an abiotic stressor, enhanced phenotypic characteristics, enhanced storability, increased protection against herbicide injury, increased sensitivity of a weed to an herbicide, increased efficacy of an herbicide, improved maintenance of the health and vigor of flower, increased growth rate, or a combination of any thereof.

The increased yield can comprise increased floral organs, increased number of flowers, increased number of seeds, increased pod fill, increased number of seed per pod, larger seeds per pod, increased pod retention, increased grain set, increased number of grains, increased grain fill, increased fruit set, increased number of fruits, larger fruits, or a combination of any thereof.

The increased plant parts or storage organs can comprise increased root tubers, increased stem tubers, increased rhizomes, increased stolons, increased corms, increased pseudobulbs, increased bulbs, or a combination of any thereof.

The increased water function can comprise increased water movement into and through the plant, greater water retention, increased water-use efficiency, increased turgor, or a combination of any thereof.

The improved maintenance of the health and vigor of flowers can comprise improved longevity of flowers.

For the example, the improved maintenance of the health and vigor of flowers can occur during storage, transport, transplant, or a combination of any thereof of the flowers.

The flowers can comprise cut flowers.

Alternatively, the flowers can comprise uncut flowers.

The abiotic stressor can comprise high temperatures, such as temperatures above 29° C., low temperatures, such as temperatures below 12° C., water deficit, drought, desiccation, high humidity, such as humidity above 60%, low humidity, such as humidity below 30%, fluctuations in humidity, osmotic fluctuations, high salinity, increased transpiration, low soil moisture, UV stress, radiation stress, or a combination of any thereof.

For example, the high salinity can comprise an environment wherein the electrical conductivity is at least 4.00 milliohms per centimeter.

For example, the abiotic stressor can comprise high salinity and the increased protection against the abiotic stressor can comprise improved plasma membrane integrity, improved plasma membrane recovery, improved reversal of plasma membrane permeability, or a combination of any thereof, following exposure to the high salinity.

As another example, the abiotic stressor can comprise temperatures above 29° C., water deficit, drought, a combination of any thereof, and the increased protection against the abiotic stressor can comprise improved plant recovery following exposure to the temperatures above 29° C., water deficit, or drought.

Enhanced phenotypic characteristics can comprise increased chlorophyll, increased duration for greenness, reduced senescence, increased turgor, enhanced plant growth and appearance, prevention of chlorosis, prevention of stunted growth, prevention of leaf rolling, prevention of leaf curling, prevention of leaf, floral, and/or fruit abscission, or a combination of any thereof.

The enhanced phenotypic characteristic can comprise increased duration of greenness. Stay green phenotypes in crop plants can be associated with increased chlorophyll and other protective pigments that increase a plant's ability to withstand drought and water deficit conditions that are generally accompanied by heat and low humidity stress. A stay green phenotype can also be described as a prolonged greenness in plants or a delayed period of senescence during grain fill. Stay green phenotypes are desirable and provide longer periods of time that the plants are undergoing active photosynthesis and grain filling, for example, as occurs later in the field season for corn.

The compositions and methods provided herein can provide several benefits to plants, especially plants of the nursery and lawn and garden variety, such as reduction in transplant shock, reduction in post-harvest losses, improved vigor of nursery cutting, increased success of propagation, increased success of grafting (citrus industry), increased tolerance to cold stress, increased tolerance to heat stress, increased freeze tolerance, decreased loss from water logging or drench stress, increased tolerance to salt stress, increased tolerance to oxidative and radiation stress (ultraviolet stress), improved desiccation to water deficit stress, improved tolerance to extreme temperature fluctuations, increased tolerance to humidity stress (high humidity and low humidity), increased yield benefits (harvestable yield), increased flower yield (number) and retention of flowers (blooming time), increased longevity and vigor, and decreased or slowed senescence (more pronounced stay green phenotype), among others.

The compositions and methods described herein are useful in treating plants that will be subjected to a period of less favorable growing conditions such as during storage or shipment. Climate control in transportation vehicles that move plants from the nursery to distributor may not be optimal in regards to air movement, temperature and humidity control. Plants grown and transported from commercial greenhouses can spend days in warehouses and in tractor trailers with poor temperature control. Transportation vehicles, warehouses and many spaces used for storage or transport are generally not adequately temperature-controlled or well-insulated and may experience dramatic temperature fluctuations in heat and cold. Plants may also be transported or stored in close proximity to one another leading to a surrounding environment with heat build-up and poor air flow. For delicate and even heartier plants, longer transportation time may pose a precarious situation to plant health and survivability. Many plants cannot tolerate a shipment transport that lasts for more than 48 hours.

The compositions are suitable for use in greenhouses but are also suitable for use before, during or after storage, transportation and other indoor operations. All major growers and distributors suffer some percentage of product loss during the storage and transportation phases. These losses could occur from desiccation or water loss from plants or plant parts during transport or storage in tightly packed or stacked situations (rack storage). The plants may also be exposed to rapid temperature and humidity changes. The agricultural compositions of the present invention and described in the osmoprotectant used in combination an anti-desiccant and/or an anti-respirant can be used to reduce and minimize post-harvest product loss.

The main causes of winter damage to trees and shrubs, such as broadleaf evergreens, conifers, rose and hydrangeas, is through desiccation or drying out, particularly during the winter months if the ground freezes and roots are unable to obtain additional water from the soil and rely on the water primarily stored in their roots or stems for survival. This type of scenario can be problematic for evergreen trees and shrubs that do not drop their leaves in the winter. The osmoprotectant, anti-desiccant and anti-respirant properties of the agricultural compositions as described are used to retain moisture in the plant. In regions that experience drier and harsher winters, these agricultural compositions can be used with multiple applications throughout the winter season and during the coldest months.

The agricultural compositions are also useful to prevent moisture losses from bulbs, pseudobulbs, corms, tubers, root stocks, scions during pre-planting, pre-storage or transplanting to reduce transplant shock and promote vigor while the plants put out new roots or during grafting practices (root stocks and scions). The agricultural compositions can also be used to extend the storage or shelf life of fruits and vegetables, tubers, pumpkins, gourds, and other harvested plants or plant parts, for example, Christmas trees.

Live cut flowers have a limited life or longevity. The majority of cut flowers can be expected to last several days with proper care. The agricultural compositions can be provided exogenously as a foliar application, a dip or drench or as an additive that can be added to a water or gel-based solution to extend the longevity of a flower's life and freshness. The agricultural compositions are also suitable for maintaining the health and vigor of flowers (cut or uncut) during storage, transport and transplant activities.

As an alternative to use of a composition formulated to include an osmoprotectant and an anti-desiccant and/or anti-respirant, the osmoprotectant, the anti-desiccant, and the anti-respirant, or the osmoprotectant and the anti-desiccant, or the osmoprotectant and the anti-respirant, or the anti-desiccant and the anti-respirant can be applied to the plant simultaneously or sequentially. By “simultaneously,” it is meant that the application of the components at least partially overlap in time, although initiation and/or completion of the application of the components may not be simultaneous.

In these methods, the osmoprotectant, the anti-desiccant, and the anti-respirant, or the osmoprotectant and the anti-desiccant, or the osmoprotectant and the anti-respirant, or the anti-desiccant and the anti-respirant are applied to the plant in separate compositions rather than being co-formulated as a composition.

When the osmoprotectant and/or anti-desiccant and/or anti-respirant are applied separately, the osmoprotectant, anti-desiccant and anti-respirant can be selected from the osmoprotectants, anti-desiccants and anti-respirants as described herein for the agricultural composition

The osmoprotectant can be applied in an amount of from about 29.57 to about 1774.41 mL per hectare (1 to 60 fluid ounces per acre).

The osmoprotectant can be applied in an amount of from about 29.57 to about 739.34 mL per hectare (1 to 25 fluid ounces per acre).

In methods where the osmoprotectant comprises a betaine, the betaine can be applied in an amount of from about 8.87 to about 2365.88 mL per hectare, or from about 236.59 to about 709.76 mL per hectare.

Where the osmoprotectant comprises a betaine, the betaine can be applied in an amount of from about 29.57 to about 1774.41 mL per hectare (1 to 60 fluid ounces per hectare), from about 29.57 to about 414.03 mL per hectare (1 to 14 fluid ounces per hectare), or from about 207.02 to about 739.34 mL per hectare (7 to about 25 fluid ounces per hectare).

For example, the betaine can be applied in an amount from about 8.87 to about 2365.88 mL per hectare.

The betaine can be applied in an amount from about 236.59 to about 709.76 mL per hectare.

Alternatively, the betaine can be applied in an amount of from about 29.57 to about 1774.41 mL per hectare (1 to 50 fluid ounces per hectare).

The betaine can be applied in an amount of from about 29.57 to 414.03 mL per hectare (1 to 14 fluid ounces per hectare).

The betaine can be applied in an amount of from about 207.02 to about 739.34 mL per hectare (7 to 25 fluid ounces per hectare).

In methods where the osmoprotectant comprises a proline, the proline can be applied in an amount of from about 8.87 to about 2365.88 mL per hectare or from about 236.59 to about 709.76 mL per hectare.

Where the osmoprotectant comprises a proline, the proline can be applied in an amount of from about 29.57 to about 1774.41 mL per hectare (1 to 60 fluid ounces per hectare), from about 29.57 to about 414.03 mL per hectare (1 to 14 fluid ounces per hectare), or from about 207.02 to about 739.34 mL per hectare (7 to about 25 fluid ounces per hectare).

For example, the proline can be applied in an amount from about 7.3 to about 2338.5 mL per hectare (0.1 to 32 fluid ounces per acre).

The proline can be applied in an amount from about 233.8 to 701.5 mL per hectare (3.2 to 9.6 fluid ounces per acre).

Alternatively, the proline can be applied in an amount of from about 29.57 to about 1774.41 mL per hectare (1 to 60 fluid ounces per hectare).

The proline can be applied in an amount of from about 29.57 to 414.03 mL per hectare (1 to 14 fluid ounces per hectare).

The proline can be applied in an amount of from about 207.02 to about 739.34 mL per hectare (7 to 25 fluid ounces per hectare).The proline can be applied in an amount of from about 8.87 mL per hectare to about 2365.88 mL per hectare.

For example, the proline can be applied in an amount of from about 236.59 to about 709.76 mL per hectare.

In methods wherein an anti-desiccant is applied, the anti-desiccant can be applied in an amount of from about 29.57 to about 2070.15 mL per hectare (1 to 70 fluid ounces per hectare), or from about 29.57 to about 739.34 mL per hectare (1 to 25 fluid ounces per hectare).

For example, the anti-desiccant can be applied in an amount of from about 29.57 to about 2070.15 mL per hectare (1 to 70 fluid ounces per hectare).

As another example, the anti-desiccant can be applied in an amount of from about 29.57 to about 739.34 mL per hectare (1 to 25 fluid ounces per hectare).

In methods wherein an anti-respirant is applied, it can be applied in an amount of from about 29.57 to about 1478.68 mL per hectare (1 to 50 fluid ounces per hectare), or from about 29.57 to about 739.34 mL per hectare (1 to 25 fluid ounces per hectare).

For example, the anti-respirant can be applied in an amount of from about 29.57 to about 1478.68 mL per hectare (1 to about 50 fluid ounces per hectare).

As a further example, the anti-respirant can be applied in an amount of from about 29.57 to about 739.34 mL per hectare (1 to 25 fluid ounces per hectare).

In methods wherein the agricultural composition is applied, the composition can be applied in an amount of from about 29.57 to about 1478.68 mL per hectare (1 to 50 fluid ounces per hectare), or from about 29.57 to about 739.34 mL per hectare (1 to 25 fluid ounces per hectare).

For example, the agricultural composition can be applied in an amount of from about 29.57 to about 1478.68 mL per hectare (1 to 50 fluid ounces per hectare).

As another example, the agricultural composition can be applied in an amount of from about 29.57 to about 739.34 mL per hectare (1 to 25 fluid ounces per hectare).

The osmoprotectant, the anti-desiccant, and the anti-respirant, or the osmoprotectant and the anti-desiccant, or the osmoprotectant and the anti-respirant can be applied one or more times during a growing season. For example, the osmoprotectant, the anti-desiccant, and the anti-respirant, or the osmoprotectant and the anti-desiccant, or the osmoprotectant and the anti-respirant, or the anti-desiccant and the anti-respirant can be applied one time, two times, three times, four times, five times, or more than five times during a growing season.

In methods where the osmoprotectant and/or the anti-desiccant and/or the anti-respirant are applied two or more times during a growing season, the first application can occur at or before the V8 stage of development, and subsequent applications can occur before the plant flowers.

The first application can also occur to the plant growth media (e.g., soil surrounding the plant) prior to planting, and subsequent applications can occur after planting (e.g., application to the plant before the plant flowers).

For example, the first application can occur as a seed treatment, or at/or before the VE stage of development, at or before the V1 stage of development, at or before the V2 stage of development, at or before the V3 stage of development, at or before the V4 stage of development, at or before the V5 stage of development, at or before the V6 stage of development, at or before the V7 stage of development, at or before the V8 stage of development, at or before the V9 stage of development, at or before the V10 stage of development, at or before the V11 stage of development, at or before the V12 stage of development, at or before the V13 stage of development, at or before the V14 stage of development, at or before the V15 stage of development, at or before the VT stage of development, at or before the R1 stage of development, at or before the R2 stage of development, at or before the R3 stage of development, at or before the R4 stage of development, at or before the R6 stage of development, at or before the R7 stage of development, or at or before the R8 stage of development.

By way of example, the first application can occur at or before the germination stage, at or before the seedling stage, at or before the tillering stage, at or before the stem elongation stage, at or before the booting stage, or at or before the heading stage. For example, where the Feekes scale is used to identify the stage of growth of a cereal crop, the first application can occur at or before stage 1, at or before stage 2, at or before stage 3, at or before stage 4, at or before stage 5, at or before stage 6, at or before stage 7, at or before stage 8, at or before stage 9, at or before stage 10, at or before stage 10.1, at or before stage 10.2, at or before stage 10.3, at or before stage 10.4, or at or before stage 10.5.

For example, the treatment period can be from about V2 to about R8, from about V3 to about V8, from about VT to about R2, from about R2 to about R8, from before the VE stage of development to about R8, or from before the VE stage of development to about V3.

The increased crop productivity can comprise increased growth rate and the treatment period can be from before the VE stage of development to about V3.

The vegetative (V) and reproductive (R) stages of various plants (including corn and soybean) are known in the art and are described, for example, in Ransom, Corn Growth and Management Quick Guide, North Dakota State University (NDSU) Extension Service (May 2013; available at https://www.ag.ndsu.edu/pubs/plantsci/crops/a1173.pdf), and Naeve, Soybean Production: Growth and Development—Growth Stages, University of Minnesota Extension Service (2011; available at https://www.extension.umn.edu/agriculture/soybean/growth-and-development/growth-stages/), both of which are incorporated herein by reference in their entirety.

The optional second and subsequent applications can also occur at any of the stages as described above. Preferably, where there is more than one application, the different applications occur at different stages of growth. More preferably, the second and subsequent applications occur before the plant begins to flower.

As an example, the osmoprotectant, the anti-desiccant, and the anti-respirant can be applied one or more times during a growing season.

The osmoprotectant, the anti-desiccant, and the anti-respirant can be applied more than one time during the growing season, and the first administration can occur at or before the V8 stage of development and subsequent administrations can occur before the plant flowers.

As another example, the osmoprotectant and the anti-desiccant can be applied one or more times during a growing season.

The osmoprotectant and the anti-desiccant can be applied more than one time during the growing season, and the first administration can occur at or before the V8 stage of development and subsequent administrations can occur before the plant flowers.

As a further example, the osmoprotectant and the anti-respirant can be applied one or more times during a growing season.

The osmoprotectant and the anti-respirant can be applied more than one time during the growing season, and the first administration can occur at or before the V8 stage of development and subsequent administrations can occur before the plant flowers.

As a still further example, the anti-desiccant and the anti-respirant can be applied one or more times during a growing season.

The anti-desiccant and the anti-respirant can be applied more than one time during the growing season, and the first administration can occur at or before the V8 stage of development and subsequent administrations can occur before the plant flowers.

The number of applications and the amount of osmoprotectant and anti-desiccant and/or anti-respirant applied to a particular plant can be dependent upon plant type, type of osmoprotectant, anti-desiccant and/or anti-respirant applied, and environmental conditions, among other factors. Environmental conditions comprise such occurrences as high salinity, high temperature, low temperature, water deficit, drought, desiccation, high humidity, low humidity, temperature fluctuations, humidity fluctuations, osmotic fluctuations, increased transpiration, low soil moisture, UV stress, radiation stress, and others. The number of applications and amount applied to a particular plant can also be dependent upon desired phenotypic characteristics.

In any of the methods, the osmoprotectant and/or the anti-desiccant and/or the anti-respirant can be applied as a seed treatment or as a soil treatment applied to the area surrounding a plant, plant part, or seed.

In any of the methods, the osmoprotectant and/or the anti-desiccant and/or the anti-respirant can be applied exogenously to plants or plant parts or as a foliar spray, an in-furrow spray, a drench, a drip line or irrigation additive, an aerial application, or impregnated on soil or soilless particle or matrix which allows for direct contact to a plant, a plant part, or a plant seed. The osmoprotectant and/or the anti-desiccant and/or the anti-respirant can be applied as an aqueous solution, an emulsion, a suspension, a granular composition, or a powder. The term “exogenous application” is intended to refer to any application method that causes the application composition to come into contact with the plant, plant part, or plant seed and includes any of the methods described above, including application to the soil or the area surrounding the plant, plant part, or plant seed.

When the osmoprotectant and/or the anti-desiccant and/or the anti-respirant are applied to a plant within a treatment period, the treatment period can be from about VE to about V4, from about V3 to about V8, from about VT to about R2 or from about R1 to about R8. For example, the treatment period can be less than about one minute, less than about two minutes, less than about five minutes, less than about thirty minutes, less than about one hour, less than about two hours, less than about five hours, or less than about one day.

“Growing season” is defined as the period of time in which a plant exhibits plant growth. A growing season may be different based on geographical location or plant type. A growing season may differ from year to year based on environmental factors. By way of example, the growing season may be defined as the time between the last time the low temperature falls below 0° C. in the spring and the first time the low temperature falls below 0° C. in the fall. In other areas, the growing season may be defined as the period of time where average rainfall surpasses a given amount (e.g., the rainy season). However, in tropical regions, the rainy season may interrupt the growing season by excess rainfall.

Further, the compositions and methods of the present invention can be used to protect plants against herbicide injury. Herbicides can be phytotoxic especially to non-target sensitive plants when applied at use rates for controlling or inhibiting the growth of weeds. Crop yield can be negatively impacted by injury from herbicides on plants. The compositions and methods can increase the herbicide tolerance of non-target plants such as corn and soybean and prevent against plant injury. The agricultural compositions are particularly well suited for use on plants that do not normally store or accumulate osmolytes such as betaines or prolines in their cells.

The compositions and methods provided using betaine and proline treatments as described can be used to protect against pesticide drift or volatility in sensitive plants that are planted nearby where a pesticide application is to be or has already been applied. Foliar or in-furrow treatments to protect plants can be either applied prophylactically before, or during or after, the application of an herbicide. These protective foliar applications can be applied to plants after an herbicide has been delivered to a neighboring field, or applied to as an in-furrow treatment to the area surrounding a seed, such as seeds planted in field where pre-plant burndown procedures have been used.

The application use rates, the timing of application and the physiology of the plant can be optimized to make a plant more susceptible to the herbicidal activity or provide a protective advantage to prevent herbicide injury (for example, herbicides in the phenoxy class such as dicamba).

The agricultural composition and methods described herein can be used in connection with any species of plant and/or the seeds thereof. The compositions and methods are typically used in connection with seeds that are agronomically important. The seed can be a transgenic seed from which a transgenic plant can grow that incorporates a transgenic event that confers, for example, tolerance to a particular herbicide or combination of herbicides, increased disease resistance, enhanced tolerance to insects, drought, stress and/or enhanced yield. The seed can comprise a breeding trait, including for example, a disease tolerant breeding trait. In some instances, the seed includes at least one transgenic trait and at least one breeding trait.

The compositions and methods can be used for the treatment of any suitable seed type, including, but not limited to row crops and vegetables. For example, one or more plants or plant parts or the seeds of one or more plants can comprise abaca (manila hemp) (Musa textilis), alfalfa for fodder (Medicago sativa), alfalfa for seed (Medicago sativa), almond (Prunus dulcis), anise seeds (Pimpinella anisum), apple (Malus sylvestris), apricot (Prunus armeniaca), areca (betel nut) (Areca catechu), arracha (Arracacia xanthorrhiza), arrowroot (Maranta arundinacea), artichoke (Cynara scolymus), asparagus (Asparagus officinalis), avocado (Persea americana), bajra (pearl millet) (Pennisetum americanum), bambara groundnut (Vigna subterranea), banana (Musa paradisiaca), barley (Hordeum vulgare), beans, dry, edible, for grains (Phaseolus vulgaris), beans, harvested green (Phaseolus and Vigna spp.), beet, fodder (mangel) (Beta vulgaris), beet, red (Beta vulgaris), beet, sugar (Beta vulgaris), beet, sugar for fodder (Beta vulgaris), beet, sugar for seeds (Beta vulgaris), bergamot (Citrus bergamia), betel nut (Areca catechu), black pepper (Piper nigrum), black wattle (Acacia mearnsii), blackberries of various species (Rubus spp.), blueberry (Vaccinium spp.), Brazil nut (Bertholletia excelsa), breadfruit (Artocarpus altilis), broad bean, dry (Vicia faba), broad bean, harvested green (Vicia faba), broccoli (Brassica oleracea var. botrytis), broom millet (Sorghum bicolor), broom sorghum (Sorghum bicolor), Brussels sprouts (Brassica oleracea var. gemmifera), buckwheat (Fagopyrum esculentum), cabbage, red, white, Savoy (Brassica oleracea var. capitata), cabbage, Chinese (Brassica chinensis), cabbage, for fodder (Brassica spp.), cacao (cocoa) (Theobroma cacao), cantaloupe (Cucumis melo), caraway seeds (Carum carvi), cardamom (Elettaria cardamomum), cardoon (Cynara cardunculus), carob (Ceratonia siliqua), carrot, edible (Daucus carota spp. sativa), carrot, for fodder (Daucus carota sativa), cashew nuts (Anacardium occidentale), cassava (manioc) (Manihot esculenta), castor bean (Ricinus communis), cauliflower (Brassica oleracea var. botrytis), celeriac (Apium graveolens var. rapaceum), celery (Apium graveolens), chayote (Sechium edule), cherry, all varieties (Prunus spp.), chestnut (Castanea sativa), chickpea (gram pea) (Cicer arietinum), chicory (Cichorium intybus), chicory for greens (Cichorium intybus), chili, dry (all varieties) (Capsicum spp. (annuum)), chili, fresh (all varieties) (Capsicum spp. (annuum)), cinnamon (Cinnamomum verum), citron (Citrus medica), citronella (Cymbopogon citrates; Cymbopogon nardus), clementine (Citrus reticulata), clove (Eugenia aromatica; Syzygium aromaticum), clover for fodder (all varieties) (Trifolium spp.), clover for seed (all varieties) (Trifbolium spp.), cocoa (cacao) (Theobroma cacao), coconut (Cocos nucifera), cocoyam (Colocasia esculenta), coffee (Coffea spp.), cola nut, all varieties (Cola acuminata), colza (rapeseed) (Brassica napus), corn (maize), for cereals (Zea mays), corn (maize), for silage (Zea mays), corn (maize), for vegetable (Zea mays), corn for salad (Valerianella locusta), cotton, all varieties (Gossypium spp.), cottonseed, all varieties (Gossypium spp.), cowpea, for grain (Vigna unguiculata), cowpea, harvested green (Vigna unguiculata), cranberry (Vaccinium spp.), cress (Lepidium sativum), cucumber (Cucumis sativus), currants, all varieties (Ribes spp.), custard apple (Annona reticulate), dasheen (Colocasia esculenta), dates (Phoenix dactylifera), drumstick tree (Moringa oleifera), durra (Sorghum) (Sorghum bicolour), durum wheat (Triticum durum), earth pea (Vigna subterranea), edo (eddoe) (Xanthosoma spp.; Colocasia spp.), eggplant (Solanum melongena), endive (Cichorium endivia), fennel (Foeniculum vulgare), fenugreek (Trigonella foenum-graecum), fig (Ficus carica), filbert (hazelnut) (Corylus avellana), fique (Furcraea macrophylla), flax for fiber (Linum usitatissimum), flax for oil seed (linseed) (Linum usitatissimum), formio (New Zealand flax) (Phormium tenax), garlic, dry (Allium sativum), garlic, green (Allium sativum), geranium (Pelargonium spp.; Geranium spp.), ginger (Zingiber officinale), gooseberry, all varieties (Ribes spp.), gourd (Lagenaria spp; Cucurbita spp.), gram pea (chickpea) (Cicer arietinum), grape (Vitis vinfera), grapefruit (Citrus paradisi), grapes for raisins (Vitis vinifera), grapes for table use (Vitis vinifera), grapes for wine (Vitis vinifera), grass esparto (Lygeum spartum), grass, orchard (Dactylis glomerata), grass, Sudan (Sorghum bicolor var. sudanense), groundnut (peanut) (Arachis hypogaea), guava (Psidium guajava), guinea corn (Sorghum) (Sorghum bicolor), hazelnut (filbert) (Corylus avellana), hemp fiber (Cannabis sativa spp. indica), hemp, manila (abaca) (Musa textilis), hemp, sun (Crotalaria juncea), hempseed (marijuana) (Cannabis sativa), henequen (Agave fourcroydes), henna (Lawsonia inermis), hop (Humulus lupulus), horse bean (Vicia faba), horseradish (Armoracia rusticana), hybrid maize (Zea mays), indigo (Indigofera tinctoria), jasmine (Jasminum spp.), Jerusalem artichoke (Helianthus tuberosus), jowar (Sorghum) (Sorghum bicolor), jute (Corchorus spp.), kale (Brassica oleracea var. acephala), kapok (Ceiba pentandra), kenaf (Hibiscus cannabinus), kohlrabi (Brassica oleracea var. gongylodes), lavender (Lavandula spp.), leek (Allium ampeloprasum; Allium porrum), lemon (Citrus limon), lemongrass (Cymbopogon citratus), lentil (Lens culinaris), lespedeza, all varieties (Lespedeza spp.), lettuce (Lactuca sativa var. capitata), lime, sour (Citrus aurantifolia), lime, sweet (Citrus limetta), linseed (flax for oil seed) (Linum usitatissimum), licorice (Glycyrrhiza glabra), litchi (Litchi chinensis), loquat (Eriobotrya japonica), lupine, all varieties (Lupinus spp.), Macadamia (Queensland nut) (Macadamia spp. ternifolia), mace (Myristica fragrans), maguey (Agave atrovirens), maize (corn) (Zea mays), maize (corn) for silage (Zea mays), maize (hybrid) (Zea mays), maize, ordinary (Zea mays), mandarin (Citrus reticulata), mangel (fodder beet) (Beta vulgaris), mango (Mangifera indica), manioc (cassava) (Manihot esculenta), maslin (mixed cereals) (mixture of Triticum spp. and Secale cereale), medlar (Mespilus germanica), melon, except watermelon (Cucumis melo), millet broom (Sorghum bicolor), millet, bajra (Pennisetum americanum), millet, bulrush (Pennisetum americanum), millet, finger (Eleusine coracana), millet, foxtail (Setaria italica), millet, Japanese (Echinochloa esculenta), millet, pearl (bajra, bulrush) (Pennisetum americanum), millet, proso (Panicum miliaceum), mint, all varieties (Mentha spp.), mulberry for fruit, all varieties (Morus spp.), mulberry for silkworms (Morus alba), mushrooms (Agaricus spp.; Pleurotus spp.; Volvariella), mustard (Brassica nigra; Sinapis alba), nectarine (Prunus persica var. nectarina), New Zealand flax (formio) (Phormium tenax), Niger seed (Guizotia abyssinica), nutmeg (Myristica fragrans), oats, for fodder (Avena spp.), oil palm (Elaeis guineensis), okra (Abelmoschus esculentus), olive (Olea europaea), onion seed (Allium cepa), onion, dry (Allium cepa), onion, green (Allium cepa), opium (Papaver somniferum), orange (Citrus sinensis), orange, bitter (Citrus aurantium), ornamental plants (various), palm palmyra (Borassus flabellifer), palm, kernel oil (Elaeis guineensis), palm, oil (Elaeis guineensis), palm, sago (Metroxylon sagu), papaya (pawpaw) (Carica papaya), parsnip (Pastinaca sativa), pea, edible dry, for grain (Pisum sativum), pea, harvested green (Pisum sativum), peach (Prunus persica), peanut (groundnut) (Arachis hypogaea), pear (Pyrus communis), pecan nut (Carya illinoensis), pepper, black (Piper nigrum), pepper, dry (Capsicum spp.), persimmon (Diospyros kaki; Diospyros virginiana), pigeon pea (Cajanus cajan), pineapple (Ananas comosus), pistachio nut (Pistacia vera), plantain (Musa sapientum), plum (Prunus domestica), pomegranate (Punica granatum), pomelo (Citrus grandis), poppy seed (Papaver somniferum), potato (Solamum tuberosum), palm, kernel oil (Elaeis guineensis), potato, sweet (Ipomoea batatas), prune (Prunus domestica), pumpkin, edible (Cucurbita spp.), pumpkin, for fodder (Cucurbita spp.), pyrethum (Chrysanthemum cinerariaefolium), quebracho (Aspidosperma spp.), Queensland nut (Macadamia spp. ternfolia), quince (Cydonia oblonga), quinine (Cinchona spp.), quinoa (Chenopodium quinoa), ramie (Boehmeria nivea), rapeseed (colza) (Brassica napus), raspberry, all varieties (Rubus spp.), red beet (Beta vulgaris), redtop (Agrostis spp.), rhea (Boehmeria nivea), rhubarb (Rheum spp.), rice (Oryza sativa; Oryza glaberrima), rose (Rose spp.), rubber (Hevea brasiliensis), rutabaga (swede) (Brassica napus var. napobrassica), rye (Secale cereale), ryegrass seed (Lolium spp.), safflower (Carthamus tinctorius), sainfoin (Onobrychis viciifolia), salsify (Tragopogon porrifolius), sapodilla (Achras sapota), satsuma (mandarin/tangerine) (Citrus reticulata), Scorzonera (black salsify) (Scorzonera hispanica), sesame (Sesamum indicum), shea butter (nut) (Vitellaria paradoxa), sisal (Agave sisalana), sorghum (Sorghum bicolor), sorghum, broom (Sorghum bicolor), sorghum, durra (Sorghum bicolor), sorghum, guinea corn (Sorghum bicolor), sorghum, jowar (Sorghum bicolor), sorghum, sweet (Sorghum bicolor), soybean (Glycine max), soybean hay (Glycine max), spelt wheat (Triticum spelta), spinach (Spinacia oleracea), squash (Cucurbita spp.), strawberry (Fragaria spp.), sugar beet (Beta vulgaris), sugar beet for fodder (Beta vulgaris), sugar beet for seed (Beta vulgaris), sugarcane for fodder (Saccharum officinarum), sugarcane for sugar or alcohol (Saccharum officinarum), sugarcane for thatching (Saccharum officinarum), sunflower for fodder (Helianthus annuus), sunflower for oil seed (Helianthus annuus), sunhemp (Crotalaria juncea), swede (Brassica napus var. napobrassica), swede for fodder (Brassica napus var. napobrassica), sweet corn (Zea mays), sweet lime (Citrus limetta), sweet pepper (Capsicum annuum), sweet potato (Lopmoea batatas), sweet sorghum (Sorghum bicolor), tangerine (Citrus reticulata), tannia (Xanthosoma sagittifolium), tapioca (cassava) (Manihot esculenta), taro (Colocasia esculenta), tea (Camellia sinensis), teff (Eragrostis abyssinica), timothy (Phleum pratense), tobacco (Nicotiana tabacum), tomato (Lycopersicon esculentum), trefoil (Lotus spp.), triticale, for fodder (hybrid of Triticum aestivum and Secale cereale), tung tree (Aleurites spp.; Fordii), turnip, edible (Brassica rapa), turnip, for fodder (Brassica rapa), urena (Congo jute) (Urena lobata), vanilla (Vanilla planifolia), vetch, for grain (Vicia sativa), walnut (Juglans spp., especially Juglans regia), watermelon (Citrullus lanatus), wheat (Triticum aestivum), yam (Dioscorea spp.), yerba mate (Ilex paraguariensis).

The compositions and methods disclosed herein can also be applied to turf grass, ornamental grass, flowers, ornamentals, trees, and shrubs. The agricultural compositions are also suitable for use in the nursery, lawn and garden, floriculture or the cut flower industry and provide benefits for enhanced plant productivity, protection health, vigor and longevity. For example, they can be applied to perennials, annuals, forced bulbs, or pseudo bulbs, herbs, groundcovers, trees, shrubs, ornamentals (e.g., orchids, etc.), tropicals, and nursery stock.

Alternatively, the methods described herein can comprise applying to a seed of a plant a seed treatment comprising a pesticide prior to applying to the plant the osmoprotectant and/or anti-desiccant and/or anti-respirant.

Having described the invention in detail, it will be apparent that modifications and variations are possible without departing from the scope of the invention defined in the appended claims.

### EXAMPLES

The following non-limiting examples are provided to further illustrate the present invention.

### Example 1: Preparation of Agricultural Compositions

Compositions 1 to 23 and stachydrine composition 1, each comprising an osmoprotectant, and anti-desiccant, and an anti-respirant, were prepared as indicated in Table 1. Concentration ranges provided in Table 1 are in concentrated (undiluted) form, such as an aqueous solution, a slurry, etc., as could be delivered to a farmer or grower prior to dilution to the recommended application use rate. Anti-respirant control A and anti-respirant control B are also described in Table 1.

TABLE 1
Agricultural concentrate compositions comprising effective concentrations of
osmoprotectant, anti-desiccant, and anti-respirant

| | | | | Other |
|---|---|---|---|---|
| Composition | Osmoprotectant | Anti-desiccant | Anti-respirant | Components |
| Composition 1 | Betaine hydrochloride | Potassium | Alkyl and alkyl lauryl | — |
| | Concentration: 83.49 mM | phosphate tribasic | polyoxyethylene glycol | |
| Composition 2 | L-proline | Concentration: 57 mM | (ALLIGARE | — |
| | Concentration: 163.88 mM | | SURFACE ™) | |
| | | | Concentration: 78.75 mM | |
| Composition 3 | Betaine hydrochloride | Potassium | Alkyl and alkyl lauryl | 0.5% v/v |
| | Concentration: 83.49 mM | phosphate tribasic | polyoxyethylene glycol | (6.4 mM) |
| | L-proline | Concentration: 57 mM | (ALLIGARE | PROXEL |
| | Concentration: 163.88 mM | | SURFACE ™) | BD 20 |
| | | | Concentration: 37.9% | (Preservative) |
| | | | v/v (78.75 mM) | |
| Composition 4 | Betaine hydrochloride | Potassium | Alkyl and alkyl lauryl | 0.5% v/v |
| | Concentration: 83.49 mM | phosphate tribasic | polyoxyethylene glycol | (6.4 mM) |
| | | Concentration: 57 mM | (ALLIGARE | PROXEL |
| | | | SURFACE ™) | BD 20 |
| | | | Concentration: 37.9% | (Preservative) |
| | | | v/v (78.75 mM) | |
| Composition 5 | L-proline | Potassium | Alkyl and alkyl lauryl | 0.5% v/v |
| | Concentration: 163.88 mM | phosphate tribasic | polyoxyethylene glycol | (6.4 mM) |
| | | Concentration: 57 mM | (ALLIGARE | PROXEL |
| | | | SURFACE ™) | BD 20 |
| | | | Concentration: 37.9% | (Preservative) |
| | | | v/v (78.75 mM) | |
| Composition 6 | Betaine hydrochloride | Potassium | Alkyl and alkyl lauryl | 0.5% v/v |
| | Concentration: 83.49 mM | phosphate tribasic | polyoxyethylene glycol | (6.4 mM) |
| | | Concentration: 57 mM | (ALLIGARE | PROXEL |
| | | | SURFACE ™) | BD 20 |
| | | | Concentration: 37.9% | (Preservative) |
| | | | v/v (78.75 mM) | |
| Composition 6-1 | Betaine hydrochloride | Potassium | Alkyl polyoxyethylene | 0.5% v/v |
| | Concentration: 83.49 mM | phosphate tribasic | (ALLIGARE 90) | (6.4 mM) |
| | | Concentration: 57 mM | Concentration: 37.9 | PROXEL |
| | | | v/v % (78.75 mM) | BD 20 |
| | | | | (Preservative) |
| Composition 6-2 | Betaine hydrochloride | Potassium | Alkyl polyoxyethoxylate | 0.5% v/v |
| | Concentration: 83.49 mM | phosphate tribasic | ether | (6.4 mM) |
| | | Concentration: 57 mM | (AQUA SUPREME) | PROXEL |
| | | | Concentration: 37.9 | BD 20 |
| | | | v/v % (78.75 mM) | (Preservative) |
| Composition 7 | Betaine hydrochloride | Potassium | Alkyl polyoxyethylene | 0.5% v/v |
| | Concentration: 83.49 mM | phosphate tribasic | (ALLIGARE 90) | (6.4 mM) |
| | | Concentration: 155 mM | Concentration: 37.9 | PROXEL |
| | | | v/v % (78.75 mM) | BD 20 |
| | | | | (Preservative), |
| | | | | 10 μM sucrose, |
| | | | | 5 μM EDTA |
| Composition 8 | Betaine hydrochloride | Potassium | Alkyl polyoxyethylene | 0.5% v/v |
| | Concentration: 166.98 mM | phosphate tribasic | (ALLIGARE 90) | (6.4 mM) |
| | | Concentration: 155 mM | Concentration: 37.9 | PROXEL |
| | | | v/v % (78.75 mM) | BD 20 |
| | | | | (Preservative) |
| Composition 9 | Betaine hydrochloride | Potassium | Alkyl polyoxyethylene | 0.5% v/v |
| | Concentration: 83.49 mM | phosphate tribasic | (ALLIGARE 90) | (6.4 mM) |
| | L-proline | Concentration: 155 mM | Concentration: 37.9 | PROXEL |
| | Concentration: 163.88 mM | | v/v % (78.75 mM) | BD 20 |
| | | | | (Preservative) |
| | | | | 6.4 mM |
| Composition 10 | Betaine hydrochloride | Potassium | Alkyl and alkyl lauryl | 0.5% v/v |
| | Concentration: 55.66 mM | phosphate tribasic | polyoxyethylene glycol | (6.4 mM) |
| | L-proline | Concentration: 57 mM | (ALLIGARE | PROXEL |
| | Concentration: 163.88 mM | | SURFACE ™) | BD 20 |
| | | | Concentration: 37.9% | (Preservative) |
| | | | v/v (78.75 mM) | |
| Composition 11 | L-proline | Potassium | Alkyl and alkyl lauryl | 0.5% v/v |
| | Concentration: 491.64 mM | phosphate tribasic | polyoxyethylene glycol | (6.4 mM) |
| | | Concentration: 57 mM | (ALLIGARE | PROXEL |
| | | | SURFACE ™) | BD 20 |
| | | | Concentration: 37.9% | (Preservative) |
| | | | v/v (78.75 mM) | |
| Composition 12 | Betaine hydrochloride | Potassium | Alkyl and alkyl lauryl | 0.5% v/v |
| | Concentration: 83.49 mM | phosphate tribasic | polyoxyethylene glycol | (6.4 mM) |
| | L-proline | Concentration: 155 mM | (ALLIGARE | PROXEL |
| | Concentration: 100 mM | | SURFACE ™) | BD 20 |
| | | | Concentration: 37.9% | (Preservative) |
| | | | v/v (78.75 mM) | |
| Composition 13 | Betaine hydrochloride | Potassium | Alkyl and alkyl lauryl | 0.5% v/v |
| | Concentration: 300 mM mM | phosphate tribasic | polyoxyethylene glycol | (6.4 mM) |
| | L-proline | Concentration: 57 mM | (ALLIGARE | PROXEL |
| | Concentration: 163.88 mM | | SURFACE ™) | BD 20 |
| | | | Concentration: 37.9% | (Preservative) |
| | | | v/v (78.75 mM) | |
| Composition 14 | Betaine hydrochloride | Potassium | Alkyl and alkyl lauryl | 0.5% v/v |
| | Concentration: 83.49 mM | phosphate tribasic | polyoxyethylene glycol | (6.4 mM) |
| | L-proline | Concentration: 57 mM | (ALLIGARE | PROXEL |
| | Concentration: 163.88 mM | | SURFACE ™) | BD 20 |
| | | | Concentration: 37.9% | (Preservative), |
| | | | v/v (78.75 mM) | 10 μM sucrose, |
| | | | | 5 μM EDTA |
| Composition 15 | Betaine hydrochloride | Potassium | Alkyl and alkyl lauryl | 0.5% v/v |
| | Concentration: 83.49 mM | phosphate tribasic | polyoxyethylene glycol | (6.4 mM) |
| | L-proline | Concentration: 57 mM | (ALLIGARE | PROXEL |
| | Concentration: 163.88 mM | | SURFACE ™) | BD 20 |
| | | | Concentration: 37.9% | (Preservative) |
| | | | v/v (78.75 mM) | |
| Composition 16 | Betaine hydrochloride | Potassium | Alkyl and alkyl lauryl | 0.5% v/v |
| | Concentration: 150 mM mM | phosphate tribasic | polyoxyethylene glycol | (6.4 mM) |
| | L-proline | Concentration: 57 mM | (ALLIGARE | PROXEL |
| | Concentration: 163.88 mM | | SURFACE ™) | BD 20 |
| | | | Concentration: 37.9% | (Preservative) |
| | | | v/v (78.75 mM) | |
| Composition 17 | Betaine hydrochloride | Potassium acetate: | Alkyl and alkyl lauryl | 0.5% v/v |
| | Concentration: 83.49 mM | 2.3% w/v | polyoxyethylene glycol | (6.4 mM) |
| | L-proline | (234.3 mM) | (ALLIGARE | PROXEL |
| | Concentration: 163.88 mM | | SURFACE ™) | BD 20 |
| | | | Concentration: 37.9% | (Preservative) |
| | | | v/v (78.75 mM) | |
| Composition 18 | Betaine hydrochloride | Potassium | Alkyl and alkyl lauryl | 0.5% v/v |
| | Concentration: 83.49 mM | phosphate tribasic | polyoxyethylene glycol | (6.4 mM) |
| | L-proline | Concentration: 57 mM | (ALLIGARE | PROXEL |
| | Concentration: 163.88 mM | | SURFACE ™) | BD 20 |
| | | | Concentration: 37.9% | (Preservative) |
| | | | v/v (78.75 mM) | |
| Composition 19 | Betaine hydrochloride | Potassium | Alkyl polyoxyethylene | 0.5% v/v |
| | Concentration: 83.49 mM | phosphate tribasic | (ALLIGARE 90) | (6.4 mM) |
| | | Concentration: 155 mM | Concentration: 37.9% | PROXEL |
| | | | v/v (78.75 mM) | BD 20 |
| | | | | (Preservative) |
| Composition 20 | Betaine hydrochloride | Potassium | Alkyl and alkyl lauryl | 0.5% v/v |
| | Concentration: 83.49 mM | phosphate tribasic | polyoxyethylene glycol | (6.4 mM) |
| | | Concentration: 155 mM | (ALLIGARE | PROXEL |
| | | | SURFACE ™) | BD 20 |
| | | | Concentration: 37.9% | (Preservative) |
| | | | v/v (78.75 mM) | |
| Composition 21 | Betaine hydrochloride | Potassium | Alkyl polyoxyethoxylate | 0.5% v/v |
| | Concentration: 83.49 mM | phosphate tribasic | ether | (6.4 mM) |
| | | Concentration: 155 mM | (AQUA SUPREME) | PROXEL |
| | | | Concentration: 37.9% | BD 20 |
| | | | v/v (78.75 mM) | (Preservative) |
| Composition 22 | L-proline | Potassium | Alkyl polyoxyethylene | 0.5% v/v |
| | Concentration: 491.64 mM | phosphate tribasic | (ALLIGARE 90) | (6.4 mM) |
| | | Concentration: 155 mM | Concentration: 37.9% | PROXEL |
| | | | v/v (78.75 mM) | BD 20 |
| | | | | (Preservative) |
| Stachydrine | L-proline-betaine | — | — | — |
| Control | (stachydrine) | | | |
| | Concentration: 55.59 mM | | | |
| Stachydrine | L-proline-betaine | Potassium | Alkyl and alkyl lauryl | 0.5% v/v |
| Composition | (stachydrine) | phosphate tribasic | polyoxyethylene glycol | (6.4 mM) |
| | Concentration: 55.59 mM | Concentration: 155 mM | (ALLIGARE | PROXEL |
| | | | SURFACE ™) | BD 20 |
| | | | Concentration: 37.9% | (Preservative) |
| | | | v/v (78.75 mM) | |
| Anti-respirant | — | — | Alkyl and alkyl lauryl | — |
| Control A | | | polyoxyethylene glycol | |
| | | | (ALLIGARE | |
| | | | SURFACE ™) | |
| | | | Concentration: 37.9% | |
| | | | v/v (78.75 mM) | |
| Anti-respirant | — | — | Alkyl polyoxyethylene | — |
| Control B | | | (ALLIGARE 90) | |
| | | | Concentration: 37.9 | |
| | | | v/v % (78.75 mM) | |

### Example 2: Application to VT Corn—Increased Yield

Agricultural compositions comprising an agriculturally effective amount of betaine-HCl (composition 1 of Example 1) or L-proline (composition 2 of Example 1) were applied as a foliar spray at a use rate of 3.2 fluid ounce per acre (Fl. oz/Ac) (234 mL per hectare) to two commercially available corn hybrids at the VT stage of development. Large acre trials were conducted at 10 separate locations throughout the Midwest territories in Iowa (IA) and Illinois (IL).

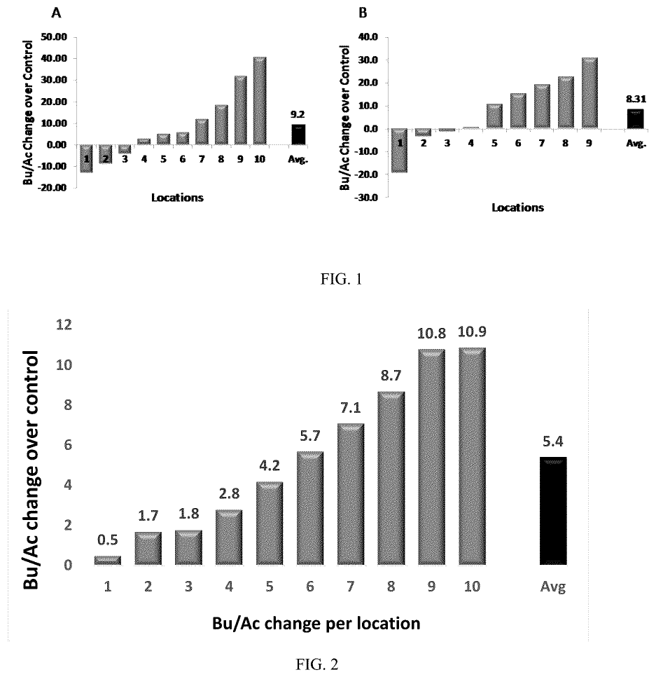

Corn yield in bushels per acre (Bu/Ac and kg/hectare) was collected at 10 locations for plants receiving the betaine foliar treatment (composition 1) as shown in panel A of FIG. 1 and at nine locations for plants receiving the proline foliar treatment (composition 2) as shown in panel B of FIG. 1 and reported as normalized to Bu/Ac to the corn control (water only) plants that did not receive either foliar treatment.

Foliar application of betaine-HCl (composition 1) as shown in panel A of FIG. 1 resulted in an average increase of 9.2 Bu/Ac (577.5 kg/hectare) over the control corn and had a 70% positive win rate over the 10 locations harvested. Foliar application of L-proline (composition 2) as shown in panel B of FIG. 1 resulted in an average increase of 8.31 Bu/Ac (521.6 kg/hectare) over the control corn plants and had a 66.7% positive win rate over the nine locations harvested. The win rate represents the percentage of testing locations at which one treatment has a yield advantage over the other treatments.

### Example 3: Application to VT Corn with Fungicide

An agricultural fertilizer composition comprising an agriculturally effective amount of betaine-HCl (composition 1 of Example 1) was combined with a commercially available fungicide, HEADLINE AMP® (13.64% pyraclostrobin, 5.14% metconazole) suitable for application at pollination and grain fill, and applied as a foliar spray to corn at the VT stage of development. The foliar composition comprising betaine-HCl was applied as a spray at a use rate of 3.2 fluid ounce per acre (Fl. oz/Ac) (234 mL per hectare) to six commercially available corn hybrids (5829A4, 5828MX, 6076SX, 6158AM, 6225HR, 6365AMX). Large scale on-farm strip trials were conducted using 5 locations throughout the Midwest, Indiana (IN), Kentucky (KY), Illinois (Central, C. IL & Southern S.IL) and Iowa (IA) using replicated trials. Two corn hybrids were grown at each location site. Plots were maintained using the individual grower's production practices and each plot was replicated 2-4 times. HEADLINE AMP® fungicide was applied using the recommended label rates at each location. Corn yield in bushels per acre (Bu/Ac) was reported at all locations as an average yield for the replicated trials at each location. The change in yield in Bu/Ac for corn plants receiving foliarly the betaine plus HEADLINE AMP® fungicide treatments were normalized to the control corn plants receiving the fungicide treatment alone.

Corn yield in bushels per acre (Bu/Ac) was collected at ten locations for plants receiving the betaine foliar treatment (composition 1) with HEADLINE AMP® as normalized to Bu/Ac for the corn control (fungicide treatment alone) plants (FIG. 2). Yield (Bu/Ac) was normalized to each control using the same corn hybrid grown at the same location.

Foliar application of betaine-HCl (composition 1) plus the fungicide (HEADLINE AMP®) as shown in FIG. 2 resulted in an average increase of 5.4 Bu/Ac (338.9 kg/hectare) over the control corn plants and had a 100% positive win rate across all locations and all treatments harvested. Corn plants that received the betaine foliar application (composition 1) with fungicide had on average a 5.4 Bu/Ac (338.9 kg/hectare) yield advantage over the control treated corn plants that received only the fungicide treatment.

### Example 4: Application to V5-V8 Corn—Increased Yield

Agricultural fertilizer compositions comprising an agriculturally effective amount of betaine-HCl (composition 1 of Example 1) or L-proline (composition 2 of Example 2) were applied as a foliar spray at a use rate of 3.2 fluid ounce per acre (Fl. oz/Ac) (234 mL per hectare) to commercially available corn hybrids at the V5-V8 stage of development. Large acre trials were conducted at separate locations throughout the Midwest territories in Iowa (IA) and Illinois (IL). Corn yield in bushels per acre (Bu/Ac) was collected at the three locations for plants receiving the betaine foliar treatment (composition 1) and for plants receiving the proline foliar treatment (composition 2) and reported as normalized to Bu/Ac for the corn control plants.

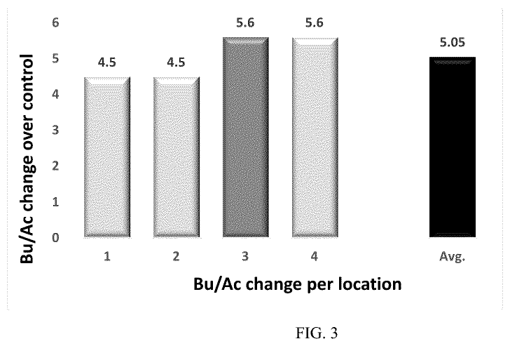

Corn yield (Bu/Ac) normalized in Bu/Ac to the yield of the control corn plants is reported for the foliar treatments that received compositions containing betaine-HCl (composition 1) and L-proline (composition 2), with each composition containing an osmoprotectant, an anti-desiccant and an anti-respirant (anti-transpirant) to increase yield (FIG. 3). The fertilizer composition comprising an agriculturally effective amount of betaine-HCl (composition 1) is shown by lighter bars (labeled 1, 2 and 4) and of the L-proline treatment (composition 2) is shown by the darker bar (labeled 3). The average of the combined foliar treatments for compositions 1 and 2 is shown as the bar labeled “Avg.” The yield for corn plants that received the betaine-HCl foliar treatment resulted in an average increase of 4.9 Bu/Ac (305.1 kg/hectare) while plants that received the L-proline foliar treatment resulted in an average increase of 5.6 Bu/Ac (351.5 kg/hectare) as compared to the control plants that did not receive either the betaine or proline foliar applications. The average Bu/Ac yield increase for the combined foliar treatments of betaine-HCl and L-proline resulted in an average increase of over 5 Bu/Ac as compared to the control corn plants. The win rate was 100% positive for corn plants that received the proline and betaine or foliar applications.

### Example 5: Two Applications to V5-VT Corn

Large acre yield trials were conducted using agricultural compositions comprising an agriculturally effective amount of betaine-HCl (composition 1 of Example 1) and L-proline (composition 2 of Example 1). The foliar treatments were applied as a foliar spray at a use rate of 3.2 fluid ounce per acre (fl. oz/Ac) (234 mL per hectare). The corn plants received the foliar betaine-HCl (composition 1) or L-proline (composition 2) containing an osmoprotectant, an anti-desiccant and an anti-respirant (anti-transpirant). The compositions were applied twice, at the V5 and VT stages of development. Corn yield (Bu/Ac) was collected at three locations for plants receiving betaine foliar treatment (composition 1) or the proline foliar treatment (composition 2). Both foliar treatments are reported as normalized to the non-foliar treated control plants.

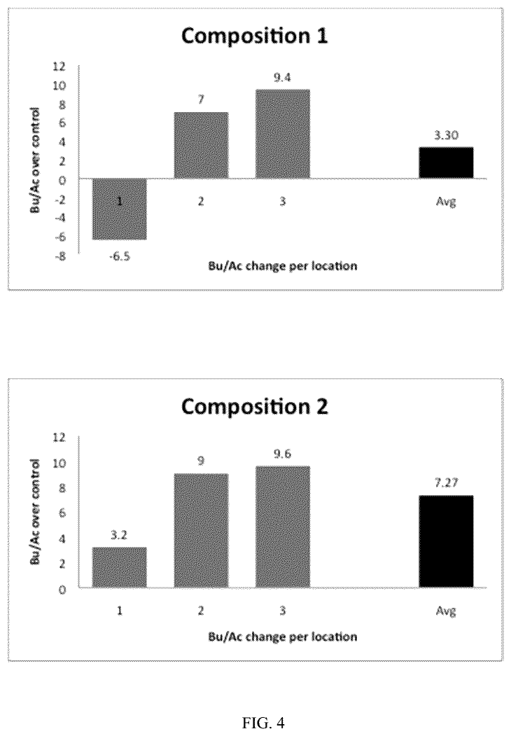

Corn yield is reported as the change in yield (Bu/Ac) for plants receiving the betaine and proline foliar treatments with Bu/Ac normalized to the control or non-foliar treated plants (FIG. 4).

Foliar treatments delivering agriculturally effective amounts of the betaine-HCl resulted in an average increase of 3.3 Bu/Ac (207.14 kg/hectare) over the control plants that did not receive the foliar applications. Foliar treatments delivering agriculturally effective amounts of the L-proline resulted in an average increase of 7.27 Bu/Ac (456.34 kg/hectare) over the control plants that did not receive the foliar applications. The win rate was 83.3% positive for corn plants that received two applications of betaine or proline foliar applications. Foliar compositions of betaine-HCl (composition 1) and L-proline (composition 2) applied twice during the growing season (V5 and VT) resulted in more than a 5 Bu/Ac (331 kg/hectare) yield advantage over the control plants (water only) that did not receive either foliar application.

### Example 6: Application to V5 Corn—Large Scale Strip Trials

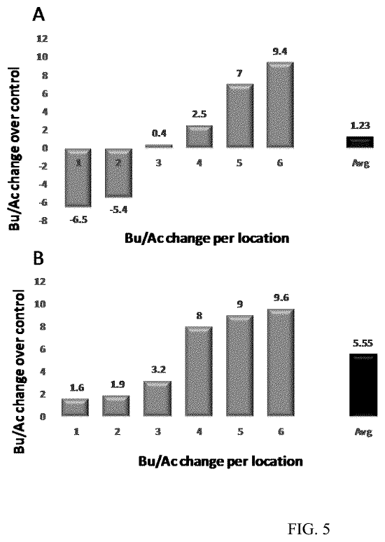

Large scale on-farm strip trials were conducted using foliar treatments comprising agriculturally effective amounts of betaine-HCl (composition 1 of Example 1) and L-proline (composition 2 of Example 1) containing an osmoprotectant, an anti-desiccant and an anti-respirant (anti-transpirant) were applied in combination with STRATEGO®YLD (10.8% prothioconazole and 32.3% trifloxystrobin) fungicide to corn plants. Large scale on-farm strip trials were conducted using three locations with two hybrids each throughout the Midwest in Iowa (IA), Illinois (IL) and Ohio (OH) using replicated fungicide strip trials. Plots were maintained using the individual grower's production practices and each plot was replicated two to four times. STRATEGO®YLD fungicide was applied using labeled rates at each location and the foliar treatments of betaine and proline were applied at a use rate of 3.2 fluid ounce per acre (Fl. oz/Ac) (234 mL per hectare) at the V5 stage of corn development. Corn yield (Bu/Ac) was reported for plants that received the betaine foliar treatment (composition 1) and the proline foliar treatment (composition 2) as normalized to the corn plants receiving the fungicide treatment alone (FIG. 5).

Corn yield (Bu/Ac) is reported for plants receiving foliar treatments the betaine and proline (compositions 1 and 2) combined with an application with a commercially available fungicide, STRATEGO®YLD (FIG. 5). Yield was normalized to the yield of control corn plants that received only the fungicide treatment. Yield from corn plants that received the foliar application comprising betaine-HCl and the STRATEGO®YLD fungicide (panel A of FIG. 5) were compared to yield from plants that received the L-proline and STRATEGO®YLD fungicide (panel B of FIG. 5). Both foliar treatments with betaine-HCl (composition 1) and L-proline (composition 2) combined with the fungicide treatment were normalized to the yield of corn plants that received the STRATEGO®YLD fungicide treatment alone. Normalized yield was reported for each location (FIG. 5). Both foliar treatments combined with the STRATEGO®YLD fungicide showed a yield advantage over the control plants. The foliar treatment with betaine-HCl and the STRATEGO®YLD fungicide, as shown in panel A of FIG. 5, resulted in an average 1.23 Bu/Ac (77.2 kg/hectare) increase over the control plants while the foliar treatment with L-proline and STRATEGO®YLD fungicide shown in panel B of FIG. 5 resulted in an average 5.55 Bu/Ac (348.4 kg/hectare) increase over the control plants.

### Example 7: Application to V5-V8 Corn—Ear Weight, Total Kernels, Kernel Weight, Ear Diameter

Large acre yield trials were conducted using agricultural fertilizer compositions comprising an agriculturally effective amount of betaine-HCl (composition 1 of Example 1) and L-proline (composition 2 to Example 1) to field corn (DEKALB coated with ACCELERON Seed Treatment with PONCHO 600) at V5-V8 stage of development. The ACCELERON Seed Treatment contains difenoconazole (1.25%) and PONCHO 600 contains clothianidin (48.0%). The corn was planted at a density of 25,000 to 27,000 seeds/acre and foliar applications were applied. Corn yield (Bu/Ac) was collected at two Midwest (KS) locations. Corn yield was collected for two replicated plots within each location with six representative plants sampled per plot. Corn yield parameters were collected for average: ear weight, total kernels, kernel weight, ear diameter for both the plants that received the betaine-HCl and L-proline foliar treatments and compared to the control (untreated) plants.

TABLE 2
Foliar treatment with betaine increases ear and
kernel weight, ear diameter, and yield in corn

| Foliar | Avg. Ear | | | Ear | Avg. Yield | Avg. Yield |
|---|---|---|---|---|---|---|
| Treatment | Weight | Avg. Total | Avg. Weight | Diameter | Location 1 | Location 2 |
| (3.2 fl. oz/ac) | Total (g) | Kernels | 50 Kernels (g) | (mm) | (Bu/Ac) | (Bu/Ac) |
| Control | 257.8 | 557.3 | 18.3 | 50.9 | 188.1 | 167.2 |
| Composition 1 | 317.5 | 647.9 | 19.0 | 53.7 | 218.7 | 194.4 |
| Percent of | +123.2% | +116.3% | +103.8% | +105.6% | +116.3% | +116.3% |
| Control | | | | | | |

Foliar treatment with betaine-HCl (composition 1) applied to corn plants at the V5-V8 stage of development was reported in total ear weight, kernel weight, ear diameter and average yield (Bu/Ac) at 2 locations. The foliar treatment with betaine-HCl (composition 1) (Table 2) or L-proline (composition 2) (Table 3) applied to corn plants resulted in an increase in ear weight (grams), total kernels, kernel weight, and ear diameter (mm) compared to control plants. Corn yield (Bu/Ac) was also improved and resulted in an average increase of 116% for the corn plants treated with the foliar treatment comprising betaine-HCl (composition 1) over the control (water only treatment) plants.

Foliar treatment with L-proline (composition 2) applied to corn plants at V5-V8 stage of development was reported in total ear weight, kernel weight, ear diameter and average yield (Bu/Ac) at two locations. The foliar treatment with L-proline (composition 2) applied to corn plants resulted in an increase in ear weight (grams), total kernels, kernel weight, and ear diameter (mm) compared to control plants (Table 3). Increases in ear weight, kernel number, kernel weight and ear diameter all contributed to increased corn yield (Bu/Ac) with an average increase of 106% for the corn plants treated with the foliar treatment comprising L-proline (composition 2) over the control (untreated) plants.

TABLE 3
Foliar treatment with proline increases ear and
kernel weight, ear diameter, and yield in corn

| Foliar | Avg. Ear | | | Ear | Avg. Yield | Avg. Yield |
|---|---|---|---|---|---|---|
| Treatment | Weight | Avg. Total | Avg. Weight | Diameter | Location 1 | Location 2 |
| (3.2 fl. oz/ac) | Total (g) | Kernels | 50 Kernels (g) | (mm) | (Bu/Ac) | (Bu/Ac) |
| Control | 221.9 | 499.6 | 17.4 | 49.4 | 168.6 | 149.9 |
| Composition 2 | 242.3 | 529.8 | 17.7 | 50.2 | 178.8 | 158.9 |
| Percent of | +109.2% | +106.0% | +101.7% | +101.6% | +106.0% | +106.0% |
| Control | | | | | | |

### Example 8: Application of Osmoprotectant and Anti-Respirant

Foliar application proceeded using the osmoprotectant L-proline with the anti-respirant alkyl and alkyl lauryl polyoxyethylene glycol (composition 5 of Example 1). The composition comprising the osmoprotectant and anti-respirant was then diluted and applied at a used rate of 3.2 Fl. oz/Ac (234 mL per hectare) to corn (Beck's hybrid 5140RR). Yield (Bu/Ac) and average change in yield (Bu/Ac) were collected for four locations across the Midwest using multiple location randomized trials. The osmoprotectant and anti-respirant foliar treatment application was compared to the control treatment (water+anti-respirant) and resulted in greater total yield per location (145.5 Bu/Ac or 9101.1 kg/hectare) as compared to the control plants (118 Bu/Ac or 7406.4 kg/hectare), as reported in Table 4. This resulted in an almost 28 Bu/Ac increase per location for the corn plants receiving the composition comprising an osmoprotectant and anti-respirant.

TABLE 4
Foliar treatment with composition comprising an
osmoprotectant and anti-respirant

| | Yield | Δ in Yield | Avg. Δ in Yield |
|---|---|---|---|
| | (Bu/Ac) | (Bu/Ac) | (Bu/Ac) |
| Treatment | per Location | per Location | per Location |
| Control (water + anti- | 117.65 | — | — |
| respirant) | | | |
| Control (L-proline + anti- | 145.45 | +27.80 | +8.64 |
| respirant; 3.2 fl. oz/ac) | | | |

Soybean yield trials were conducted to determine the effect on yield of using a combination of an osmoprotectant and an anti-respirant, applied as a foliar treatment at two stages in soybean development. Compositions were prepared as described in Table 5.

TABLE 5
Osmoprotectant and anti-respirant compositions

| | | | Ratio |
|---|---|---|---|
| | | | Osmo- |
| | Osmo- | | protectant: |
| | protectant % | Anti-Respirant % | Anti-Respirant |
| Composition | (w/v) | (w/v) (mM) | (w/v) |
| 4 | Betaine-HCl | Alkyl and alkyl lauryl | 1:45 |
| | (0.85%) | polyoxyethylene glycol | |
| | | (37.9%, 78.75 mM) | |
| 5 | L-proline | Alkyl and alkyl lauryl | 1:20 |
| | (1.88%) | polyoxyethylene glycol | |
| | | (37.9%, 78.75 mM) | |
| 3 | Betaine-HCl + | Alkyl and alkyl lauryl | 1:45 (for 3) |
| | L-proline | polyoxyethylene glycol | 1:20 (for 4) |
| | | (37.9%, 78.75 mM) | |
| Control | — | Alkyl and alkyl lauryl | — |
| | | polyoxyethylene glycol | |
| | | (37.9%, 78.75 mM) | |

The compositions were diluted and applied at a use rate of 3.2 fl. oz/Ac (234 mL per hectare) to soybean (Variety 375 NR). Yield (Bu/Ac) and absolute changes in yield (Bu/Ac) were collected at four locations across the Midwest using multiple location randomized trials.

Compositions 4, 5, and 3 were compared to the control treatment (water+lauryl polyoxyethylene glycol). The foliar application treatments were compared to the control treatments applied to the same growth stages, at either V4-V5 or R2-R3 per location. Yield (Bu/Ac) is reported (per location) for soybean plants that received compositions 4, 5, and 3 as a foliar treatment. Absolute soybean yield (Bu/Ac) averaged per location and the percent change in yield (Bu/Ac) normalized to the control are reported for each of the treatment and treatment combinations in Table 6.

TABLE 6
Foliar treatment with osmoprotectant and anti-respirant
applied at two stages of growth in soybean

| | | Percent Change in |
|---|---|---|
| Treatment | Yield (Bu/Ac) | Yield (Bu/Ac) |
| (Stage of Growth) | per Location | over Control |
| Composition 4 (V4-V5) | 63.1 | +15.9% |
| Composition 4 (R2-R3) | 26.8 | −3.8% |
| Composition 5 (V4-V5) | 48.9 | +1.7% |
| Composition 5 (R2-R3) | 30.7 | +0.1% |
| Composition 3 (V4-V5) | 48.2 | +1.0% |
| Composition 3 (R2-R3) | 33.7 | +3.2% |

Foliar application using composition 4 resulted in the greatest percent yield advantage, an average of a 16% increase over the control plants when applied to soybean at the V4-V5 stage of development. The timing of the foliar treatment composition comprising an osmoprotectant and an anti-respirant differed depending on what osmoprotectant was combined with the anti-respirant as well as the stage of soybean development at which the foliar treatment was applied. The composition 3 foliar treatment composition applied at the R2 to R3 growth stage resulted in a noticeable yield advantage when compared to the same treatment applied at the V4-V5 growth stage in soybean and the control.

### Example 9: In-Furrow Application to Corn

Soil treatment using betaine-HCl (composition 1 of Example 1) was used to increase yield in corn (commercial variety). The betaine composition was applied to the soil or the area surrounding a seed (in-furrow) at an application use rate of 24.0 fl. oz/Ac (1754 mL/hectare). In-furrow or soil treatment trials were conducted using four replicated plots that were randomized. Average plot weight (kg/hectare), seed moisture (%) and grain yield (kilograms/Plot) were collected and reported as the average of the four replicate plots per trial. The increases in average plot weight (kg/hectare), seed moisture (%) and grain yield (kilograms/Plot) using the betaine-HCl (composition 1) as an in-furrow soil treatment applied to the area surrounding a seed during planting and prior to covering the seed all differed significantly from the corn plants that received the water control (Table 7).

TABLE 7
In-furrow soil treatment with betaine increases corn yield

| | Avg. Plot | Avg. Moisture | Avg. Grain |
|---|---|---|---|
| Seed | Weight | (%) | Yield |
| Treatment | (kg/hectare) | Harvested Seed | (kg/Plot) |
| Control | 50.5 | 13.80 | 445.3 |
| Composition 1 | 53.6* | 14.13* | 464.3* |

*LSD p = 0.5 significant

### Example 10: Application to Corn and Soybean—Increased Plant Height

An L-proline composition (composition 2 of Example 1) was applied foliarly to corn (Beck's corn hybrids 5828 YH) grown in an environmentally controlled growth room. Changes in plant height (cm)—a measure of growth rate—were measured under non-stress and stress conditions. Foliar treatments were applied to two-week-old corn at the V2 to V3 stage of development. Plant height (cm) was measured just prior to the foliar application delivered at two weeks and then again ten days later for four-week-old corn. Two replicate trials were conducted using ten plants per trial. Corn plants were grown under non-stress and stress-simulated environmental conditions. Corn plants grown under a non-stress environment were grown under optimized growth room conditions for a duration of four weeks. After two weeks of growth, the corn plants were treated with a foliar application of the L-proline composition (composition 2 of Example 1) containing an osmoprotectant and an anti-desiccant or an osmoprotectant and an anti-respirant. A subset of the corn plants was not treated with the foliar proline composition applications (control).

After foliar application, the plants in the stress treatment were placed into an environment to simulate heat and drought stress. Heat stress was applied using heat mats to raise the temperature in the environment approximately from 21° C. to 30° C. During this period of heat stress, the plants were left un-watered. Plant height was measured for corn plants grown under the non-stress and stress simulated environments. Changes in plant height were determined for plants that received the L-proline foliar treatment and normalized to the water-treated control plants in each environment. The combined average of two trials with nine replicate plants per trial is reported in Table 8.

TABLE 8
Foliar application of L-proline increases height in corn

| Treatment: Composition 2 | | |
|---|---|---|
| (3.2 fl. oz/Ac or 234 mL/hectare) | Non-stressed | Heat stress |
| % Change in Corn Height over Control | +4.8% | +7.96% |
| SEM Average | 2.24% | 2.26% |
| p-value | 0.085 | 0.007 |

Foliar treatment of corn plants with L-proline (composition 2) promoted growth. Plant height was increased by approximately 5% in plants grown in the non-stress and 8% in plants grown in the stress (heat and drought) environments. The percent standard error mean (SEM) is also reported due to the normal distribution of data points in the curve. Plant height (cm) was found to be normally distributed in that approximately 95% of the population fell within +/−1.96 SE of the mean. Increases in plant height for corn plants that received the L-proline foliar treatments over the water-treated control plants were found to be significant (p≤1.00) in both the non-stress (p=0.085) and stress (p=0.007) environments (Table 8).

Foliar treatment of soybean plants with L-proline (composition 2) also resulted in increased growth under both stressed and non-stressed environments. The soybean plants were grown and treated with composition 2 in an identical manner to that described above for corn, and were also subjected to heat stress and assessed for growth in the same manner as described above for corn. Plant height was increased by approximately 3% in plants grown in the non-stress and 8.7% in plants grown in the stress (heat and drought) environments (Table 9).

TABLE 9
Foliar application of L-proline increases height in soybean

| Treatment: Composition 2 | Non- | Heat |
|---|---|---|
| (3.2 fl. oz/Ac or 234 mL/hectare) | stressed | stress |
| % Change in Soybean Height over Control | +2.5% | +8.7% |

### Example 11: Application to Soybean—Increased Yield

Large acre yield trials were conducted using agricultural compositions comprising an agriculturally effective amount of betaine-HCl (composition 1 of Example 1) or L-proline (composition 2 of Example 1). The betaine-HCl and L-proline treatments were applied as foliar sprays at a use rate of 3.2 fluid ounce per acre (Fl. oz/Ac) (234 mL/hectare) to soybean grown at five locations (participating sites: IA, IL, IN, KS and SD). The soybean plants received the foliar betaine-HCl and L-proline treatments at the R2 stage of development. Soybean yields (Bu/Ac) for plants receiving the betaine foliar treatment (composition 1) or the proline foliar treatment (composition 2) were normalized to the non-foliar treated control (water only) plants.

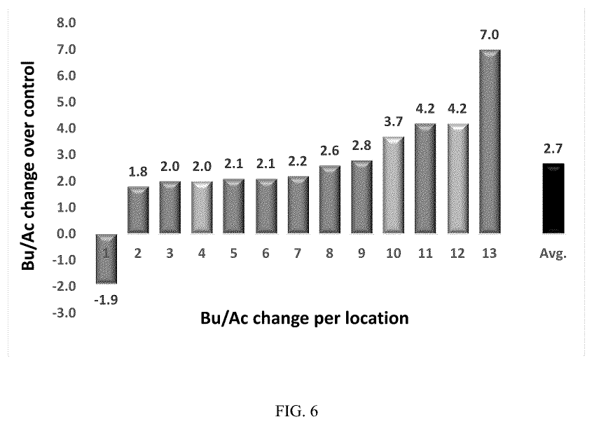

Soybean yield (Bu/Ac) is reported in FIG. 6 for the plants that received the foliar treatments containing agriculturally effective amounts of betaine-HCl (lighter bars in FIG. 6; locations 4, 10, and 12) and L-proline (darker bars in FIG. 6; locations 1-3, 5-9, 11, and 13). As shown in FIG. 6, the yield for the plants that received the betaine-HCl treatment had an average increase of 3.3 Bu/Ac (221.9 kg/hectare) in harvestable yield over the control plants. Soybean plants that received the L-proline treatment had an average increase in harvestable yield of 2.5 Bu/Ac (168.1 kg/hectare) over the control plants. The win rate was 92.3% positive for soybean plants that received the betaine or proline foliar applications with a 2.7 Bu/Ac (181.6 kg/hectare) yield advantage over the control plants that did not receive either foliar application.

### Example 12: Application to Winter Wheat—Increased Yield

Large acre yield trials were conducted using agricultural compositions comprising an agriculturally effective amount of betaine-HCl (composition 1 of Example 1) or L-proline (composition 2 of Example 1) applied to wheat (Wheat Variety Beck's 88) (Table 10). The betaine-HCl and L-proline treatments were applied as a foliar spray at a use rate of 3.2 fluid ounce per acre (Fl. oz/Ac) (234 mL per hectare) to wheat at the time of flag leaf emergence (Feekes growth stage 8). Yield was collected from wheat plants grown at five locations throughout the Midwest (IL, MO, and KS). Wheat yield (Bu/Ac) for plants receiving the betaine foliar treatment (composition 1) or the proline foliar treatment (composition 2) are reported below in Table 10 in average Bu/Ac per location and the change in the average Bu/Ac over the control.

TABLE 10
Foliar treatment with a composition of betaine and proline
increases yield in winter wheat

| | Avg. | Avg. | Avg. | Avg. | Avg. |
|---|---|---|---|---|---|
| | Bu/Ac | Bu/Ac | Bu/Ac | Bu/Ac | Bu/Ac |
| | Location | Location | Location | Location | Location |
| | 1—IL | 2—MO | 3—IL | 4—MO | 5—KS |
| | (Δ Bu/Ac | (Δ Bu/Ac | (Δ Bu/Ac | (Δ Bu/Ac | (Δ Bu/Ac |
| | over | over | over | over | over |
| Treatment | control) | control) | control) | control) | control) |
| Control | 82.75 | 91.10 | 62.73 | 60.04 | 82.94 |
| | (—) | (—) | (—) | (—) | (—) |
| Composition 1 | 85.37 | 90.30 | 63.69 | 60.94 | 83.29 |
| | (2.62) | (−0.80) | (0.96) | (0.90) | (0.35) |
| Composition 2 | 83.08 | 87.70 | 71.08 | 62.37 | — |
| | (0.33) | (−3.40) | (8.34) | (2.33) | |

The foliar applied betaine-HCl treatment averaged an approximate 1 Bu/Ac (67.3 kg/hectare) increase in winter wheat yield, whereas the foliar applied L-proline treatment averaged a 1.9 Bu/Ac (127.8 kg/hectare) increase in wheat yield across the locations harvested.

Large acre yield trials were conducted using agricultural compositions comprising an agriculturally effective amount of L-proline (composition 2) applied to wheat (Wheat Variety Beck's 88) in 2015 and 2016 (Wheat Variety Everest) (Table 11). The L-proline composition was applied as a foliar spray at a use rate of 3.2 fluid ounce per acre (Fl. oz/Ac) (234 mL per hectare) to wheat at the time of flag leaf emergence (Feekes growth stage 8). This stage of wheat development was specifically selected to apply the foliar treatment because the emergence and the development of the flag leaf is important for attaining high yields and thus the additional protection provided by the proline foliar treatment was used to provide a yield advantage in the field. Yield was collected from wheat plants grown at seven locations (IL, MO, and KY). Wheat yield in Bu/Ac and kg/hectare is reported in Table 11 for plants that received the proline foliar treatment as an average change in Bu/Ac and kg/hectare as compared to the control and the percent (%) win rate across the seven locations.

TABLE 11
Foliar treatment with a composition of L-proline increases yield

| | 2015 Average | | 2015 Percent | 2016 Average | | 2016 Percent |
|---|---|---|---|---|---|---|
| | Bu/Ac (kg/hectare) | 2015 Average | (%) Win | Bu/Ac (kg/hectare) | 2016 Average | (%) Win |
| | across | Bu/Ac (kg/hectare) | Rate across | across | Bu/Ac (kg/hectare) | Rate across |
| Treatment | 7 locations | over control | 7 locations | 7 locations | over control | 7 locations |
| Control | 67.07 | — | — | 78.79 | — | — |
| | (4510.43) | | | (5298.59) | | |
| Composition 2 | 76.06 | 1.90 | 75% | 80.76 | 2.23 | 50% |
| | (5115) | (127.77) | | (5431.10) | (149.97) | |

Wheat yield (Bu/Ac) was increased for plants receiving the foliar treatment containing L-proline (composition 2). For the plants treated in 2015, the treatment resulted in a combined average of 76 Bu/Ac (5111 kg/Ac) for the seven locations, providing an increase of 1.9 Bu/Ac (127.8 kg/hectare) over the control with a 75% win rate. For the plants treated in 2016, the treatment with the L-proline composition resulted in a combined average increase of about 81 Bu/Ac,(approximately 5447.2 kg/hectare), for the seven locations combined, providing an increase of 2.2 Bu/Ac (approximately 148 kg/hectare), over the control with a 50% win rate.

### Example 13: Application to Winter Wheat—Increased Yield

Large acre yield trials were conducted using agricultural compositions comprising an agriculturally effective amount of betaine-HCl (composition 6 of Example 1) or L-proline (composition 5 of Example 1) applied to two wheat hybrids (Beck's 120 and Everest). Wheat seed from both hybrids received a seed treatment with SATIVA® IMF MAX (available from NuFarm Americas Inc. and containing 11.16% imidacloprid (a systemic insecticide), 0.60% metalaxyl (a acylalanine fungicide), 0.45% tebuconazole (a triazole fungicide), and 0.36% fludioxonil (a non-systemic fungicide)) applied using the recommended label instructions in a slurry to seed prior to planting (3.5 fluid ounces per 100 pounds of seed (234 mL per approximately 45 kg). Wheat was planted in 1.5 meters×3.0 meters×3.8 meters replicate plots planted using 1.8 meters row spacing at five locations. Each plot had three replicates per foliar treatment per hybrid and each foliar treatment was randomized using a randomized plot design. The betaine-HCl and L-proline treatments were applied as foliar sprays at a rate of 3.2 fluid ounces per acre (Fl. oz/Ac) (234 mL per hectare) at the time of flag leaf emergence (Feekes growth stage 8). Yield was collected from wheat plants grown at five locations throughout the US Midwest (IL, KY, and MO). Wheat yield Bu/Ac or kg/hectare is reported in Table 12 for the betaine and L-proline foliar-applied treatments and the base seed treatment control as the average combined yield across all five locations. The average change in yield (Bu/Ac) compared to anti-respirant control A for the two hybrids is also reported across the five locations (Table 12). Both controls received the base seed treatment SATIVA® IMF MAX applied at 3.5 fluid ounces per 100 pounds of seed (234 mL per approximately 45 kg).

TABLE 12
Winter wheat yield with foliar applications of
osmoprotectants on seed treated wheat

| | Avg. Yield Bu/Ac | Avg. Δ in |
|---|---|---|
| Composition | (kg/hectare) | Yield (Bu/Ac)* |
| Base Seed | 78.94 | +1.05 |
| Treatment (Control) | (5308.68) | |
| Anti-respirant | 77.89 | — |
| Control A | (5238.07) | |
| Composition 6 | 80.03 | +2.14 |
| | (5381.98) | |
| Composition 5 | 81.35 | +3.46 |
| | (5470.75) | |

*Compared to Anti-respirant Control A

Foliar application of compositions 5 and 6 on wheat at the time of flag leaf emergence resulted in a yield advantage for the two wheat hybrids. Overall yield for wheat treated with composition 6 (80 Bu/Ac or 5380 kg/hectare) was increased by 2.14 Bu/Ac (143.9 kg/hectare) compared to the yield of wheat plants treated with the anti-respirant control, resulting in a 63% win rate. Additionally, yield for wheat treated with composition 5 (81 Bu/Ac or 5447 kg/hectare) was increased by 3.46 Bu/Ac (232.7 kg/hectare) compared to the yield of wheat plants treated with the anti-respirant control, resulting in a 71% win rate. The composition 5 and 6 foliar treatments showed compatibility with the SATIVA® IMF MAX seed treatment and resulted in a yield increase in of 1.05 Bu/Ac (70.6 kg/hectare) over the anti-respirant control.

### Example 14: Application to Tomatoes—Increased Yield

Foliar application treatments of betaine-HCl (composition 1 of Example 1) and L-proline (composition 2 of Example 1) were applied as an exogenous spray at the pre-bloom stage and used to increase yield in tomatoes.

Small scale plots were designed to simulate commercial growing conditions for tomatoes. Tomatoes were started as transplants in the greenhouse 42 to 56 days prior to planting into raised field beds. Tomatoes were transplanted once soil temperatures three inches beneath the soil surface reached 15.6° C. Tomatoes were grown on raised beds covered with black plastic mulch. Plants were grown using drip irrigation and fertilizer (80 lbs. (36.3 kg) nitrogen; 100 lbs. (45.4 kg) phosphate, and 100 lbs. (45.4 kg) potash or potassium) applied following grower guidelines throughout the growing season to ensure optimum plant growth and yields. Small raised bed plots were designed to simulate the planting densities used by commercial growers that generally plant 2,600 to 5,800 plants per acre in single rows with 45.7 to 76.2 cm between plants in the row on 1.5- to 2-meter centers. [Orzolek et al., “Agricultural Alternatives: Tomato Production.” University Park: Penn State Extension, 2016].

Foliar treatments using betaine-HCl (composition 1) or L-proline (composition 2) were applied on two hybrids of tomato, JetSetter (Trial 1) and Better Big Boy (Trial 2) at early bloom (first flower) stage. The betaine and proline foliar compositions tested were applied at an application use rate of 3.2 Fl. oz/Ac and 32 Fl. oz/Ac (or 234 mL/hectare and 946 mL/hectare), on tomato plants and compared to the control (water applied at same use rate). Effects of the foliar treatments on increasing yield in tomatoes were determined and reported as normalized to the water control treatment. The average percentage change in yield over the average control yield is reported in Table 13.

TABLE 13
Foliar treatment of betaine-HCl or L-proline increases yield
in different hybrids of tomato

| | Trial 1: | Trial 2: % Δ | Avg. Trials |
|---|---|---|---|
| Foliar | % Δ in Yield | in Yield over | 1 & 2, % Δ |
| Treatment | over Avg. | Avg. Control; | in Yield over |
| (Application | Control; | Hybrid: Better | Avg. |
| Rate) | Hybrid: Jetsetter | Big Boy | Control |
| Composition 1 | +18.47% | +18.34% | +18.41% |
| (3.2 Fl. oz/Ac) | | | |
| Composition 1 | +37.76% | +41.68% | +39.72% |
| (32 Fl. oz/Ac) | | | |
| Composition 2 | +9.69% | +8.83% | +9.26% |
| (3.2 Fl. oz/Ac) | | | |
| Composition 2 | +48.42% | +10.1% | +29.26% |
| (32 Fl. oz/Ac) | | | |

As shown in Table 13, the average yield represented as a percent change over the control plants is reported separately for the two trials as the average for the two tomato hybrids. Foliar application using betaine-HCl (composition 1) resulted in an average increase of 28% in tomato fruits over the control plants for both trials and hyrbids. The foliar application using L-proline (composition 2) resulted in an average increase of 19% in tomato fruits over the control plants for both trials and hyrbids.

Foliar treatments of betaine-HCl (composition 1) or L-proline (composition 2) were also applied to tomatoes (hybrid: Roma) at the first bloom stage using two application use rates (1.0 Fl. oz/Ac or 29.6 mL/hectare, and 3.2 Fl. oz/Ac or 234/per hectare) and changes in yield are reported for two replicate trials in Table 14.

Both replicate trials were conducted at the same Midwest location (MO). Yield was collected and reported for number of fruits per plant, the weight (grams) per fruit and the yield (lbs/Ac) for the Roma tomato plants receiving the betaine and proline foliar treatments and the non-treated control (water only) plants (Table 14).

TABLE 14
Foliar treatment with compositions containing betaine
or proline increases yield in tomato

| | % Δ in Number of | % Δ in | % Δ in Yield |
|---|---|---|---|
| Treatment | Fruits per Plant* | Weight/Fruit* | (lbs/Ac)* |
| Composition 1 | +17% | +11% | +32% |
| 1.0 Fl. oz/Ac | | | |
| Composition 1 | −9% | +13% | +4% |
| 3.2 Fl. oz/Ac | | | |
| Composition 2 | +15% | +20% | +41% |
| 1.0 Fl. oz/Ac | | | |
| Composition 2 | +53% | +24% | +93% |
| 3.2 Fl. oz/Ac | | | |

*Compared to water-only control

Foliar treatments of betaine-HCl (composition 1) or L-proline (composition 2) resulted in increased yield in Roma tomatoes when applied using two application use rates of 1.0 Fl. oz/Ac and 32 Fl. oz/Ac (29.6 mL/hectare and 234 mL/hectare (Table 14). Foliar applications of both the betaine-HCl (composition 1) and L-proline (composition 2) resulted in increases in the number of tomato fruits, fruit weight and overall total yield (lbs/Ac) compared to the non-treated control plants (water only treatment).

### Example 15: Application to Peppers—Increased Yield

Foliar treatments with betaine-HCl (composition 1 of Example 1) or L-proline (composition 2 of Example 1) were applied using small-scale plots designed to simulate commercial growing conditions for peppers (Capsicum). Peppers were grown from 6-week old transplants in raised beds covered with black plastic mulch that had good water-holding characteristics and in soil having a pH of 5.8-6.6. Plants were grown using drip irrigation and fertilizer applied following grower guidelines throughout the growing season to ensure optimum plant growth and yields. Small raised bed plots were designed to simulate the planting densities used by commercial growers that generally plant approximately 10,000-14,000 plants per acre in double rows 35.6-45.7 cm apart on plastic mulched beds with 40.6-61 cm between plants in the row and with the beds spaced 5.0-6.5 feet apart from their centers. A single row of peppers also can be planted on each bed (5,000-6,500 plants per acre) [Orzolek et al., “Agricultural Alternatives: Pepper Production.” University Park: Penn State Extension, 2010].

Foliar applications with compositions containing betaine-HCl (composition 1) or L-proline (composition 2) were applied at the pre-flower to early flower stage on two varieties of pepper: Red Knight (RK) and Hungarian Hot Wax (HHW). The betaine and proline foliar compositions were applied at an application use rate of 3.2 Fl. oz/Ac and 32 Fl. oz/Ac (234 mL and 946 mL/hectare, respectively), on pepper plants and compared to the control (water applied at same use rate). Effects of the foliar applications on pepper yield were determined for two separate harvests using a once-over harvest approach and normalized to the yield of the control plants. The average percentage change in yield over the yield for the control plants is reported in Table 15 as the change per total weight (lbs) of peppers harvested and per total number of peppers harvested for both the betaine and proline treatments provided at use rates of 3.2 and 32 Fl. oz/Ac (234 mL and 946 mL/hectare, respectively).

TABLE 15
Foliar treatment increases yield in different varieties of pepper

| | Avg. % Δ in | Avg. % Δ in | Avg. % Δ | Avg. % Δ |
|---|---|---|---|---|
| | Yield Total | Yield Total | in Yield | in Yield |
| | Weight | Weight | Total | Total |
| | (lbs) | (lbs) | Number | Number |
| Foliar Treatment: | (3.2 Fl. | (32 Fl. | (3.2 Fl. | (32 Fl. |
| Pepper Variety | oz/Ac) | oz/Ac) | oz/Ac) | oz/Ac) |
| Composition 1: RK | +22.70% | +32.95% | +4.94% | +7.41% |
| Composition 2: RK | +6.63% | +17.96% | +8.64% | +9.88% |
| Composition 1: HHW | +57.67% | +45.02% | +33.3% | +9.72% |
| Composition 2: HHW | +146% | +185% | +72.22% | +141% |

The average yield for the betaine and proline foliar treatments are represented as a percent change over the average yield harvest of the control plants. The percent change in yield in the foliar treated peppers was reported as an average for the two harvests and for the two pepper varieties. Percent change in yield over the control (water) pepper plants are reported for both the RK and HHW pepper varieties (Table 15).

Foliar betaine-HCl resulted in an average increase in yield of 33% (reported in total weight) in RK peppers at the higher 32 Fl. oz/Ac (946 mL/hectare) application rate and respective increases of 4.9% and 7.4% over the control in total number of peppers for both application use rates. Foliar L-proline resulted in respective 6.6% and 18% increases in yield as reported for total weight in RK peppers at the 3.2 and the 32 Fl. oz/Ac (234 mL and 946 mL/hectare) application rates and respective increases of 8.7% and 9.9% over the control in total number of peppers for both application use rates. Additionally, foliar treatment with betaine-HCl resulted in respective 57.7% and 45% increases in yield as reported for total weight in HHW peppers at the 3.2 and the 32 Fl. oz/Ac (234 mL and 946 mL/hectare) application rate and respective 33.3% and 9.72% increases over the control in total number of peppers for both application use rates. Foliar treatment with L-proline resulted in respective 146% and 185% increases in yield as reported for total weight in HHW peppers at the 3.2 and the 32 Fl. oz/Ac (234 mL and 946 mL/hectare) application rate and respective 72.2% and 141% increases over the control in total number of peppers for both application use rates.

There were differences in how the two pepper varieties responded to the L-betaine and L-proline foliar treatments and in the resultant yield advantages provided to both pepper varieties (Table 15). Substantial yield increases were seen in the HHW variety of peppers, the RK variety of peppers, and the control or non-treated plants. The betaine-HCl and L-proline foliar treatments applied to both the RK and HHW varieties of peppers resulted in both increased weight (higher use rate for RK) and total number of peppers as compared to the non-treated plants or plants receiving the water control.

### Example 16: Application to Potato—Increased Yield

Potatoes were planted in pots to simulate a planting density that is commonly used by commercial growers and equivalent to one slice planted per foot in rows with a pot diameter which was selected using the recommended row spacing used by commercial growers. Potatoes (Variety: Yukon Gold) were started from slices using one slice containing 2-3 eyes each and planted cut side down with eyes pointing up planted per each 7.6 L pot containing topsoil. The L-proline composition (composition 2 of Example 1) was applied as an in-furrow treatment by applying the composition to the potato slice and/or the area surrounding the potato slice at an application use rate of 3.2 Fl. oz/Ac per pot (234 mL/hectare). Eight replicates per treatment were harvested 90 days after planting. Yield parameters of total biomass (fresh mass) of potatoes per plant, and diameter per potato were measured and averages were reported as a percent change compared to the control non-treated (water only) plants (Table 16).

TABLE 16
In-furrow treatment with proline increases total biomass
and diameter of potatoes

| | Total | | Total # of | Avg. | |
|---|---|---|---|---|---|
| | Biomass | | potatoes | Diameter | % Δ in |
| | Fresh | % Δ in | per | per potato | potato |
| Treatment | mass (g) | Biomass* | treatment | (mm) | diameter* |
| Control | 202.6 | 100% | 10 | 338.47 | 100% |
| Composition 2 | 332.2 | 163.9% | 16 | 468.62 | 139% |

*Compared to Control

Treatment using L-proline (composition 2) applied as an in-furrow treatment to potato slices at the time of planting resulted in substantial increases in total biomass and harvestable yield of potatoes. Increased yield resulted from total increases in fresh biomass (g), harvestable yield or number of potatoes, and potato diameter (mm) and a total increase in number of potatoes per plant as compared to the control or non-foliar treated plants (Table 16).

### Example 17: Application to Squash—Increased Yield

Foliar treatments containing betaine-HCl (composition 1 of Example 1) or L-proline (composition 2 of Example 1) were applied exogenously to Crookneck squash at the first bloom stage. Foliar treatments for both the betaine and proline compositions were applied to squash plants using an application use rate of 3.2 Fl. oz/Ac (234 mL/hectare). Yield comparisons were made between the plants treated with the betaine and proline compositions, and compared to the control non-treated (water only) plants planted in the same Midwest (MO) location using two replicated trials.

Yield for the foliar treated plants is reported in Table 17 as the number of squash per plant, the weight (grams) per squash and the total squash yield (lbs/Ac) and represented as a percentage change as compared to non-treated control plants.

TABLE 17
Foliar treatment with compositions of betaine or proline
increases yield in squash

| | % Δ in Number | % Δ in | % Δ in |
|---|---|---|---|
| Treatment | of Squash | Weight/ | Yield |
| (Application Rate) | per Plant | Squash | (lbs/Ac) |
| Composition 1 | +10% | +12% | +21% |
| (3.2 Fl. oz/Ac) | | | |
| Composition 2 | +14% | +16% | +29% |
| (3.2 Fl. oz/Ac) | | | |

Both foliar treatments, betaine-HCl (composition 1) and L-proline (composition 2), resulted in an increased yield advantage in Crookneck squash when applied at the pre-bloom stage compared to the non-treated control plants. Percent increases for the foliar-applied treatments are shown for the percent change in the number of squash per plant, the weight per squash and the total yield increases in Table 17.

### Example 18: Application to Lettuce—Increased Yield

Foliar compositions containing betaine-HCl (composition 1 of Example 1) or L-proline (composition 2 of Example 1) were applied two-weeks post-emergence to Bib lettuce grown in a Midwest (MO) location. The betaine and proline foliar compositions were applied at an application use rate of 3.2 Fl. oz/Ac or 32 Fl. oz/Ac (234 mL and 946 mL/hectare, respectively), on lettuce plants. Harvestable yield (harvestable leaf lettuce or above ground biomass) for lettuce that received the betaine-HCl or L-proline foliar treatments was compared to the control (water only) plants. Effects of the foliar applications on lettuce yield was determined for two separate harvests using a once-over harvest approach and normalized to the yield of the control plants. The average percentage change in yield over the yield for the control plants is reported in Table 18 as the percent change in yield (lbs/Ac) compared to the control lettuce.

TABLE 18
Foliar treatment with compositions of betaine or
proline increases yield in lettuce

| Treatment (Application Rate) | % Δ in yield |
|---|---|
| Composition 1 (32 Fl. oz/Ac) | +5.0% |
| Composition 2 (3.2 Fl. oz/Ac) | +2.7% |
| Composition 2 (32 Fl. oz/Ac) | +4.0% |

The foliar treatments comprising betaine-HCl (composition 1) or L-proline (composition 2) applied at the higher use rate of 32 Fl. oz/Ac resulted in respective 5% and 4% increases in fresh harvestable biomass over the non-treated lettuce plants.

### Example 19: Application to Lawn and Turf—Increased Growth and Health

A foliar treatment containing betaine-HCl (composition 1 of Example 1) was applied to turf grass (Variety: Zoysia) to determine if the foliar application promoted plant growth and/or health and/or delayed dormancy and browning. Foliar applications were applied on golf course turf grass in locations that received full sun or partial shade and were compared to the turf that did not receive the treatment with betaine but received water instead (water controls). The foliar application with betaine-HCl was applied using a use rate of 3.2 Fl. oz/Ac (or 234 mL/hectare) over the surface of the turf grass and replicated using 1.22×1.22 meter turf blocks at four locations on the golf course that received full sun or partial shade during peak months. Each location selected was facing due West and assigned using a grid system to mark the turf that received the foliar and control treatments. At each location, each block was divided into eight sections with two replicates collected per each treatment. Changes in plant height (cm), a measure of plant growth rate of turf grass, were measured over the season and normalized to the non-foliar treated (control) turf grass. Average percent change in plant height as normalized to the control and the standard deviations (STDEV) are reported in Table 19.

TABLE 19
Foliar application of betaine for increased growth in turf grass

| | Avg. % Δ | Avg. % Δ | Avg. Δ |
|---|---|---|---|
| | in plant | in plant | in plant |
| | height, | height, | height |
| Foliar Treatment | Replicate 1 | Replicate 2 | (STDEV) |
| Full Sun: Betaine-HCL | 101.1% | 101.1% | 101.1% |
| Composition 1 | | | (0.46) |
| Partial Shade: Betaine-HCL | —* | 100.6% | 100.6% |
| Composition 1 | | | (0.45) |

*Removed due to disease

Changes in plant height (cm) are reported in turf grass that receiver foliar treatments using the betaine-HCl treatment (composition 1) in the full sun and the partial shade environments on a golf course (Table 19). Plant height—a measure of plant growth—was increased for Zoysia turf grass that received the foliar treatment with betaine-HCl in both full sun and partial shade environments as compared to the control turf that received no foliar treatment. Foliar treatment when applied to the turf areas that received full sun (replicates 1 and 2) resulted in an increased plant height as compared to the turf areas that received partial shade (replicate 2; replicate 1 was removed due to disease).

### Example 20: Application to Corn—Improved Water Movement and Retention, Turgor, and Osmotic Potential

Osmotic adjustment in plants is a mechanism for maintaining turgor and reducing the negative effects of water stress on vegetative and reproductive tissues. Corn plants (Beck's Corn Variety (hybrids) 5828 YH) were treated with a foliar composition comprising betaine-HCl (composition 1 of Example 1). The composition was applied to corn plants at approximately V4-V7 stages of development to increase water potential and maintain a positive balance in turgor to enhance plant survival and productivity under heat stress environments.

The foliar application was applied at a crop use rate of 3.2 Fl. oz/Ac (234 mL/hectare). The PLANTBEAT system (PHYTECH) was used to determine the water potential over time or turgor potential (real-time water moving through the plant) with and without application of the betaine foliar treatment.

Locations were specifically selected that were subjected to heat stress in the field. The PLANTBEAT system uses a water meter and moisture sensors that measure the loss of water from the soil. The moisture measurements are collected using a real-time interface for recording and data loading using a computer or mobile interface. Real-time measurements for stem diameter (using a dendrometer (a device for measuring stem diameter or thickness) having a range of 0-10 mm resolution), water tension in the soil (range 0-84 cBar; using a tensiometer), temperature (range of 0-40° C.) and volumetric water content (VWC; range of 0-70%) were collected for V4-V7 corn plants receiving the betaine foliar treatment and compared to the control (water only).

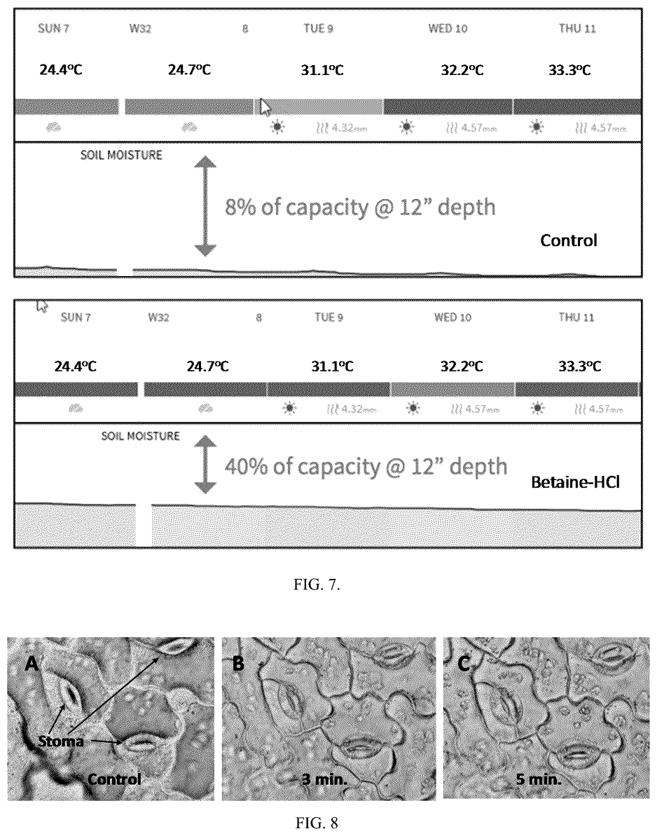

The PHYTEC PLANTBEAT caliper system was also used to measure stalk diameter with moisture sensors placed 30.5 cm below the soil surface to measure the removal of water from the soil during heat stress. Changes in water movement and turgor into the corn plant receiving the betaine foliar application treatment were compared to soil moisture or measurement of soil capacity at a one-foot depth (FIG. 7).

The data collected for water movement or turgor potential for the corn plants were combined with soil moisture data collected using microclimate sensors. Spatial imaging was also used to provide a view of water stress conditions in the field.

Corn plants that received the exogenous applications of the betaine-HCl composition exhibited improved water movement into the plant accompanied by water retention in the plant. This treatment also resulted in improved turgor for these foliar-treated plants that were subjected to heat stress, water deficit, drought and low humidity environments. Corn plants receiving the betaine-HCl composition treatment exhibited increased desiccation tolerance, which is associated with less stomatal conductance and decreased transpiration losses that result in an increase in water use efficiency (WUE). The foliar-treated plants pulled less water from the soil under stress-associated conditions as compared to control plants that received only a water control spray treatment (FIG. 7).

TABLE 20
Corn stalk diameter daily change (mm) as calculated
over a five-day period

| Treatment | Day 1 | Day 2 | Day 3 | Day 4 | Day 5 |
|---|---|---|---|---|---|
| Water Control | 140 | 264 | 403 | 542 | 558 |
| Composition 1: | 129 | 140 | 176 | 196 | 145 |
| Betaine-HCl | | | | | |

Fluctuations in corn stalk diameter were measured over a 5-day period using the PHYTECH PLANTBEAT caliper system, and results are shown in Table 20. Extreme fluctuations in turgor pressure as measured by changes in stalk diameter are indicators of a plant under water deficit stress. An increase or change in stem diameter over one day provides an indicator of plant stress. A change of over 200 mm indicates a physiological stress response in corn.

Plants treated with an agriculturally effective concentration of betaine-HCl (composition 1) were assessed for changes in water movement into and through the plant and for fluctuations in turgor pressure. The control or non-foliar treated corn plants lost considerably more water through the plants into the surrounding atmosphere when compared to corn plants that received the foliar application treatments containing betaine-HCl as described. Corn plants treated with the betaine-HCl applied as a foliar treatment showed increased water retention and constant maintenance of turgor pressure in the plants as depicted by the consistent range reported in stalk diameter from 129-196 mm over the 5-day period compared to the fluctuations seen in the stalk diameter for the control plants ranging in fluctuations from 140-558 mm (Table 20). Absolute changes in stalk diameter are indicative of turgor adjustments in the plant which can be a measure of extreme stress, water movement and the resultant water loss from the plant. These parameters may be regulated by the plant as an effort to maintain osmotic potential. The stalk diameter change, a measure of turgor pressure, was found constant in the corn plants that received the betaine-HCl foliar application as compared to plants receiving the water control treatments that showed great fluctuation in stalk diameter or turgor pressure. In addition, the diameter of the corn treated with the betaine-HCl foliar application exhibited less fluctuation in stalk turgor which was related to more water retention in the plants. The betaine-HCl foliar treated corn plants also exhibited lower soil temperatures compared to the higher soil temperatures reported for the soil that the control plants.

The PLANTBEAT system provides an accurate measure of soil moisture in the soil. Soil in plots with the corn control plants had less of a capacity to retain moisture and exhibited a reduction in the capacity of the soil to maintain water—an 8% capacity as compared to soil planted with corn plants that received the betaine-HCl foliar treatment measured a 40% capacity to retain soil moisture at a depth of one foot. There was an apparent differentially increased loss of moisture from the soil with the corn plants that did not receive the foliar treatment (controls) compared to plants that received the betaine-HCl foliar treatment. The plants treated with the foliar applications containing betaine-HCl used overall less water from the soil which is transpired through the plant to the atmosphere and therefore the soil near and under the treatment plants retained more water during conditions of heat stress and exhibited cooler temperatures (FIG. 7).

### Example 21: Application to Soybean—Improved Water Movement Promotes Stomatal Opening and Turgor in Soybean Leaves

A betaine composition was applied to isolated epidermal layers from soybean leaves and stimulation and promotion of stomatal opening was examined. Water movement through stomata is related to increased gas exchange or the movement of carbon dioxide into the leaf, which becomes fixed into carbon and correlates to an increase in water use efficiency (WUE) or to a more efficient water movement through the plant. WUE can also be defined as the ratio of biomass produced to the rate of water transpired through the stomata (transpiration). Treatment with a formulation comprising betaine-HCl as an osmoprotectant, a potassium salt as an anti-desiccant, and a surfactant as an anti-respirant (composition 4 of Example 1) was applied to the outer epidermal layers excised from soybean leaves to measure the effect of betaine-HCl on stomatal opening and closing.

Soybean plants (MorSoy variety) were grown in 3.8 L pots using a planting mix of 3:1 topsoil to VIROGO potting mix containing the following percentages of total nitrogen (N), available phosphate (P) and soluble potassium (K): 0.07% total nitrogen/0.04% available phosphate/0.03% soluble potassium under standard summer conditions in July in the US Midwest (MO). Epidermal layer peels were collected from the abaxial (lower) surface of soybean leaves from plants at the V5 stage of development. Immediately after collection, the epidermal sections were floated in the dark and maintained at a constant temperature of 22° C. for 30 minutes on a solution of 1 mM CaCl₂. The epidermal sections were then floated for a few seconds on deionized water and subsequently were transferred to a solution containing betaine-HCl (composition 4 of Example 1). The pre-treatment with CaCl₂ was used to remove any broken cells, as well as permit mechanical adjustment of the stomatal complex (guard cells plus aperture) that may have occurred during the removal of the epidermal sections from the soybean leaves. Control images (initial aperture) were collected immediately after pre-treatment (prior to the treatment with betaine-HCl). The pre-treated epidermal sections were then added to the betaine-HCl solution and imaged continuously over a five-minute period of time. Each epidermal sample was considered one replicate. A total of nine replicate samples were imaged from each soybean plant using a total of three soybean plants (resulting in a total replicate sampling of 27 sections). Epidermal sections were imaged mounted on a microscope slide with a drop of deionized water and immediately observed with a light microscope (OMAX A3RDF50 Phase Contrast Microscope, 400× magnification). A digital color camera (OMAX A3550U) was attached to the microscope and was used to capture images. The images were sent to real-time imaging software (OMAX Toup View). Color photomicrographs (300 pixel resolution with white balance correction) were captured from the outer epidermal sections with continuous monitoring for a period of 5 minutes. Representative images were collected for the pre-treatment control (panel A of FIG. 8), the betaine-HCl treatment at three minutes (panel B of FIG. 8), and the betaine HCl treatment at five minutes (panel C of FIG. 8).

Stomatal-associated guard cells surrounding each stoma in the epidermal sections exhibited increased opening of the stomata. with the application of betaine-11Cl (composition 4) in all of the 27 replicate samples imaged. Application of composition 4 increased the solute concentrations of the solution, moving water from a higher water potential (outside of the epidermal leaf sections) to a region of lower water potential, moving the betaine-HCl solution into the leaves resulting in an increased turgidity of the guard cells and thus increasing the aperture of the stomatal pore(s). In panel A of FIG. 8, guard cells that have lost water or become flaccid are shown and lead to the closure of the stomatal opening or a decrease in stomatal aperture. Application of the betaine-HCl solution resulted in the increased opening of the stomata or in an increased stomatal aperture between the two guard cells. The increase in stomatal aperture that occurred with the betaine-HCl treatment was observed after a three-minute incubation period (panel B of FIG. 8). This increase was maintained and there was a further increase in stomatal aperture within the stomatal complex with the five-minute incubation period (panel C of FIG. 8). In the soybean abaxial epidermal sections, leaves that received the control pre-treatment exhibited only completely closed stomata (or an average measure of stomatal aperture of 0 μm in size) whereas the sections that received the betaine-HCl treatment averaged stomatal apertures ranging from 2-2.2 μm after the three-minute incubation period and 2.5 3 μm after the five-minute incubation period.

### Example 22 Application to Onion—Improved Membrane Integrity after Exposure to Salinity-Induced Stress

The impact of salinity stress on the cell integrity of epidermal cell membranes of Sabroso onions (Allium cepa L.) was determined by treating the onion cell membrane layer with a saline solution, and then, at a prescribed time, applying a treatment with an osmoprotectant composition. Exogenously applied osmoprotectants such as betaine-HCl or L-proline or a combination of betaine and proline can be used to assist with the recovery and stabilization of cell membranes exposed to salt stress. Osmoprotectants such as betaine and proline accumulate in cells and assist with balancing the osmotic difference between a cell's surroundings and the cytosol. Exogenous applications consisting of betaine-HCl and L-proline were applied both in combination and separately to the onion cell layers after exposure to a saline (salinity imparted) stress and then examined for cell membrane recovery and integrity from the exposure. Permeabilization of plant cell membranes that surround the primary liquid contents in the cytoplasm of the cell causes leakiness and is detrimental to the cells of a growing plant. Permeabilization can be either reversible, in which case the cell membrane can reseal following a treatment (for example, high saline), or irreversible, where the cell membranes dissociate from the cell structures and pull away, resulting in cell lysis or rupture.

Onion cell membranes that received exposure to high saline were examined for changes in membrane recovery, stabilization, and integrity after treatment using osmoprotectant treatments comprising a combination of betaine-HCl and L-proline (composition 3 of Example 1), betaine-HCl (composition 4 of Example 1), or L-proline (composition 5 of Example 1) and were compared to the onion cell layers that received no exposure to saline (deionized water control treatment). A single layer of the onion epidermis was excised from Spanish yellow onions (Sabroso variety, approximately 8-10 cm in bulb diameter). The outer papery scales, the first fleshy scale, and the second layer of the onions were removed. Then, 20-mm diameter sections were excised from the third scale layer (undamaged). Each sample was considered one replicate. A total of nine replicate samples were collected and imaged from each onion bulb, and three separate onions were used, resulting in 27 total replicate samples. The onion cell layers were used to determine cell membrane integrity after application of the saline treatment and then to examine cell membrane recovery following the treatment with the compositions containing betaine and/or proline osmoprotectants.

Onion sections were cut and rinsed in deionized water to remove any cell debris or other contents and then immediately immersed in a freshly diluted Neutral Red (NR) staining solution (NR dye, THERMO FISHER). Freshly diluted stock Neutral Red dye was prepared as a 0.5% NR solution dissolved for 30 minutes in acetone and then filtered twice. The filtered stock was further diluted to 0.04% using a 0.2 M mannitol in 0.01 M HEPES (4-(2-hydroxyethyl)-1-piperazineethanesuflonic acid) buffer (pH 7.8). The resulting solution was used as the dyeing solution. Sections of the onion were dipped in 600 μl of diluted dye solution for a period of two hours and then rinsed for 30 minutes in the 0.2 M mannitol/0.01 M HEPES buffer solution. Onion specimens were mounted on a microscope slide with a drop of deionized water, and immediately observed with a light microscope (OMAX A3RDF50 Phase Contrast Microscope; 0.50× fixed field). A digital color camera (OMAX A3550U) was attached to the microscope and was used to capture images, which were sent to real-time imaging software (OMAX Toup View). Color photomicrographs (300 pixel resolution with white balance correction) were captured from the cells comprising the outer epidermis of each specimen.

To examine the effects of salinity stress, a saline solution of 300 mM NaCl was applied to the onion cell layers for a period of 30-40 minutes. The onion cell layers were then imaged as described above to record the amount of membrane integrity or separation from the intact cell layer. The osmoprotectant treatments comprising betaine-HCl and L-proline (composition 3), betaine H—Cl (composition 4), or L-proline (composition 5) were subsequently added to the samples. The osmoprotectant treatments were applied directly to the surface of the epidermal cell layer and cell layers were continually imaged for two to three minutes. Membrane recovery, stabilization and integrity was determined for each of the osmoprotectant treatments by imaging as described above and compared to the water control treatment in each replicate series.

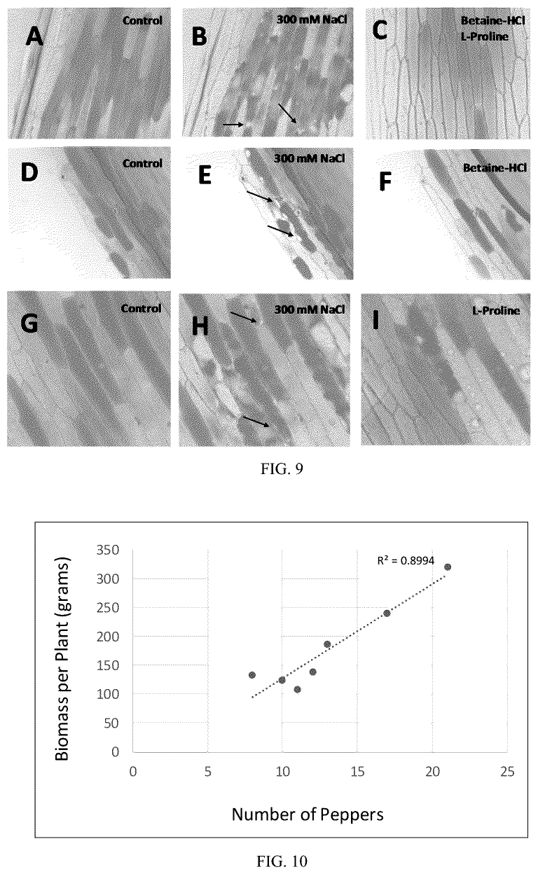

In FIG. 9, the epidermal layers from the three onion plants that were treated with the deionized water control treatment show only healthy cells with no indication of membrane detachment or permeabilization (panels A, D and G of FIG. 9). By contrast, the epidermal cell layers that received a saline stress (300 mM NaCl), which show dissociation of the cell membranes and shrinkage within the cells (panels B, E and H of FIG. 9).

Exogenous application of compositions 3, 4, or 5 resulted in a complete recovery of the onion cell membranes (panels C, F and I of FIG. 9). All of the onion cell membranes that received the osmoprotectant treatments exhibited a reversal of the membrane permeabilization caused by the high salt treatment. Treatment with the composition containing both betaine-HCl and L-proline (composition 3) resulted in the most complete membrane recovery to a control or a non-saline treated state and, as shown in panel C of FIG. 9.

### Example 23: Application to Corn Enhanced Normalized Difference Vegetation Index (ENDVI) Analysis

Enhanced Normalized Difference Vegetation Index (ENDVI) is an indicator of live green vegetation and was used to determine the greenness index of crops in field trials using remote sensing technology. In the ENDVI index, values ranging from −0.1 to 0.1 are indicative of no or zero greenness, whereas values approaching 1 are indicative of lush greenness. Plants strongly absorb visible light from the 400-700 nm spectral wavelength range and reflect the wavelengths in the near-infrared light from 700-1100 nm. ENDVI measurements can correspond to certain vegetative properties, such as plant biomass or greenness, absorption of light by plant canopies, and photosynthetic capacity (e.g., leaf area index, biomass, and chlorophyll concentration). ENDVI images were collected using a sensor attached to a drone (DJI MATRICE 100) specifically created to capture images and filter different wavelengths of light during the capture. The sensor uses visible and near-infrared bands of the electromagnetic spectrum. Healthy plants with large amounts of vegetation or biomass reflect green (G) and near-infrared (NIR) light, while absorbing both blue (B) and red light. Plants that are less healthy or that have less above-ground biomass reflect more visible and less NIR light. ENDVI uses both red and green as the reflective channels while using blue as the absorption channel. The ENDVI formula below adds the NIR and green channels together for the reflective channel. The blue channel is multiplied by two to compensate for the NIR and G channels being added together. The ENDVI equation uses the following calculation for the NIR, G, and B channels to provide a ratio value as a single output:

$$ENDVI = \frac{( NIR + Green ) - ( 2 * Blue )}{( NIR + Green ) + ( 2 * Blue )}$$

Corn seed (DEKALB hybrid DKC 58-89 variety) treated with a seed treatment comprising EVERGOL® fungicide (7.18% propiconazole, 3.59% penflufen, and 5.74% metalaxyl) and PONCHO®/VOTiVO® 500 (a mixture of 40.3% clothianidin insecticide and 51.6% Bacillus firmus 1582, a microbial agent) was planted in the US Midwest (IL). Various foliar treatments containing an osmoprotectant, an anti-desiccant, and/or an anti-respirant were applied to corn plants at the V5-V7 stage of development. ENDVI images were collected three weeks after each foliar treatment and after the corn canopy had fully closed. Plot regions to identify individual foliar treatments in a field and the replicates per each treatment were clearly established using GPS coordinates in each field trial. The treatment replicates identified for imaging were consistent in size. For each foliar treatment, three replicates were collected with one row imaged per each replicated plot. Using ENDVI technology, orthomosaic images were collected in the red, near infrared, green, blue and white (255 nm, a filter for background as the green channel would also reflect white light) wavelengths on identical size plots per treatment. The images were processed using drone display image analysis software. The average intensity for each of the image channels was collected separately using the split channel mode. The ENDVI values for the NIR, G and B spectral reflectance were then averaged and entered into the ENDVI algorithm to calculate a measure of plant health (greenness) for each plot replicate. These numbers were then averaged for the three plot replicates as reported in Table 21 to Table 25. ENDVI values for the treatment applications were compared to the control treatments as designated in Table 21 to Table 25. Treatment compositions were applied at 3.2 Fl. oz/Ac (234 mL/hectare).

TABLE 21
ENDVI outputs provided for osmoprotectant foliar
treatments on corn hybrid DKC 58-89

| | ENDVI | % Δ in ENDVI |
|---|---|---|
| Composition | (STDEV) | average* |
| Anti-respirant control B | 0.240 (0.022) | — |
| Composition 4 | 0.253 (0.008) | +6% |
| Composition 6 | 0.252 (0.006) | +5% |
| Composition 7 | 0.250 (0.017) | +4% |
| Composition 8 | 0.249 (0.016) | +4% |
| Composition 9 | 0.254 (0.010) | +6% |

*Normalized to anti-respirant control B

Compositions comprising betaine-HCl and/or L-proline, an anti-desiccant, and an anti-respirant (compositions 4 and 6-9) were exogenously applied to V5-V7 corn plants. Compositions 7, 8, and 9 contained approximately 2% more of the anti-desiccant in the form of potassium phosphate tribasic as compared to compositions 4 and 6. The anti-respirants used in the formulations also differed between the foliar treatments. The anti-respirant in compositions 4 and 6 was an alkyl and alkyl lauryl polyoxyethylene glycol surfactant. The anti-respirant in compositions 7, 8, and 9 was an alkyl polyoxyethylene. Results are shown in Table 21. Foliar application of betaine-HCl (composition 4, 6, 7, and 8) or betaine-HCl applied in combination with L-proline (composition 9) resulted in increased ENDVI index or ratio compared to plants that received anti-respirant control B. ENDVI is reported as the percent change as compared to the ENDVI collected from corn plants that received only the anti-respirant B control. ENDVI ratio values were the highest (6% increase) for the betaine-HCl (composition 4) and betaine-HCl +L-proline (composition 9) treatments.

Corn seed from DEKALB hybrids (DKC 58-89 and DKC 52-61) was grown from seed treated with EVERGOL® fungicide combined with PONCHO®/VOTIVO® 500 prior to planting. Exogenously applied osmoprotectants were applied with a fertilizer at the V5-V7 stage of development. A foliar fertilizer, CORON 25-0-0.5B (available from Helena Chemical) was examined for compatibility with compositions containing a combination of betaine-HCl and L-proline (composition 10 of Example 1) or betaine-HCl (compositions 6, 6-1, and 6-2 of Example 1) applied as foliar treatments. The anti-respirants tested in combination with the betaine-HCl and L-proline treatments included three non-ionic surfactants: ALLIGARE SURFACE™ (alkyl and alkyl lauryl polyoxyethylene glycol), ALLIGARE 90 (alkyl polyoxyethylene) and AQUA SUPREME (alkyl polyoxyethoxylate ether; Alligare LLC). ENDVI values are reported for each treatment as the average for the two corn hybrids (DKC 58-89 and DKC 52-61) in Table 22. Control plants received no treatment with fertilizer or osmoprotectant compositions, but were treated with EVERGOL® fungicide combined with PONCHO®/VOTIVO® 500.

TABLE 22
ENDVI with foliar treatment using osmoprotectants applied
with and without a fertilizer in two corn hybrids

| | Average ENDVI | % Δ Change in |
|---|---|---|
| Composition | (STDEV) | ENDVI average* |
| Control | 0.219 (0.029) | — |
| Composition 6 | 0.242 (0.035) | +10% |
| Composition 6-1 | 0.226 (0.029) | +3% |
| Composition 6-2 | 0.234 (0.023) | +7% |

*Normalized to control

As shown in Table 22, comparison of betaine-HCl (compositions 6, 6-1, and 6-2) containing different anti-respirants exhibited increased ENDVI ratio values as compared to ENDVI values from plants grown from the seed that received only the seed treatment. The ENDVI ratio values resulting from composition 6 (alkyl and alkyl lauryl polyoxyethylene glycol) were 10% greater compared to the average ENDVI value for plants grown from seeds that received only the seed treatment and did not receive a foliar treatment application. The betaine-HCl applied in formulation with alkyl polyethoxylate ether (composition 6-2) provided a 7% increase in the average ENDVI over the control, whereas the betaine-HCl formulated with alkyl polyoxyethelene (composition 6-1) provided a 3% increase in average ENDVI over the control and was equivalent to the treatment with composition 11, which contained both the betaine-HCl and L-proline osmoprotectants.

Foliar treatments using SILWET L-77 (a non-blended organosilicone surfactant) as an anti-respirant used in combination with an anti-desiccant (potassium acetate) and trehalose as an osmoprotectant were applied to corn (DEKALB hybrid, DCK 58-89) at the V5 V7 stage of development and assessed for differences in ENDVI ratio values as compared to plants that did not receive a foliar spray treatment. Controls did not receive any spray treatment. Results are shown in 23 and 24.

TABLE 23
ENDVI comparisons using varying osmoprotectant,
anti-desiccant and anti-respirant foliar treatment
combinations on corn (hybrid DKC 58-89)

| | Component | | | |
|---|---|---|---|---|
| | (Rate of | | | % Δ in |
| | Application in | | ENDVI | ENDVI |
| Composition | Fl. oz/Ac) | Concentration | (STDEV) | Average* |
| Control | — | — | 0.243 | — |
| | | | (0.012) | |
| Composition | SILWET L-77 | 0.010% (v/v) | 0.253 | +4% |
| 23 | (3.2) | (87 μM) | (0.012) | |
| Composition | Potassium | 1.12 μM | 0.246 | +1% |
| 24 | Acetate (3.2) | | (0.031) | |
| Composition | SILWET L-77 | 0.010% (v/v) | 0.263 | +8% |
| 25 | (3.2) | (87 μM) | (0.011) | |
| | Potassium | 1.12 μM | | |
| | Acetate (3.2) | | | |

*Normalized to control; Application use rate for SILWET L-77 and Potassium Acetate was 3.2 Fl. oz/Ac (234 mL/hectare).

As shown in Table 23, corn plots that received a foliar treatment using potassium acetate alone provided only a slight increase in ENDVI ratio value over the no-spray control plots; however, the potassium acetate and SILWET L-77 treatment provided an 8% increase in ENDVI ratio value over the no-spray control plots.

TABLE 24
ENDVI comparisons using varying osmoprotectant, anti-desiccant and
anti-respirant foliar treatments combinations on corn (hybrid DKC 58-89)

| | ENDVI (STDEV) | ENDVI (STDEV) | % Δ in |
|---|---|---|---|
| | Hybrid 1: | Hybrid 2: | ENDVI |
| Composition | DCK 58-89 | DCK 52-61 | average* |
| Control | 0.243 (0.012) | 0.235 (0.020) | — |
| Composition 23 | 0.253 (0.012) | 0.241 (0.014) | +4% |
| Composition 24 | 0.246 (0.031) | 0.252 (0.10) | +4% |
| Composition 25 | 0.263 (0.011) | 0.244 (0.007) | +6% |

*Normalized to control

As shown in Table 24, composition 25 (comprising SILWET L-77 and potassium acetate) resulted in higher ENDVI ratio values, with an approximately 6% increase over the no-spray control plots. The foliar applications of SILWET L-77 (composition 23) and potassium acetate (composition 24) applied individually to the two corn hybrids showed on average a 4% increase in ENDVI over the no-spray control plots.

Ectoine (S)-2-methyl-3,4,5,6-tetrahydropyrimidine-4-carboxylic acid or 1,4,5,6-tetrahydro-2-methyl-4-pyrimidinecarboxylic acid) was selected as an alternative osmoprotectant foliar treatment for corn and applied to DEKALB hybrid DKC 65-81 at the V5-V7 stage of development. Ectoine serves as a protective substance by acting as an osmolyte and was used as a foliar treatment in combination with at least one anti-desiccant and at least one anti-respirant. Ectoine was exogenously or foliarly applied in combination with potassium sulfate as the anti-desiccant and AEROSOL OT-100 (an anionic sulfosuccinic acid-based surfactant) (Table 25).

TABLE 25
ENDVI comparisons using ectoine as an osmoprotectant foliar
treatment on corn (hybrid DKC 65-81)

| | Component | | | |
|---|---|---|---|---|
| | (Rate of | | | |
| | Application | | | % Δ in |
| | in mL | | ENDVI | ENDVI |
| Composition | per hectare) | Concentration | (STDEV) | average* |
| Control | — | — | 0.264 | — |
| | | | (0.010) | |
| Composition | AEROSOL | 0.013% (v/v) | 0.272 | +3% |
| 26 | OT-100 | 292.4 μM | (0.012) | |
| | (189.3) | | | |
| Composition | Potassium | 574 μM | 0.265 | — |
| 27 | Sulfate | | (0.002) | |
| | (94.6) | | | |
| Composition | Ectoine | 208 μM | 0.261 | −1% |
| 28 | (94.6) | | (0.010) | |
| Composition | AEROSOL | 0.013% (v/v) | 0.274 | +4% |
| 29 | OT-100 | 292.4 μM | (0.016) | |
| | (189.3) | | | |
| | Potassium | 574 μM | | |
| | Sulfate | | | |
| | (94.6) | | | |
| Composition | AEROSOL | 0.013% (v/v) | 0.276 | +4% |
| 30 | OT-100 | 292.4 μM | (0.013) | |
| | (189.3) | | | |
| | Ectoine (94.6) | 208 μM | | |

*Normalized to control

As shown in Table 25, treatment with combinations of the AEROSOL OT-100 surfactant and potassium sulfate or the AEROSOL OT-100 surfactant and ectoine (compositions 29 and 30, respectively) resulted in a 4% increase in an average ENDVI ratio value as compared to the no-spray control treatment in corn hybrid DKC 65-81. Moreover, the combination foliar treatment with the AEROSOL OT-100 surfactant and ectoine (composition 30) resulted in a synergistic effect, showing a 4% increase in average ENDVI ratio value, an effect greater than the sum of either composition applied separately.

### Example 24: Application to Sugar Beet—Antifreeze Protection

Exogenous application of betaine-HCl (composition 4 of Example 1) was used to provide antifreeze protection and applied as a foliar spray treatment to young sugar beets. Plants of the genus Beta and Chenopodiaceae, such as sugar beet, are able to accumulate osmolytes such as betaines in their cells, which benefit the plant by providing protection against abiotic stress. However, additional benefits may be provided to sugar beets, especially young plants emerging from cold soils in the spring, using exogenous applications comprising betaines. The agricultural composition used for antifreeze treatment for the application to sugar beet contained an anti-desiccant (potassium phosphate tribasic), an osmoprotectant (betaine-HCl) and an anti-respirant (alkyl and alkyl lauryl polyoxyethylene glycol).

The betaine-HCl composition was provided as a foliar application at a use rate of 3.2 fl. oz./ac (234 mL per hectare) to sugar beet plants in early developmental stages. Sugar beets (commercially available seed variety) were planted in 39.7 cm³ pots containing topsoil at a planting depth of approximately 0.6 cm, with four seeds per pot. After planting, 50 mL of room temperature water was added to each pot to allow for germination. Sugar beets were watered and fertilized using a standard regime. The pots were kept in an environmentally controlled growth chamber and grown using a 12/12 hour light/day cycle and a 21° C. day/15° C. night temperature regime. Plants were germinated and grown for 14 days (approximately 2 weeks) under these conditions and then the temperature in the chamber was lowered to −3° C. for 72 hours to simulate freezing conditions keeping the day/night parameters constant. After this time, the sugar beet plants were placed in an environment to recover for two weeks under temperatures ranging from 18-20° C., with the same light/day cycle as before. Sugar beet plants that received the foliar betaine-HCl treatment were compared to sugar beet plants that received only a water control applied to the foliage. Plants receiving both the foliar betaine-HCl applied and water-control treatments were measured for percent germination, stand count and total biomass (roots, stems, and leaves). Results were normalized to the water control (Table 26).

TABLE 26
Freeze tolerance protection of sugar beet using betaine foliar treatment

| Foliar Treatment | Percent (%) | Percent (%) | Percent (%) |
|---|---|---|---|
| (Application Rate) | Germination | Stand Count | Biomass/plant |
| Composition 1 (234 mL | 162% | 162% | 121% |
| per hectare) | | | |

Foliar application of betaine HCl (composition 1) resulted in an increase in percent germination, percent stand count (recovery from the cold treatment), and overall productivity as represented by greater biomass produced per sugar beet plant. The foliar application of betaine-HCL composition provided as a spray to sugar beet seedlings can be applied just prior to cold snap or predicted early frost and provides anti-freeze protection to young plants.

### Example 25: Application to Soybean—Improved Tolerance to Water Deficit and Heat Stress

An agricultural composition comprising betaine-HCl and L-proline (a 50:50 mixture of compositions 1 and 2 of Example 1) was applied exogenously as a foliar spray to soybean plants at the unifoliate (VC to V1) stage of development. Soybean seeds (Soybean variety 297 NR) were planted in 39.7 cm³ pots containing topsoil at a depth of 2.54 cm, with two seeds per pot. After planting, 50 mL of room temperature water was added to each pot to allow for germination. The pots were kept in an artificial lighted growth room receiving approximately 300 μmol m⁻² s⁻¹ for a 13/11 light/day cycle and a 21° C. day/15° C. night temperature regime.

The combined betaine and proline composition (a 50:50 combination of composition 1 and 2) was sprayed exogenously on soybean plants at the unifoliate stage (in replicates). A water control was applied to the control soybean plants. The foliar application containing betaine and proline was applied at a use rate of 3.2 Fl. oz/Ac (234 mL per hectare), in order to simulate the application use rates in the large-scale field trials. Soybean plants were treated with the foliar treatment or water alone (control) and were returned to the controlled environmental chamber for 24 hours to allow for the compositions to be absorbed into the plants. After the 24-hour absorption period, the plants were transferred to conditions that provided both heat and water deficit stress. Plants were left un-watered for three days and placed into a heat chamber that simulated summer heat (39° C.). Plants were monitored using time lapse photography over a 36-hour period. Soybean plants were ranked using a scoring system of 0-4 and coupled with the time reported in hours that it took the plants to reach the state as described by the score rankings in Table 27. A score of 0 indicates that any time during the study the plants reached a state where they were non-revivable or dead.

TABLE 27
Survivability ranking for soybean with betaine and proline treatments

| | Control Treatment | Treatment |
|---|---|---|
| Score | Time in hours | Time in hours |
| 0-dead past revival | 18 | 23 |
| 1 dying could be revived | 15 | 20 |
| 2 leaf droop | 12 | 15 |
| 3 leaf curl | 8 | 10 |
| 4 healthy | 0-7 | 0-9 |

Soybean plants (20 total plants/treatment) that received the betaine and proline combined treatments were ranked and compared to the control plants that received only a water treatment (Table 27). An average time (in hours) to reach each of the ranking stages as described for ranking 0-4 is reported in Table 27. The control (water application only) plants reached a score ranking of 0 at an average time of 18 hours, while the foliar-treated plants that received a combination of betaine and proline (50:50 mixture of compositions 1 and 2) reached a score ranking of 0 at approximately 23 hours after transfer to the stress simulated environment. Soybean plants receiving the betaine/proline composition had enhanced survivability under conditions of water deficit and heat stress and exhibited more turgor or erect unifoliates for longer periods of time.

### Example 26: Application to Corn—Enhanced Phenotypic Characteristics

Stay green phenotypes were examined during periods that provided non-stress and stress conditions in corn grown in large acre trials. Stay green phenotypic characteristics were assessed and ranked in corn plants that received the agricultural fertilizer compositions comprising an agriculturally effective amount of betaine-HCl (composition 1 of Example 1) or L-proline (composition 2 of Example 2) and compared to the control plants. Foliar compositions were applied as foliar sprays at a use rate of 3.2 fl. oz/ac (234 mL per hectare), to commercially available corn hybrid (Beck's Corn hybrids 5828 YH) at the V4-V8 stage of development. Large acre trials were conducted at separate locations throughout the Midwest territories in Iowa (IA) and Illinois (IL). Corn yield in bushels per acre (Bu/Ac) for plants receiving the betaine foliar treatment (composition 1) or the proline foliar treatment (composition 2) was measured as described above in Example 4 and results are reported in FIG. 3.

Stay green phenotypes were also examined for the corn trials at two locations for plants receiving betaine foliar treatment (composition 4 of Example 1) or the L-proline foliar treatment (composition 5 of Example 1) and having on average a 5 Bu/Ac increase over the corn control plants compared at V8-VT stage of development. Corn plants that received exogenous foliar applications of the combined fertilizer compositions of betaine-HCl and/or L-proline (compositions 4 and 5) during the V4-V8 stages of development exhibited on average two to three times more greenness when ranked visually at the V8 and VT stage of development as compared to the non-foliar treated control plants. Plants receiving the combined betaine-HCl and L-proline treatment applied exogenously to the foliage also did not exhibit chlorosis of the leaves, stunting, or leaf rolling or curling as seen in the non-treated control plants, which showed all stress-induced symptoms.

### Example 27: Application to Corn and Soybean—Protection Against Herbicide Injury

Foliar treatments comprising betaine-HCl (composition 1 of Example 1) or L-proline (composition 2 of Example 1) were applied to corn and soy plants at an application use rate of 3.2 Fl. oz/Ac (234 mL/hectare) applied concurrently with a high dose of ROUNDUP® (2% glyphosate and 2% pelargonic acid; 1.42 L/hectare). Application occurred at the V5-V8 stage of development for corn and at the R2 stage for soybean (Table 28). Control plants were not treated with herbicide, betaine-HCl, or proline.

TABLE 28
Compositions of betaine and proline applied exogenously
as foliar treatments protect against herbicide injury

| | Corn: | Corn: | Soybean: | Soybean: |
|---|---|---|---|---|
| | Bu/Ac | Bu/Ac | Bu/Ac | Bu/Ac |
| Foliar | compared | compared to | compared | compared to |
| Treatment | to control | ROUNDUP ® | to control | ROUNDUP ® |
| ROUNDUP ® | −10.1 | — | −2.4 | — |
| ROUNDUP ® | −8.0 | +2.0 | −1.2 | +1.2 |
| with Betaine- | | | | |
| HCl | | | | |
| (composition 1) | | | | |
| ROUNDUP ® | −3.0 | +7.1 | −1.6 | +0.8 |
| with L-Proline | | | | |
| (composition 2) | | | | |

As shown in Table 28, spray treatment with ROUNDUP® as applied by recommended use rates to corn and soybean resulted in loss of yield (Bu/Ac) when compared to control plants that did not received a treatment with the herbicide. ROUNDUP®-treated plants yielded approximately 10 Bu/Ac less in corn and over 2 Bu/Ac less in soybean compared to the control plants that received no herbicide treatment. Foliar treatment using exogenously applied betaine-HCl (composition 1) or L-proline (composition 2) applied concurrently on plants and fields that received an application using ROUNDUP® exhibited an increase in harvested yield in both corn and soybean plants as shown in Table 28.

### Example 28: Application of Osmoprotectants—Compatibility with Dicamba Herbicide in Soybean and Arabidopsis Bioassays

Osmoprotectant compositions comprising L-proline were tested in combination with dicamba herbicide to determine compatibility. In these instances, dicamba could be used for as an over-the-top application for post-emergence weed control. The combination testing of the osmoprotectants with dicamba was conducted on soybean and on Arabidopsis thaliana (Col-O ecotype) to determine if there were any negative impacts to the efficacy of the herbicide due to the presence of either the betaine or proline osmoprotectant. A non-transgenic variety of soybean that does not contain a transgene for dicamba resistance and is therefore sensitive to the dicamba herbicide was selected for testing in order to determine if there were any interactions or masking of the herbicide treatment by either betaine or proline osmoprotectants. Arabidopsis thaliana, a weed commonly known as thale crest, was also selected for use in these studies because the genus Brassica includes a number of weed species that are susceptible to herbicides such as dicamba.

Soybean (MorSoy variety) seed was planted directly into 39.7 cm³ pots containing a planting mix of 3:1 topsoil to VIGORO potting mix (N 0.07/P 0.04/K 0.03) at a depth of 1.5 inches (3.8 cm), with two seeds per pot, and provided with 50 mL of room temperature water (to each pot) to allow for germination. Seeded soybean pots were then placed in an environmentally controlled growth room and grown under a 16/8 light/day cycle using fluorescent lighting providing approximately 200-300 mol m⁻² s⁻¹ (light photons) and a 21° C. day/15° C. night temperature regime. Plants were grown until the unifoliate leaves were fully expanded or until the VC growth stage of development and then treated with foliar applications of L-proline provided prior to treatments with dicamba. The L-proline formulation (162 μL; composition 5 of Example 1) was diluted in water (50 mL) to provide an application use rate of approximately 3.2 Fl. oz/Ac (234 mL/hectare). A water-only control was also used. Six uniform sprays of each treatment were applied per pot at an equal distance of 30.5 cm above the top rim of the pot. The unifoliate leaves were then allowed to dry for 30 minutes prior to the addition of commercially available dicamba (CLASH™, available from NuFarm Americas, Inc.). The final herbicide concentration was 50 mg/L with 0.01% (v/v) (86.94 μM) SILWET L-77 organosilicone surfactant. Epinasty scoring was conducted on seven replicate plants per each treatment using a ranking scale of 0-4 as described in Table 29. An average epinasty score is also reported in Table 29.

TABLE 29
Epinasty scoring using foliar treatments of proline with dicamba
applied over the top on VC soybean

| Scoring with Dicamba | | |
|---|---|---|
| (Applied over the top) | Water + | Composition |
| Epinasty Ranking Scale | Dicamba | 5 + Dicamba |
| 0 = no stem bend | 3 | 4 |
| 1 = stem bend is less than 90° | 3 | 3 |
| 2 = stem bend is approximately 90° | 4 | 4 |
| 3 = stem bend is greater than 90° | 4 | 2 |
| 4 = stem points straight down or is spiraling | 3 | 3 |
| | 2 | 1 |
| | 2 | 2 |
| Average Epinasty Score per Treatment | 3.0 | 2.7 |

As shown in Table 29, foliar treatment using L-proline (composition 5) applied to soybean plants at an early stage of development was found to be compatible with the dicamba herbicide provided as an over-the-top application and did not hinder the effectiveness of the herbicide. Soybean plants that are particularly susceptible to injury from dicamba were used to examine if the damage that may occur on a susceptible plant would be inhibited or masked proline formulation. Foliar treatment with L-proline (composition 5) was provided before application of the dicamba to the unifoliate leaves of soybean. The treatment with L-proline did not prevent or inhibit injury symptoms such as epinasty symptoms on the leaves that resulted from treatment with the dicamba herbicide. The L-proline treatment when applied on soybean plants did not differ substantially from the total average epinasty score of the plants that received the water plus dicamba treatment and which resulted in an average epinasty score of 3.0.

Seed from Arabidopsis thaliana was germinated and grown sterilely on 0.5× Murashige-Skoog (MS) agar plates with 1% sucrose for one week. Seedlings were treated with a foliar application of of betaine-HCL (composition 4 of Example 1) provided with and without the dicamba herbicide (CLASH™, available from NuFarm America, Inc.) in a formulation with an organosilicone surfactant, SILWET L-77 (available from Helena Chemical) provided at a final concentration of 0.01% (v/v) (86.94 μM). The diluted betaine-HCl (composition 4) treatment was provided at a concentration that was consistent with the foliar treatment applied using a 3.2 Fl. oz/Ac (234 mL/hectare) use rate and each seedling received four sprays at this rate. Dicamba was applied as a spray to the Arabidopsis seedlings at a final concentration of 200 mg/L. This concentration is effective to inhibit growth of dicamba-sensitive weeds. The total number of Arabidopsis seedlings tested was based on the actual percentage that germinated and grew on the MS agar, a range of N=23 to N=54 total seedlings per treatment. The foliar treated plants were placed in a controlled growth chamber having a constant temperature of 21° C. and a constant photoperiod of 200-300 μmol-1 m⁻² s⁻¹ for 48 hours, after which they were scored for visible herbicide damage. Two replicate trials were conducted with the treatments that contained the addition of dicamba. A damage score ranging from 1 to 5 was assigned to each of the plants and the total number of plants in each of the score categories was recorded. An overall damage score was also calculated based on the number of total plants for each score and then averaged to report a damage score value. The damage criteria scores are provided in Table 30. The results of this study are provided in Table 31. The upper and lower numbers listed in the “Dicamba+Surfactant” and “Dicamba+Surfactant+Composition 4” rows in Table 31 represent the results from each of the two replicate trials.

TABLE 30
Damage scoring used to determine the
injury of dicamba on Arabidopsis seedlings

Score = 1: No damage. Cotyledons and emerging true leaves well
expanded and orientated horizontal to plate
Score = 2: Cotyledons well expanded and orientated horizontal to plate,
but emerging true leaves are drooping (vertical to plate)
Score = 3: Both cotyledons and emerging true leaves are drooped
(vertical to plate)
Score = 4: Entire seedling drooping, and laying on plate
Score = 5: Seedlings water-logged/transparent, or other obvious signs
of necrosis (either white or black splotches on leaves)

TABLE 31
Compatibility of betaine-HCl osmoprotectant tested in combination
with and without dicamba on Arabidopsis seedlings

| | | | | | | | Overall |
|---|---|---|---|---|---|---|---|
| | | | | | | | damage |
| | | | | | | | score 1-5 |
| | Total # | Number of seedlings per score | | | | | (STDEV) |
| Treatment | seedlings | Score = 1 | Score = 2 | Score = 3 | Score = 4 | Score = 5 | Score: 1-5 |
| Surfactant | 23 | 23 | 0 | 0 | 0 | 0 | 1.0 |
| Control (0.01%) | | | | | | | (0.00) |
| Dicamba + | 41 | 0 | 0 | 26 | 15 | 0 | 3.36 |
| Surfactant | 25 | 0 | 0 | 16 | 9 | 0 | (0.48) |
| Dicamba + | 40 | 0 | 0 | 32 | 8 | 0 | 3.15 |
| Surfactant + | 54 | 0 | 0 | 48 | 6 | 0 | (0.36) |
| Composition 4 | | | | | | | |

As shown in Table 31, dicamba applied at a final concentration of 200 mg/L to young Arabidopsis seedlings resulted in the most plants with damage scores of 3 and 4, whereas the plants treated with the surfactant-only control had no visible signs of injury. Signs of dicamba injury as described in the score groups of 1-5 were not alleviated or masked by the combination treatment of dicamba with betaine-HCl (composition 4). The overall average injury score for the dicamba plus surfactant did not differ significantly from the injury score reported with the dicamba plus surfactant used in combination with betaine-HCl. The respective damage scores were 3.36 and 3.15 for each of these treatments.

### Example 29: Application to Impatiens and Poinsettias—Increased Heat Tolerance

Impatiens at the pre-bloom stage that were well-watered and in a soilless media were placed in a growth chamber with day temperatures of 2FC to 25° C. and night temperatures of approximately 18° C. Impatiens plants were then sprayed with a foliar treatment of L-proline (composition 2 of Example 1) applied at a use rate of 3.2 Fl. oz/Ac (234 mL/hectare). Impatiens that received the proline foliar treatment or a water control treatment were returned to the growth chamber with the same temperature conditions for 24 hours after the foliar application was applied. After 24 hours, the temperature was increased to 37.8° C. and held for 38 hours. A score ranking of plant injury was conducted for the plants treated with the proline composition and compared to rankings for control plants which received only a water treatment (Table 32). All plants started with the same ranking of 5.

A similar study was performed on poinsettias. The plants were treated in the same manner as described above for the impatiens, except that the heat stress step was performed for either 36 or 72 hours following return of the plants to the growth chamber, and the temperature used to apply heat stress was 29.4° C. The poinsettias were treated with either betaine HCl (composition 1 of Example 1) or L-proline (composition 2 of Example 1). Results are shown in Table 33.

TABLE 32
Injury rankings for heat stress applied after 38 hours to impatiens

| | Average Score for Heat | |
|---|---|---|
| | Tolerance (0-5) after | |
| | Heat Treatment 38 | |
| Treatment | hours at 37.8° C. | Score Ranking |
| Control | 0 | 0 - dead past revival |
| Composition 2 | 3.5 | 1 - extreme heat stress-dying |
| (L-Proline) | | 2 - severe wilting, leaf droop |
| | | 3 - signs of stress, wilt |
| | | 4 - early signs of wilting |
| | | 5 - healthy plant no signs of |
| | | stress |

TABLE 33
Injury rankings for heat stress applied after 36 hours and 72 hours to Poinsettias
(3.2 fl. oz/ac application rate)

| | Average Score for | Average Score for | |
|---|---|---|---|
| | Heat Tolerance after | Heat Tolerance after | |
| | Heat Treatment | Heat Treatment | |
| Treatment | 36 hours at 29.4° C. | 72 hours at 29.4° C. | Score Ranking |
| Control | 0 | 0 | 0 - dead past revival |
| Composition 1 | 4.2 | 2.6 | 1 - extreme heat stress-dying |
| Betaine-HCL | | | 2 - severe wilting, leaf droop |
| Composition 2 | 4.9 | 3.2 | 3 - signs of stress, wilt |
| L-Proline | | | 4 - early signs of wilting |
| | | | 5 - healthy plant no signs of |
| | | | stress |

### Example 30: Application to Cut Flowers—Increased Transpiration and Water Movement

Flowers (freshly cut carnations) were placed in compositions comprising betaine-HCl (composition 4 of Example 1), L-proline (compositions 5 and 11 of Example 1), or a combination of both betaine-HCl and L-proline (composition 12 of Example 1). Control flowers received no water, water only, or surfactant only (anti-respirant control A of Example 1). The treatments of compositions 4, 5, 11 and 12 were provided at concentrations that were comparable to the concentrations that are used as foliar treatments and were consistent with a 3.2 Fl oz/Ac (234 mL/hectare) application use rate. Anti-respirant control A was applied at a concentration of 78.75 mM. Five flower stems (cut to equal lengths) were placed in conical tubes containing 12 mL of each treatment (with the exception of the no water control), and the tubes were then filled to 15 mL with water. The cut stems of the flowers were soaked (immersed) for approximately 24 hours in the various treatments and then placed in a controlled growth room chamber having a constant temperature of 21° C. and a constant photoperiod (200-300 μmol⁻¹ m⁻² s⁻¹). The temperature of the controlled growth environment containing the cut flowers (remaining in the treatment solutions) was then elevated to 37° C. and held constant for 24-48 hours. These conditions simulate a drought and desiccation environment that can occur as flowers are being transported from nurseries to the big box stores. Final solution uptake (mL) was measured for the cut flowers placed in treatments of betaine-HCl (composition 4), L-proline (compositions 5 and 11) or the combination betaine and proline (composition 12) and compared to the same parameter measured for the control plants which received a water only or a surfactant only treatment. Average solution uptake was compared across the cut flowers that received the different treatment formulations and also for the cut flowers that received the no water treatment, which provided a comparison to severe droughted conditions. Values were averaged over the total number of flowers per each treatment and average solution uptake values are reported in Table 34.

TABLE 34
Immersion of stems from cut flowers to preserve against
desiccation and promote longevity

| Treatment | Average Solution Uptake (mL) |
|---|---|
| Water Control | 7.45 |
| No Water Control | — |
| Anti-Respirant Control A | 7.95 |
| Composition 4 | 7.80 |
| Composition 5 | 8.30 |
| Composition 11 | 8.50 |
| Composition 12 | 9.63 |

The osmoprotectant-containing solutions (compositions 4, 5, 11, and 12) were compared to the water and to the surfactant control as well as to the no water control. Apparent differences were found in solution uptake for the cut carnations during and after the heat treatment period. All three of the treatments containing various levels of L-proline and an anti-desiccant (compositions 5, 11, and 12) provided to the cut flower stems resulted in increased solution uptake by the stems as compared to the water control or the surfactant control. Carnation cut flowers that received the treatment formulation of betaine-HCl and L-proline and a higher concentration of anti-desiccant (155 μM tribasic potassium phosphate; composition 12) exhibited the greatest increased uptake of solution, which is indicative of both increased transpiration or water movement through the cut stem and enhanced water use in the cut flower as compared to the water control or surfactant control.

### Example 31: Application of Foliar Treatment of Betaine-HCl, L-Proline, and Alternative Osmoprotectants—Corn Growth Rate and Recovery Under Droughted Conditions

Plant growth rate under droughted conditions was examined in corn treated with osmoprotectants (betaine-HCl and L-proline) provided in combination with an anti-desiccant (potassium salt) and an anti-respirant (surfactant). Corn (Beck's hybrid 5828 YH) plants were grown in an environmentally controlled growth facility. Corn seed was planted directly into 39.7 cm³ pots containing a planting mix of 3:1 topsoil to VIGORO potting mix (N 0.07/P 0.04/K 0.03) at a depth of 2.54 cm, with two seeds per pot. After planting, 50 mL of room temperature water was added to each pot to allow for germination. Plants were grown for 1.5 weeks under a 16/8 light/day cycle using fluorescent lighting providing approximately 200-300 μmol m⁻¹ s⁻¹ (light photons) and a 21° C. day/15° C. night temperature regime.

At 1.5 weeks, the plants were provided with another 50 mL of water per pot and plant height was measured for each plant. Plants were then segregated to prevent any cross contamination between the foliar treatments.

The plants then received a foliar-applied treatment with formulations that contained both betaine-HCl and L-proline (compositions 12, 13, 14, and 15 of Example 1) or betaine-HCl as the only osmoprotectant (composition 4 of Example 1). The foliar treatments were applied using six uniform and equidistant sprays (30.5 cm above the top of the pot) and provided at an application use rate that would be equivalent to 3.2 fluid ounces per acre (Fl. oz/Ac) (234 mL/hectare) in a field. Each foliar treatment included two trials with 14 replicate plants per trial. The treated plants were then randomized using a randomized block design within each treatment replicate. Control plants were treated in the same manner but with a composition containing only the surfactant, ALLIGARE SURFACE™ (alkyl and alkyl lauryl polyoxyethylene glycol; Alligare LLC) applied at a final concentration of 0.10% (v/v) (78.75 mM), consistent with the final concentration of surfactant in compositions 4 and 12-15. After the foliar treatments were applied, the plants were returned to the same randomized locations in the growth facility and left un-watered to induce and simulate droughted conditions in a field for a period of two weeks. After plants remained for a period of two weeks under drought-induced conditions, a final plant height measurement was taken for each plant. Relative percent growth rate under droughted conditions was calculated for each plant in each treatment replicate using the equation:

$$\% Growth Rate = ( \frac{final height cm 3.5 weeks - initial height cm at 1.5 weeks}{initial height cm at 1.5 weeks} ) \times 100$$

Growth rate is reported in Table 35 as the relative growth rate and the percentage average change in growth rate normalized to the growth rate of the plants that received only the surfactant control treatment. Growth rate measurements are reported as the combined average of two trials with 14 replicate plants per trial.

TABLE 35
Foliar treatment with betaine-HCl and L-proline to
influence growth rate in corn under droughted conditions

| | | Change (%) in |
|---|---|---|
| | Relative Growth Rate | Relative |
| Treatment | (%) | Growth Rate* |
| Surfactant Control (0.10%) | 35% | — |
| Composition 12 | 36% | +1% |
| Composition 13 | 39% | +4% |
| Composition 14 | 39% | +4% |
| Composition 15 | 37% | +6% |
| Composition 4 | 40% | +14% |

*Normalized to surfactant control

As shown in Table 35, foliar treatments (compositions 12-15) containing varying concentrations of betaine-HCl (83.49 mM or 300 mM) and L-proline (100 mM or 163.88 mM) provided in a formulation with an anti-desiccant (tribasic potassium phosphate) and an anti-respirant (ALLIGARE SURFACE™) exhibited increased relative growth rates under droughted conditions compared to plants that received the treatment with the surfactant (control). The high betaine HCl (300 mM) with L-proline (163.88 mM) treatment (composition 13) applied to corn plants was comparable to the betaine-HCL (83.49 mM) and L-proline (163.88 mM) treatment (composition 14) that also contained sucrose (10 μM) and EDTA (5 μM) and resulted in a +4% increase in the relative growth rate compared to the plants that received the surfactant-only control. Composition 15 had the same concentrations of betaine-HCl (83.49 mM) and L-proline (163.88 mM) to composition 14 but did not contain sucrose and EDTA, and provided a +6% increased relative growth rate in plants as compared to the plants treated with the surfactant-only control. The greatest increase in relative growth rate was observed for plants that received the betaine-HCl (83.49 mM) foliar treatment (composition 4) which resulted in an increased growth rate of +14% as compared to the plants that received the surfactant-only control.

Plant recovery from droughted conditions was also determined in corn treated with osmoprotectants (betaine-HCl and L-proline) provided in combination with an anti-desiccant (potassium salt) and an anti-respirant (surfactant). Corn (Beck's hybrid 5828 YH) plants were planted in an environmentally controlled growth facility and grown using the conditions as described above in the first paragraph of this example. Foliar treatments containing a combination of betaine-HCl, and L-proline (compositions 3 and 12-18 of Example 1), betaine-HCL as the only osmoprotectant (composition 4 of Example 1), or L-proline as the only osmoprotectant (composition 5 of Example 1) and an anti-desiccant (potassium salt) and an anti-respirant (surfactant) were applied to corn plants. The foliar treatments were applied to corn plants at 1.5 weeks post-emergence and plants were examined for recovery or survival following conditions of drought stress (Table 36). Control plants were treated with a water only control spray treatment. Each foliar treatment was randomized using a randomized block design within each treatment replicate, which included two trials with 14 replicate plants per trial for each of the foliar applied treatments. After the foliar treatments were applied, the plants were returned to the controlled growth facility and were left un-watered for a period of two weeks to induce and simulate droughted conditions. At the end of the two-week drought period, the plants were watered (50 mL water per pot after 48, 72 and 144 hours) during the recovery period. Plants were returned to the controlled growth environment and plant recovery was recorded after 48, 72 and 144 hours after the initial re-watering. Plant recovery is reported in Table 36 as the average of the number of live plants remaining compared to the total plants at 1.5 weeks (prior to the initiation of the drought treatment). Additionally, plant recovery is reported in Table 36 as the percentage of total plants that recovered for each treatment after 48, 72 and 144 hours after the soil was re-hydrated. The average number of plants and the percentage of total plants that recovered for each treatment are reported in Table 36. Foliar treatments were applied at 3.2 Fl. oz/Ac (234 mL/hectare) application rate.

TABLE 36
Foliar treatments with betaine-HCl and L-proline: growth
recovery in corn following drought-induced stress

| | Number (%) | Number (%) | Number (%) |
|---|---|---|---|
| | Plants Recovered | Plants Recovered | Plants Recovered |
| Treatment | after 48 hours | after 72 hours | after 144 hours |
| Water Control | 4 (11%) | 6 (16%) | 9 (24%) |
| Composition 12 | 16 (42%) | 22 (58%) | 25 (66%) |
| Composition 16 | 7 (20%) | 12 (34%) | 17 (49%) |
| Composition 13 | 20 (53%) | 24 (63%) | 25 (66%) |
| Composition 17 | 12 (31%) | 18 (46%) | 17 (44%) |
| Composition 14 | 13 (33%) | 19 (48%) | 23 (58%) |
| Composition 3 | 7 (18%) | 13 (34%) | 12 (32%) |
| Composition 15 | 9 (25%) | 11 (28%) | 11 (28%) |
| Composition 18 | 5 (14%) | 6 (17%) | 7 (19%) |
| Composition 5 | 4 (11%) | 9 (24%) | 12 (32%) |
| Composition 4 | 6 (16%) | 14 (37%) | 19 (50%) |

As shown in Table 36, the foliar treatment (composition 13) having a betaine-HCl concentration of 300 mM and a L-proline concentration of 163.88 mM and further containing 57 mM tribasic potassium phosphate as an anti-desiccant and ALLIGARE SURFACE™ as an anti-respirant resulted in the highest number of live plants at 48 and 72 hours after re-watering (during the recovery period), averaging 53% and 63% plant recovery, respectively. The foliar treatment (composition 12) containing betaine-HCl (83.49 mM) and L-proline (163.88 mM) and a higher concentration of anti-desiccant (155 μM tribasic potassium phosphate) and ALLIGARE SURFACE™ anti-respirant resulted in a comparable percentage of plants that recovered after 144 hours as compared to the plants treated with composition 13, averaging 66% recovery for both treatments. Addition of other stabilization agents, such as sucrose and EDTA to formulations containing betaine-HCl and L-proline (composition 14) also resulted in an increased plant recovery after exposure to droughted conditions, resulting in an average of 58% of the total plants recovering after a period of 144 hours.

A betaine-HCl composition (composition 19 of Example 1) was compared to alternative osmoprotectants stachydrine (L-proline-betaine) and the sugar alcohol myo-inositol applied as foliar treatments in order to compare plant growth rates in corn grown under droughted conditions. Stachydrine was selected as an osmoprotectant that acts as a negative control due to its functional role in the induction of nodulation (Phillips, D. A., Joseph, C. M., Maxwell, C. A., “Trigonelle and stachydrine released from alfalfa seeds activate NodD2 protein in Rhizobium meliloti” (1992) Plant Physiology 99: 1526-1531). Stachydrine acts through a different mode of action as compared to the betaine-HCl osmoprotectant.

Plant growth rates under droughted conditions were compared in corn treated with foliar applications comprising betaine-HCl, stachydrine or myo-inositol (see Table 37). Corn (Beck's hybrid 5828 YH) plants were planted in an environmentally controlled growth facility and grown using the conditions described in the first paragraph of this example. At 1.5 weeks, the plants were provided with another 50 mL of water per pot and plant height was measured for each plant. Plants were then segregated to prevent any cross contamination between the foliar treatments. The plants then received a foliar-applied treatment with the formulations as described in Table 1 (Composition 19, Stachydrine Composition, or Stachydrine Control), a surfactant-only control (anti-respirant control A), or a composition containing 55 mM myo-inositol. The foliar treatments were applied using six uniform and equidistant sprays (30.5 cm above the top of the pot) and provided at an application use rate that would be equivalent to the fluid ounces per acre (Fl. oz/Ac) in a field as listed in Table 37. Each foliar treatment included two trials with 14 replicate plants per trial. The treated plants were then randomized using a randomized block design within each treatment replicate. Anti-respirant control A contained ALLIGARE SURFACE™ (Alligare LLC) applied at the same final concentration of 0.10% (v/v) (78.75 mM) as in the other compositions. After the foliar treatments were applied, the plants were returned to the same randomized locations in the growth facility and left un-watered to induce and simulate droughted conditions in a field for a period of two weeks. After plants remained for a period of two weeks under drought-induced conditions, a final plant height measurement was taken for each plant. Relative percent growth rate under droughted conditions was calculated for each plant in each treatment replicate using the percent (%) growth rate equation (as provided above in this Example). Results are provided in as averages in Table 37.

TABLE 37
Foliar treatments of alternative osmoprotectants and
anti-desiccants with anti-respirants to influence growth rate in corn

| | Relative Growth | |
|---|---|---|
| | Rate (%) | Change (%) |
| | under Droughted | in Relative |
| Treatment (Application Rate) | Conditions | Growth Rate^{b} |
| Anti-Respirant Control A (78.75 mM) | 29.0% | — |
| Stachydrine Control (234 mL/hectare) | 29.9% | +0.9% |
| Stachydrine Composition (234 | 29.9% | +0.9% |
| mL/hectare) | | |
| Myo-inositol (55.5 mM)^{a} | 31.1% | +2.1% |
| (467.7 mL/hectare) | | |
| Composition 19 (234 mL/hectare) | 35.8% | +6.8% |

^{a}Composition also included preservative (0.5% (v/v) (6.4 mM) PROXEL BD 20)
^{b}Normalized to Surfactant Control

Formulations that included stachydrine applied either with (Stachydrine Composition) or without (Stachydrine Control) an anti-desiccant and anti-respirant to corn plants grown under water deficit conditions resulted in plants that had only a slight+0.9% increase in percentage growth rate compared to plants that received the surfactant only application. The foliar applied betaine-HCl (composition 19) formulation applied to corn plants grown under droughted conditions resulted in plants with increased growth rates (+6.8% increase) compared to the growth rates of plants that received a foliar application of the surfactant-only control. The more pronounced increase in percentage growth rate was of plants that received the betaine-HCl (composition 19) foliar application compared to plants that received either of the stachydrine treatments. Foliar application with myo-inositol also resulted in an enhanced growth rate (+2.1% as compared to plants that received the surfactant-only control). Combinations of betaine-HCl formulations (e.g., composition 19) with myo-inositol may result in additional increases in percent growth rate in corn plants.

### Example 32: Application to V4-V7 Corn—Increased Yield

Large acre corn trials were planted from corn seed (DEKALB hybrids: DKC 58-89; DKC 52-61 and DKC 65-81) coated with a seed treatment comprising EVERGOL® fungicide combined with PONCHO®/VOTIVO® 500. Agricultural compositions comprising an agriculturally effective amount of betaine-HCl, L-proline, or combinations thereof were provided in combination with an anti-desiccant (potassium salt) and an anti-respirant (surfactant) to corn. Field seed beds at each location were prepared using conventional or conservation tillage methods for corn plantings. Fertilizer was applied as recommended by conventional farming practices which remained consistent between the US Midwest locations. Herbicides were applied for weed control and supplemented with cultivation when necessary. Four-row plots, 17.5 feet long (5.3 meters) were planted at all locations. Corn seed was planted 1.5 to 2 inches deep (approximately 5 cm) to ensure normal root development. Corn was planted at an average of approximately 42,000 plants per acre with row widths of 30-inch rows (on average 0.8 meters) and seed spacing of 1.6 to 1.8 seeds per foot (30 cm).

Corn plants at approximately the V5 stage of development received foliar applications using agricultural compositions containing an osmoprotectant, an anti-desiccant and an anti-respirant. Foliar compositions comprising betaine-HCl (compositions 4 and 19 of Example 1), varying amounts of an anti-desiccant (tribasic potassium phosphate), and different surfactants (anti-respirants) were applied to three corn hybrids (DEKALB hybrids: hybrid 1: DKC 52-61; hybrid 2: DKC 58-89; hybrid 3: DKC 65-81) planted in seven locations throughout the US Midwest (IN, IL, & IA). The average change in corn yield (Bu/Ac) was collected across the seven locations and is reported in Table 38 as the change compared to the non-foliar corn or base seed treatment control. The surfactant-only control (ALLIGARE 90, alkyl polyoxyethylene) was applied at 0.10%. The treatment compositions were applied at 3.2 Fl. oz/Ac (234 mL/hectare).

TABLE 38
Foliar treatment with betaine-HCl with varying
amounts of anti-desiccant and different anti-respirants

| Treatment | Average Change in Bu/Ac |
|---|---|
| Base Seed Treatment (Control) | — |
| Surfactant control | +1.12 |
| Composition 4 | +5.32 |
| Composition 19 | +1.94 |

The two betaine-HCl foliar treatments contained the same concentrations of betaine-HCl (83.49 mM) and surfactant (applied at a final concentration of 0.10%) but differed in the type of surfactant (composition 4 contained ALLIGARE SURFACE™ (alkyl and alkyl lauryl polyoxyethylene glycol) and composition 19 contained ALLIGARE 90 (alkyl polyoxyethylene)). The compositions also differed in the concentration of anti-desiccant tribasic potassium phosphate, with composition 4 containing 57 μM tribasic potassium phosphate and composition 19 containing 155 μM tribasic potassium phosphate. As shown in Table 38, composition 4 applied as a foliar treatment resulted in increased average yield for the three corn hybrids of +5.32 Bu/Ac (333.9 kg/hectare), whereas composition 19 resulted in a yield gain of +1.94 Bu/Ac (121.8 kg/hectare) over the control corn seed treatment.

In a separate experiment, corn plants consisting of three different hybrids (DEKALB: DKC 52-61; DKC 58-89; DKC 65-81) at approximately the V5 stage of development received foliar applications of ROUNDUP POWERMAX® (active ingredient potassium glyphosate, 48.7%; application rate: 24 Fl. oz/Ac (1754 mL/hectare)) combined with osmoprotectant treatments of compositions 9 and 19 of Example 1 at application rates of 3.2 Fl. oz/Ac (234 mL/hectare). Foliar treatment combinations of ROUNDUP POWERMAX with compositions 9 and 19 were tested in seven locations throughout the US Midwest (IN, IL, & IA). Corn yield (Bu/Ac) was collected and is reported in Table 39 as the average change in yield (Bu/Ac) across all the locations compared to the non-foliar treated corn control (base seed treatment control).

TABLE 39
Corn yield - foliar applications of an osmoprotectant
combined with an herbicide

| Treatment | Avg. Δ in Yield (Bu/Ac) |
|---|---|
| Base Seed Treatment (Control) | — |
| ROUNDUP POWERMAX ® | −0.76 |
| ROUNDUP POWERMAX ® + | +1.23 |
| Composition 9 | |
| ROUNDUP POWERMAX ® + | +2.65 |
| Composition 19 | |

The base seed treatment (control) was EVERGOL® fungicide+PONCHO®/VOTIVO® 500. All of the foliar treatments as described in Table 39 received the same seed treatment prior to planting as described for the seed treatment control.

As shown in Table 39, foliar application to corn using ROUNDUP POWERMAX® combined with osmoprotectant treatments containing betaine-HCl and L-proline (composition 9) or betaine HCl as the only osmoprotectant (composition 19) resulted in a yield advantage as compared to corn plants that received no foliar application and were grown from seed treated only with the base seed TREATMENT EVERGOL®+PONCHO VOTIVO 500 (Base Seed Treatment) or as compared to corn grown from seed treated with the Base Seed Treatment and subsequently treated foliarly with the ROUNDUP POWERMAX® herbicide (−0.76 Bu/Ac yield compared to control). Foliar application of ROUNDUP POWERMAX® combined with either the betaine-HCl and L-proline (composition 9) or betaine-HCl (composition 19) formulations resulted in positive yield gains of +1.23 Bu/Ac (composition 10) and +2.65 Bu/Ac (composition 19), respectively, over the yield of the seed treatment control plants.

In another experiment, foliar formulations containing anti-respirants (various surfactants) applied in combinations with betaine-HCl as an osmoprotectant and a fixed amount of anti-desiccant (155 μM tribasic potassium phosphate) were compared for effects on yield when applied to corn plants at the V5 stage of development on yield (Bu/Ac). Foliar betaine-HCl treatments (compositions 19-21 of Example 1) were applied to two corn hybrids (DEKALB: DKC 52-61 and DKC 58-89) across seven locations in the US Midwest (IN, IL, amd IA) using an application rate of 3.2 Fl. oz/Ac (234 mL/hectare). These foliar treatments had consistent betaine-HCl (83.49 mM) and anti-desiccant (155 μM tribasic potassium phosphate) concentrations but differed in the compositions of the anti-respirant (surfactants: ALLIGARE SURFACE™ (alkyl and alkyl lauryl polyoxyethylene glycol), ALLIGARE 90 (alkyl polyoxyethylene), AQUA SUPREME (alkyl polyoxyethoxylate ether)) that were included in the formulations. Yield (Bu/Ac) is reported in Table 40 as a yield per hybrid average across the seven locations combined and as an average change in yield (Bu/Ac) that is combined for both hybrids compared to yield obtained from corn grown with the base seed treatment (Table 40). The base seed treatment (control) was EVERGOL® fungicide+PONCHO®/VOTIVO® 500.

TABLE 40
Corn yield - foliar applications of osmoprotectant betaine-HCl
combined with varying surfactants (anti-respirants)

| | Avg. Yield | Avg. Yield | |
|---|---|---|---|
| | (Bu/Ac) Hybrid 1 | (Bu/Ac) Hybrid 2 | Avg. Δ |
| Treatment | DKC 52-61 | DKC 58-89 | in Bu/Ac |
| Base Seed | 198.1 | 205.3 | — |
| Treatment | | | |
| Composition 20 | 204.7 | 208.8 | +5.05 |
| Composition 19 | 201.9 | 206.2 | +2.35 |
| Composition 21 | 207.7 | 210.8 | +7.55 |

As shown in Table 40, foliar treatment formulations of composition 19 (ALLIGARE 90), composition 20 (ALLIGARE SURFACE™), and composition 21 (AQUA SUPREME) applied to corn at approximately the V5 stage of development had positive impacts on overall yield reported for both hybrids compared to the seed treatment control plants. Yield increases on average with foliar treatment application of composition 19 resulted in a +2.4 Bu/Ac yield increase, composition 20 resulted in a +5.1 Bu/Ac (320 kg/hectare) yield increase, and composition 21 resulted in a +7.6 Bu/Ac (477 kg/hectare) yield increase when applied as a foliar application on corn using a 3.2 Fl. oz/Ac (234 mL/hectare) application use rate. The composition 21 treatment containing the AQUA SUPREME surfactant and provided in a formulation with betaine-HCl and the anti-desiccant (potassium salt) resulted in the highest yield gains compared to the other two surfactant formulations tested.

### Example 33: Application to VT Corn—Increased Yield

Composition 9 of Example 1, a formulation that comprises two osmoprotectants (betaine-HCl and L-proline) combined with an anti-desiccant (tribasic potassium phosphate) and an anti-respirant (ALLIGARE 90 surfactant (alkyl polyoxyethylene)) was applied foliarly at the VT stage of development to three hybrids of corn (DEKALB: DKC 58-89; DKC 52-61, DKC 65-81). Corn was planted in 40 foot (12.2 meters) rows in three US Midwest locations (MO, IL). Foliar treatments of composition 9 and an ALLIGARE 90 surfactant-only control (Anti-Respirant Control B of Example 1) were applied to each of the three hybrids planted across the three locations using a 3.2 Fl. oz/Ac (234 mL/hectare) use rate. Yield (Bu/Ac) is reported in Table 41 as the average yield for the three corn hybrids across three US Midwest locations and also as the average change in yield (Bu/Ac) for the composition 10 foliar treatments compared to the corn plants that received anti-respirant control B only.

TABLE 41
Yield—Foliar application of a combination of betaine-HCl
and L-proline to VT corn

| | | Avg. Δ in Yield |
|---|---|---|
| | | (Bu/Ac) Compared |
| Treatment | Avg. Yield (Bu/Ac) | to Control |
| Anti-respirant control B | 204.6 | — |
| Composition 9 | 216.8 | +12.2 |

As shown in Table 41, foliar application composition 9 comprising both betaine-HCl and L-proline with a tribasic potassium phosphate (anti-desiccant) and ALLIGARE 90 surfactant (anti-respirant) on VT corn resulted in a substantial increase in overall yield of +12.2 Bu/Ac (766 kg/hectare).

In a separate experiment, large acre field trials were conducted using one and two location trials in the US Midwest (IL) planted with three different corn hybrids (DEKALB: DKC 58-89; DKC 52-61; DKC 65-81). Results are shown in Table 42. Seed from each of the corn hybrids was coated with a seed treatment of EVERGOL® fungicide combined with PONCHO®/VOTIVO® 500. Foliar treatments comprising a non-ionic polyoxyethylene-polyoxypropylene block copolymer surfactant (PLURONIC F-68, an anti-respirant), a quaternary ammonium salt (choline chloride) and/or a di-hydrated salt (calcium chloride) were applied to corn plants at the V5 stage of development. The foliar treatments were applied using the final concentrations and application use rates as described in Table 42. Choline chloride was selected for its osmolyte-like properties. Choline chloride is a precursor of acetylcholine and is involved in the regulation of water resorption in plants. Choline chloride was tested as a foliar application treatment individually and in combination an anti-respirant (PLURONIC F 68 surfactant). Average yield in Bu/Ac was reported for two trials. Trial 1 was conducted at one location and trial 2 was conducted at two locations in the US Midwest (IL). Yield (Bu/Ac) is reported as the average yield across location(s) and as the average for all three hybrids except where indicated in Table 42 and as the average change in yield (Bu/Ac) compared to the yield from the seed treatment control plants. The Base Seed Treatment control plants received only the EVERGOL® fungicide+PONCHO®/VOTIVO® 500 seed treatment and not any foliar treatments.

TABLE 42
Foliar application of choline chloride osmoprotectant combined with
an anti-respirant and a di-hydrated salt increases yield in corn

| | | Avg. Yield | Avg. Yield | Avg. Δ |
|---|---|---|---|---|
| | Application | (Bu/Ac) | (Bu/Ac) | in Yield |
| Treatment | Concentration | Trial 1 | Trial 2 | (Bu/Ac) |
| Base Seed | — | 192.6 | 154.9 | — |
| Treatment | | | | |
| PLURONIC ® | 0.025% (v/v) | 194.2 | 157.9 | +2.3 |
| F-68 Surfactant | (30.42 μM) | | | |
| Choline Chloride | 1.3 mM | 207.3* | 157.2 | +8.5 |
| Calcium Chloride | 0.007% (w/v) | 201.4 | 169.6 | +11.8 |
| (dihydrate) | (476.2 μM) | | | |
| PLURONIC ® | 0.025% (v/v) | 217.0* | 160.8 | +15.15 |
| F-68 + | (30.42 μM) | | | |
| Calcium Chloride | 0.007% (w/v) | | | |
| (dihydrate) | (476.2 μM) | | | |
| PLURONIC ® | 0.025% (v/v) | 202.0 | 163.2 | +8.9 |
| F-68 + Choline | (30.42 μM) | | | |
| Chloride + | 1.3 mM | | | |
| Calcium Chloride | 0.007% (w/v) | | | |
| | (476.6 μM) | | | |

*Yield collected for two hybrids only

Foliar application of the PLURONIC® F-68 surfactant, choline chloride or calcium chloride applied separately to corn plants resulted in an overall increase in yield or in a yield benefit compared to the base seed treatment control plants. Corn plants that received the PLURONIC® F-68 surfactant foliar treatment had a +2.3 Bu/Ac (144 kg/hectare) yield increase, whereas treatment with choline chloride or calcium chloride resulted in a +8.5 Bu/Ac (533.5 kg/hectare) yield increase and a +11.8 Bu/Ac (740.6 kg/hectare) yield increase, respectively, when compared to the base seed treatment control plants. The yield increase of +2.3 Bu/Ac (144 kg/hectare) reported in corn with the PLURONIC F-68 surfactant and the yield increase of +11.8 Bu/Ac (740.6 kg/hectare) with the calcium chloride treatment was additive when the treatment was applied as a combined treatment. When applied as a combined treatment of PLURONIC F-68 surfactant plus calcium chloride, corn yield was increased by +15.15 Bu/Ac (951 kg/hectare) over the yield of base seed treatment control plants. Corn yield was increased by +8.5 Bu/Ac (533.5 kg/hectare) in plants that received the foliar treatment with choline chloride and the combination of choline chloride, calcium chloride, and PLURONIC® F-68 surfactant. The combined treatment resulted in only a +0.4 Bu/Ac over the yield from plants that received the choline chloride treatment. The PLURONIC® F-68 surfactant, calcium chloride, and choline chloride treatment resulted in a +8.9 Bu/Ac (558.6 kg/hectare) increase in yield compared to the yield from the base seed treatment control plants.

### Example 34: Application to V4-V6 Soybean—Increased Yield (Large Acre Yield Trials)

Large acre soybean trials were planted from soybean seed that received a seed treatment of EVERGOL® fungicide plus PONCHO®/VOTIVO® 500. Soybean seed was planted 1.5 to 2 inches deep (approximately 5 cm) to ensure normal root development. Soybean was planted in 12.5 feet (3.8 meter) plots with an average of 150,500 plants per acre, row widths of 30 inches (0.8 meters) and seed spacing of 7 to 8 seeds per foot (30 cm).

Agricultural compositions comprising agriculturally effective amounts of betaine-HCl or combinations of betaine-HCl and L-proline provided with an anti-desiccant (potassium salt) and an anti-respirant (surfactant) were applied to soybean. The betaine-HCl and L-proline treatments were applied as a foliar spray at a use rate of 3.2 fluid ounces per acre (Fl. oz/Ac) (234 mL/hectare) to soybean grown at six US Midwest locations (IN, IA and IL). The soybean plants received foliar treatments containing betaine-HCl or combinations of betaine-HCl and L-proline (compositions 4, 7, 9, and 19 of Example 1) at approximately the V4-V6 stage of development. Soybean yield was collected for plants receiving the osmoprotectant compositions for each of three soybean varieties (Asgrow: AG2733, AG3536 and AG4034) across the six locations. Results are reported in Table 43 as the change in yield (Bu/Ac) compared to the control soybean plants that received the base seed treatment only with no foliar spray treatment. A surfactant-only control (anti-respirant control B of Example 1) was also used and was applied at an application rate of 0.10% (78.75 mM).

TABLE 43
Foliar treatment with compositions containing betaine
and proline increase yield in soybean

| Treatment | Avg. Δ in Yield (Bu/Ac) |
|---|---|
| Base Seed Treatment Control | — |
| Anti-Respirant Surfactant B | −1.24 |
| Composition 4 | +2.18 |
| Composition 9 | +2.94 |
| Composition 19 | +0.88 |
| Composition 7 | +0.50 |

Foliar application of betaine-HCl (composition 4) and betaine-HCl applied in combination with L-proline (composition 9) provided in formulations with an anti-desiccant (potassium phosphate tribasic) and an anti-respirant (surfactant) to soybean plants resulted in positive yield gains. Foliar treatment with betaine-HCl (composition 4) formulation resulted in a yield increase of +2.18 Bu/Ac (146.6 kg/hectare) with a 64% win rate, whereas treatment with the betaine-HCl and L-proline (composition 9) formulation resulted in an average yield increase of +2.94 Bu/Ac (197.7 kg/hectare) with an 82% win rate as compared to soybean plants that received no foliar treatment (base seed treatment control). Slight increases in average soybean yield were also observed for soybeans that received foliar treatments with the other betaine-HCl (compositions 7 and 19) formulations.

In another experiment, large acre yield replicated trials of soybean (variety: Asgrow AG4034) were planted from seed treated with a base seed treatment package containing EVERGOL® fungicide and PONCHO®/VOTIVO® 500 in three locations in the US Midwest (IL). Foliar treatment applications using an alternative osmoprotectant (trehalose), anti-desiccant (potassium acetate), anti-respirant (SILWET L-77), or a combination of the trehalose and SILWET L-77 were applied to soybean plants at the R2 stage of development at the application use rates as described in Table 44 and plants were examined for treatment effects on yield. Trehalose is a non-reducing carbohydrate resistant to acid hydrolysis and stable in solution under high temperatures and acidic conditions. Trehalose was applied separately and in combination with a non-blended organosilicone surfactant (SILWET L-77) as a foliar spray application to soybean plants.

TABLE 44
Foliar applications of trehalose to soybean combined with an
anti-desiccant and an anti-respirant

| | Application Use | | Avg. Δ in |
|---|---|---|---|
| | Rate Fl. oz/Ac | Avg. Yield | Yield |
| Treatment | (mL/hectare) | (Bu/Ac) | (Bu/Ac) |
| Base Seed Treatment | — | 66.8 | — |
| (Control) | | | |
| SILWET L-77 | 3.2 Fl. oz/Ac | 66.6 | −0.23 |
| | (234 mL/hectare) | | |
| Trehalose | 6.4 Fl. oz/Ac | 68.3 | +1.49 |
| | (467.7 mL/hectare) | | |
| Potassium Acetate | 3.2 Fl. oz/Ac | 67.2 | +0.35 |
| | (234 mL/hectare) | | |
| SILWET L-77 + | 3.2 Fl. oz/Ac | 70.1 | +3.32 |
| Trehalose | (234 mL/hectare) | | |
| | 6.4 Fl. oz/Ac | | |
| | (467.7 mL/hectare) | | |

Final concentrations at application were as follows: SILWET L-77-86.94 M, Trehalose=10 mM and Potassium Acetate 234.4 mM.

Soybean plants grown from seed treated with the base seed treatment (control) yielded on average 66.8 Bu/Ac (4492.3 kg/hectare) across the three locations. The SILWET L-77 treatment alone resulted in a slightly reduced yield, an average −0.23 Bu/Ac (−15.5 kg/hectare) compared to yield obtained from the seed treatment-only control plants. Foliar application with trehalose alone applied to soybean plants using a 6.4 Fl. oz/Ac (467.7 mL/hectare) use rate provided a yield advantage of +1.49 Bu/Ac (100.2 kg/hectare) over the seed treatment control plants. Foliar treatment application of trehalose (6.4 Fl. oz/Ac) combined with the SILWET L-77 (3.2 Fl. oz/Ac or 234 mL/hectare) resulted in a +3.32 Bu/Ac (223.3 kg/hectare) over the control seed treatment plants (Table 44). The combined foliar treatment with trehalose and SILWET L-77 provided a synergistic effect on soybean yield as the increase of over 3 Bu/Ac (201.8 kg/hectare) was greater than the sum of the increases in yield when trehalose and SILWET L-77 were applied separately.

### Example 35: Application to R2 Soybean—Increased Yield (Large Acre Yield Trials)

Large acre yield trials were conducted using foliar applications of osmoprotectants (betaine-HCL and L-proline). The betaine-HCl and L-proline treatments (compositions 7, 8, 9, 19, and 22 of Example 1) were applied as foliar sprays at a use rate of 3.2 Fl. oz/Ac (234 mL/hectare) to three varieties of soybean (Asgrow: AG2733, AG3536 and AG4034) grown in 12 locations across the US Midwest (IA, IN, IL). For each foliar treatment in each location, soybean was planted in 12.5 feet (3.81 meters) plot rows with three replicates per treatment. The soybean plants received the foliar betaine-HCl and L-proline treatment applications at the R2 stage of development. Harvestable soybean yield is reported in Table 46 as the average yield (Bu/Ac) and the average change in yield (Bu/Ac) as compared to the surfactant-only control and is reported as an average across all locations for all three soybean varieties (Table 45) and individually for the three varieties compared to the surfactant control treatment for the corresponding soybean variety (Table 46). The surfactant control (anti-respirant control B of Example 1) was applied at 0.10% (78.75 mM).

TABLE 45
Soybean yield - foliar applications of different concentrations of
betaine-HCl and/or L-proline across 12 locations

| | Avg. Yield | Avg. Δ in |
|---|---|---|
| Treatment | (Bu/Ac) | Yield (Bu/Ac) |
| Base Seed Treatment | 64.5 | — |
| (Control) | | |
| Anti-Respirant Control B | 61.8 | −2.67 |
| Composition 4 | 65.2 | +0.63 |
| Composition 8 | 63.6 | +1.72 |
| Composition 9 | 64.3 | +2.49 |
| Composition 22 | 64.0 | +2.16 |
| Composition 19 | 63.3 | +1.42 |
| Composition 7 | 63.6 | +1.74 |

TABLE 46
Soybean yield—foliar applications of different concentrations of
betaine-HCl and L-proline for 3 soybean varieties

| | Avg. Yield in Bu/Ac (Avg. Δ in Yield in Bu/Ac) | | |
|---|---|---|---|
| Treatment | AG2733 | AG3536 | AG4034 |
| Anti-Respirant | 72.9 | 60.5 | 58.7 |
| Control B | (—) | (—) | (—) |
| Composition 8 | 73.7 | 62.2 | 60.6 |
| | (+1.44) | (+1.65) | (+1.98) |
| Composition 9 | 76.4 | 62.7 | 60.8 |
| | (+4.06) | (+2.18) | (+2.17) |
| Composition 22 | 77.6 | 61.2 | 61.5 |
| | (+5.28) | (+0.68) | (+2.83) |
| Composition 19 | 75.3 | 62.9 | 57.8 |
| | (+3.01) | (+2.43) | (−0.89) |
| Composition 7 | 73.5 | 62.2 | 60.8 |
| | (+1.17) | (+1.66) | (+2.13) |

Average yield (Bu/Ac) and average change in soybean yield (Bu/Ac) are reported for two locations for soybean variety AG2733, for six locations for soybean variety GG3536 and for 4 locations for soybean variety AG4034.

As shown in Table 46, overall, foliar treatments consisting of betaine-HCl as the only osmoprotectant (compositions 7, 8, and 19), betaine-HCl in combination with L-proline (composition 9), or L-proline as the only osmoprotectant (composition 22) provided a yield improvement for all three of the soybean varieties. The only exception was one of the betaine-HCl (composition 19) foliar treatments on soybean variety AG4034. However, the same betaine-HCl (composition 19) treatment did provide a yield increase for two of the varieties (AG2733: +3 Bu/Ac (201.8 kg/hectare), AG3536: +2.43 Bu/Ac (163.4 kg/hectare) as compared to plants that received anti-respirant control B only treatment. Soybean variety AG2733 was the highest yielding variety overall across locations tested (two US Midwest locations in IA) while soybean varieties AG3536 and AG4034 had comparable yields across the locations tested and were uniform based on the foliar treatment applied. The treatment with the highest betaine-HCl concentration (composition 8) and the betaine-HCl treatment supplemented with sucrose and EDTA (composition 7) provided the most consistent increases in yield across all three of the soybean varieties, ranging from +1.44 to +1.98 Bu/Ac (+96.8 to +133.2 kg/hectare for composition 8 and +1.17 to +2.13 Bu/Ac (+78.7 to +143.2 kg/hectare) for composition 7. Betaine-HCl combined with L-proline (composition 9) and high L-proline (composition 22) treatments had the highest respective yield increases on soybean variety AG2733 and resulted in respective +4.06 and +5.28 Bu/Ac increases in yield across the treatment trials compared to the yield of the soybean plants treated with the anti-respirant control B (Table 46).

In another study, foliar treatments with betaine-HCl (composition 4 of Example 1) and betaine-HCl with L-proline (composition 9 of Example 1) were applied to soybean (variety AG2733) planted at two separate locations in the US Midwest (IA) at the R2 stage of development. Each location had three replicates of 12.5-foot (3.81 meters) plots per each treatment. Harvestable yield was reported as the average yield (Bu/Ac) across the two locations. The average change in yield was compared to yield for plants grown from seed treated with the seed treatment alone (seed treatment control with no foliar treatment) at the two locations (Table 47). Foliar treatments were applied at 3.2 Fl. oz/Ac (234 mL per hectare). The base seed treatment was a combination of EVERGOL® fungicide and PONCHO®/VOTIVO® 500.

TABLE 47
Soybean yield—foliar applications using osmoprotectants,
betaine-HCl and L-proline

| | Avg. Yield | Avg. Δ in Yield |
|---|---|---|
| Treatment | (Bu/Ac) | (Bu/Ac) |
| Base Seed Treatment (Control) | 74.4 | _ |
| Composition 4 | 79.4 | +5.00 |
| Composition 9 | 75.5 | +1.10 |

Foliar treatment with betaine-HCl (composition 4) or a combination of betaine-HCl and L-proline (composition 9) applied to soybean plants (variety AG2733) at the R2 stage of development resulted in an increase in the average yield (Bu/Ac) compared to control plants that received the base seed treatment only. The betaine HCl (composition 4) treatment resulted in an increase of +5 Bu/Ac (+336.2 kg/hectare) while the combination treatment of betaine-HCl and L-proline resulted in a +1.1 Bu/Ac (+74 kg/hectare) increase over the plants grown from the seed treatment control (Table 47).

In a further study, large acre yield trials were conducted using betaine-HCl (composition 19 of Example 1) or betaine-HCl with L-proline (composition 9 of Example 1) treatments provided with a broad spectrum fungicide: STRATEGO®YLD (10.8% prothioconazole and 32.3% thiofloxystrobin). STRATEGO®YLD is a commercially available fungicide suitable for use as an early season foliar application for soybean at the R2 stage of development. The betaine-HCl with L-proline (composition 9) and betaine-HCl (composition 19) treatments were applied as foliar sprays at a use rate of 3.2 fluid ounces per acre (Fl. oz/Ac) (234 mL/hectare) and the STRATEGO®YLD fungicide was applied as a foliar spray at a use rate of 4.0 fluid ounces per acre (Fl. oz/Ac) (292 mL/hectare). The foliar treatments were applied to soybean (variety: Asgrow AG4034) grown at five US Midwest locations (IN, IA and IL). For each foliar treatment in each location, soybean was planted in 12.5-foot (3.81 m) plot rows with three replicates per treatment. Soybean yield was collected for plants receiving the osmoprotectant/fungicide treatments as described in Table 48. Soybean yield is reported in Table 48 as the average yield (Bu/Ac) for soybean variety AG4034 across the five locations and also as the change in yield (Bu/Ac) compared to soybean plants treated with only the STRATEGO®YLD fungicide application.

TABLE 48
Soybean yield with foliar applications of betaine-HCL and
L-proline osmoprotectants combined with a fungicide

| Treatment | Avg. Yield (Bu/Ac) | Avg. Δ in Yield (Bu/Ac) |
|---|---|---|
| STRATEGO ®YLD | 55.6 | — |
| STRATEGO ®YLD + | 56.0 | +0.40 |
| Composition 9 | | |
| STRATEGO ®YLD + | 57.7 | +2.10 |
| Composition 19 | | |

The base seed treatment (ST control) was EVERGOL® fungicide+PONCHO®/VOTIVO® 500. The STRATEGO®YLD fungicide was applied at the concentration and application use rate as recommended on the specimen label.

The STRATEGO®YLD fungicide provided in combination with betaine-HCl (composition 19) foliar treatment resulted in a yield gain for soybean across the five locations an overall average yield increase of +2.10 Bu/Ac (141.2 kg/hectare) as compared to the yield from plants that received the STRATEGO®YLD fungicide applied alone. The STRATEGO®YLD fungicide has been reported to provide an average yield increase of +3-4 Bu/Ac (+202-269 kg/hectare) in general for soybean. The STRATEGO®YLD fungicide combined with the betaine-HCl (composition 19) treatment and applied to early season soybean may provide a +5 Bu/Ac (+336.3 kg/hectare) or greater increase in yield over conventional planted (non-treated) soybeans.

### Example 36: Application to Spring-Planted Vegetables—Increased Yield

Plants were grown in raised beds covered with black plastic mulch using a row planting experimental design to simulate large scale commercial growing conditions for the individual vegetable crops. Plants were grown using drip irrigation and fertilizer application regimes following the recommended grower guidelines for the region throughout the growing season to provide an optimum environment for plant growth.

Beets (Beta vulgaris, variety: Red Ace F1) were grown from seed planted into lightly tilled sandy loam soil in raised row beds covered with black plastic mulch. Seeds were planted 1.5 inches (3.8 cm) deep and approximately 1 inch (2.5 cm) apart. Three weeks after germination, plants were thinned to one plant every five inches (12.5 cm), with an average of 100 plants per row bed. Sugar beets were planted in one location in the US Midwest (MO). A foliar spray treatment containing betaine-HCl (composition 7 of Example 1) was applied at an application use rate of 3.2 Fl. oz/Ac (234 mL/hectare) to the beet plants in the early vegetative stage, approximately 15 days post-emergence. Foliar treatment with the betaine-HCL (composition 7) during this phase was examined for effect on root growth during the storage period when most of the energy is first allocated to root growth. Harvestable yield in sugar beet was collected for the beet root weight per plant (in grams) and the above ground biomass per plant (in grams) for the treatments as described in Table 49. Plants received a foliar treatment containing betaine-HCl (composition 7), anti-respirant control B of Example 1, or a no spray control. Harvestable sugar beet yield for plants that received the foliar treatments for both the composition 7 treatment and the commercial standard (positive control) was compared to the yield from plants that received a surfactant-only treatment or no foliar treatment whatsoever (no spray control). Harvestable yield is reported in Table 49 for one final harvest at the end of the growing season (Spring to Summer, April to late August) as the average beet root weight per plant and the average above ground biomass per plant.

TABLE 49
Foliar treatment of sugar beets with betaine-HCl increases
harvest weight and above ground biomass

| | Avg. Beet Root | Avg. Above Ground |
|---|---|---|
| | Weight per | Biomass per |
| Treatment | Plant (g) | Plant (g) |
| Control (No Spray) | 49.7 | 894.1 |
| Anti-Respirant Control B | 49.6 | 892.9 |
| Composition 7 | 67.0 | 1138.9 |

The yield from the betaine-HCl (composition 7) treatment was compared to the yields from beet plants that received the no spray or the surfactant-only treatments, as well as to the yield obtained from plants treated with the commercial standard positive control. As shown in Table 49, foliar application using the betaine-HCl (composition 7) treatment provided to beet plants approximately 15 days post emergence resulted in an increase of +17.3 grams root weight per plant or a +35% increase in root weight per plant over the roots grown from plants that received the surfactant-only treatment or a no spray control. Beet plants that received the foliar treatment application with betaine-HCl (composition 7) also had a substantial increase in above ground biomass per plant, an average increase of approximately 245 grams as compared to plants that received the surfactant-only treatment or a no spray control. Thus, the foliar application with the betaine-HCl (composition 7) treatment provided to beets resulted in an average of a +27% increase in above ground biomass compared to the yield obtained from plants that received a surfactant only or a no spray control.

Foliar treatments containing betaine-HCl (compositions 8 and 19 of Example 1) or a combination of betaine-HCl and L-proline (composition 9 of Example 1) were applied on jalapeno pepper plants (Capsicum) at early bloom (first flower) stage. Peppers from 12-week-old transplants were planted in two raised bed rows covered in black plastic mulch containing soil with good water-holding characteristics and a pH of 5.8-6.6. The jalapeno peppers were planted using planting densities that simulate commercial growing conditions for peppers. Jalapeno pepper plants were spaced 14-16 inches (38 cm) apart with 16-24 inches (50 cm) between plants containing, providing approximately 25 plants per row bed. The betaine and proline foliar compositions were applied at an application use rate of 3.2 Fl. oz/Ac (234 mL/hectare). Control treatments included a foliar applied surfactant-only control (anti-respirant control B of Example 1). Effects of the foliar applications on pepper yield or the average number of jalapeno peppers per plant and the total above ground biomass per plant (grams) were determined for two separate harvests using a once-over harvest approach. The number of peppers and the above ground biomass per plant were each normalized to the yield or biomass of the pepper plants that received the foliar treatment with the surfactant only control (Table 50).

TABLE 50
Foliar treatment of jalapeno peppers with betaine-HCl and
L-proline increases harvest weight and above ground biomass

| | | | Above Ground Biomass | |
|---|---|---|---|---|
| | Avg. Number Peppers | | per Plant in grams | |
| | per Plant | | (% change over | |
| Treatment | (% change over control) | | control) | |
| Anti-Respirant | 10 | (—) | 123.7 | (—) |
| Control B | | | | |
| Composition 19 | 21 | (+110%) | 319.9 | (+159%) |
| Composition 8 | 13 | (+30%) | 185.7 | (+50%) |
| Composition 9 | 12 | (+20%) | 138.0 | (+12%) |

As shown in Table 50, the number of jalapeno peppers per plant highly correlated with the average biomass produced per plant in the pepper yield trials. The total number of peppers was plotted against total above ground biomass for each pepper plant and was found to be positively correlated with an R² value of 0.8994 (FIG. 10). Foliar treatment with the formulations containing betaine-HCl (composition 19: 83.49 mM; composition 8: 166.98 mM) applied at a 3.2 Fl. oz/Ac (234 mL/hectare) use rate at the early flower stage on jalapeno pepper plants resulted in the highest increases in yield compared to yield obtained from pepper plants treated with the surfactant-only control. Composition 19 resulted in more than a doubling of the yield of peppers, providing +110% more peppers and a substantial increase in above ground biomass per plant, an approximate +196 grams more biomass per plant (a +159% increase in biomass) compared to biomass obtained from plants that received treatment with the surfactant-only control. Composition 8 also resulted in a marked increase in the yield of peppers, providing +30% more peppers and a substantial increase in above ground biomass per plant (an approximate +62 grams more biomass per plant or a +50% increase in biomass) compared to the biomass obtained from plants that received treatment with the surfactant-only control.

### Example 37: Application to Lettuce—Increased Biomass

An osmoprotectant, L-proline (composition 5 of Example 1) was applied foliarly to lettuce at two distinct timings prior to harvest to examine the effect of the osmoprotectant on total harvestable biomass. Lettuce was grown in two locations in the US (MO, AZ). Ten lettuce seeds (variety: Buttercrunch Lettuce) per treatment were planted at a depth of one centimeter in sandy loam soil in raised row beds covered with black plastic mulch. Two replicate rows of 10 feet (approximately 3 meters) in length consisting of 18-inch (46 cm) row spacing between rows were planted for each treatment replicate, with a total of three replicate row beds per trial. Treatment replicates were segregated from the non-spray control planting using a randomized complete block design. Drip irrigation was provided to saturate the soil for proper germination of seeds. Three weeks after germination, plants were thinned to one plant every five inches (12.5 cm), an average of approximately 24 plants per row bed. Plants were watered by drip irrigation. Lettuce plants received a foliar treatment with L-proline (composition 5) at two separate time points during the growing season-10 days after emergence and 10 days before harvest-using a 3.2 Fl. oz/Ac (234 mL/hectare) application use rate. Total above ground biomass was harvested on the lettuce plants at these two time-points and total biomass per replicated plot was compared to the biomass harvested from the no spray control plants. Biomass for the lettuce plants that were treated with L-proline (composition 5) is reported as the percentage change in biomass compared to the no spray control plants in Table 51.

TABLE 51
Foliar application with L-proline increased biomass in lettuce

| Treatment | % Change in Yield Biomass |
|---|---|
| No Spray Control | — |
| Composition 5 | −0.5% |
| Applied 10 days after emergence | |
| Composition 5 | +8.5% |
| Applied 10 days before harvest | |

Foliar application of L-proline (composition 5) applied to lettuce plants 10 days prior to harvest resulted in plants that had increased biomass at the time of harvest, an average of +8.5% more biomass as compared to the no spray control lettuce plants.

### Example 38: Application to Cotton—Increased Yield

American upland cotton (Gossypium hirsutum, variety CG 3885B2XF) was grown in four US locations (three in LA and one in TX) planted in plots of 13.33×40 feet (4.06×12.19 meters) rows with 40 inch (101.6 cm) spacing between the rows. Each plot was planted using 4.5 seeds/ft (30.48 cm). Standard herbicide and fertilizer application regimes were followed as recommended per each region. Betaine-HCl (composition 4 of Example 1) and betaine-HCl and L-proline (composition 9 of Example 1) treatment formulations were applied using a 3.2 Fl. oz/Ac (234 mL/hectare) application use rate at the first bloom stage (approximately 55 days post-emergence). Each foliar treatment and the no treatment control were replicated four times using a randomized complete block design. The cotton fibers (lint) were collected at harvest and reported as the average kilograms of lint per hectare. The average change in lint per acre was compared to the lint per acre collected for the control plants. Results provided listed in Table 52.

TABLE 52
Foliar treatment to cotton with betaine-HCl and L-proline
osmoprotectants result in increased lint weight per acre

| | Avg. weight lint | Δ avg. weight lint |
|---|---|---|
| Treatment | (kg/hectare) | (kg/hectare) |
| No Spray Control | 1043.17 | — |
| Composition 4 | 1044.86 | +1.68 |
| Composition 9 | 1080.18 | +37.00 |

Cotton plants that received the foliar treatment of betaine-HCl (composition 4) had slightly higher lint yields—on average of +1.7 more kg of lint per hectare—over the lint weights compared non-treated control plants. The combined treatment of betaine-HCl with L-proline (composition 9) resulted in substantially higher amounts of cotton lint per acre and yielded on average an increase of approximately +37 more kg of lint per hectare as compared to the non-treated control plants.

### Example 39: Application of Betaine-HCl and L-Proline Osmoprotectants to Alfalfa—Increased Yield

Foliar applications of betaine-HCl and L-proline osmoprotectants (composition 3 of Example 1) were examined for effects on total biomass (harvestable bales) and crude protein content of hay. Alfalfa (Medicago sativa L.) plants had been established the previous year and were grown in three acre plots in three separate trials in the US (CA). Twenty alfalfa plants were planted per square foot and provided a recommended plant stand for field testing. Each three-acre plot received either a foliar treatment or a no spray control treatment, which was replicated three times. Alfalfa plants per each plot were harvested at three separate times (received three separate cuttings throughout the growing season, Spring-Summer 2017). Recommended practices for fertilizer use and weed management were followed for the particular region and irrigation was provided on a 28-day cycle with a cutting of the alfalfa (for hay) following on the end of the 28th day. Fertilizer (SUPERPHOS, a high phosphate fertilizer containing calcium dihydrogen phosphate and monocalcium phosphate [Ca(H₂PO₄)₂·H₂O) was applied at 19-23 liters per acre or 47 to 57 liters per hectare with flood irrigation. Foliar treatment comprising a combination of betaine-HCl and L-proline (composition 3) was provided two weeks prior to the first cutting at an application use rate of 3.2 Fl. oz/Ac (234 mL/hectare) and assessed using an average bale count and average percent crude protein in the harvested hay as compared to the no spray control alfalfa plots. Crude protein was measured using a Hach Kjeldahl method from samples taken from five random bales for each of three replicate harvests per plot (Rossi, A. M., et al., 2004, “Nitrogen contents in food: a comparison between the Kjeldahl and Hach methods,” The Journal of the Argentine Chemical Society 92: 99-108). Results are provided in Table 53.

TABLE 53
Foliar treatment of alfalfa increased bale count and
percent crude protein

| Treatment | Avg. Bale Count per plot | Avg. % Crude Protein |
|---|---|---|
| No Spray Control | 84.5 | 20.66% |
| Composition 3 | 92.0 | 24.28% |

Foliar treatment with a combination of the betaine-HCl and L-proline (composition 3) osmoprotectants resulted in an increased number of bales for three harvests performed throughout the growing season, more than +7 bale increase for the osmoprotectant treated plots compared to the non-treated control plots. Crude protein as measured based on nitrogen concentration of the harvested alfalfa hay was also substantially increased in the plants that received the betaine-HCl and L-proline (composition 3) foliar treatment combination, an increase of nearly 4% protein. This increase in crude protein as reported for the composition 4 treated plants shifted the hay classification from the “good” for the non-treated control plants to the “premium” quality alfalfa hay (composition 3-treated plants).

“Good” classification is described as early to average maturity, early- to mid-bloom, leafy, fine- to medium-stemmed, and free of damage other than slight discoloration. “Premium” classification is described as early maturity, prebloom, fine-stemmed, extra leafy (factors indicative of a high nutritive content), green, and free of damage. Crude protein for “good” alfalfa is 18 to 20. Crude protein for “premium” alfalfa is 20 to 22.

### Example 40: Increased Growth in Corn for Early Seedling Establishment Under Conditions of Drought

Rapid initial growth at phenological stages up to V3, specifically between V2 and V3 stages, for early seedling establishment was examined in corn treated with various combinations of an osmoprotectant (betaine-HCl), an anti-respirant (40.3% alkyl polyglucoside esters) and an anti-desiccant (glycerol) applied as a drench to the soil at the time of planting. The anti-respirant also functioned as an infiltration surfactant (above-soil surfactant or penetrant) and the anti-desiccant functioned as a humectant. Growth of corn plants as determined by changes in plant height (cm) up to the V3 stage of development was examined using the treatments described in Tables 54 and 55. A combined treatment with betaine-HCl (osmoprotectant), an infiltration surfactant (anti-respirant) and a humectant (anti-desiccant) was also compared with other drench treatments and a water-only control. Glycerol, a polyol compound that has three hydroxyl groups that are responsible for its solubility in water and its hydroscopic nature, was selected as a viscous humectant to combine with the betaine-HCl osmoprotectant and the infiltration surfactant. This triple treatment combination was selected based on its mode of action properties in soil drench applications that promote the retention and management of moisture by attracting moisture and condensing it for contact to the germinating seed and/or growing plant.

The treatment combination was provided as a soil drench at the time of planting and again at emergence to promote rapid growth at the early V stages of development, enhance early vigor, provide for a robust stand establishment, and protect against the effects of drought during early seedling establishment. The betaine-HCl osmoprotectant was provided at a final application concentration of 83.49 mM. The infiltration surfactant was diluted in water at the recommended application use rate using a ratio of 1:1600 (surfactant to water) (52.9 μM). The humectant was provided at a final application treatment of 1% diluted in water (136.8 mM). The individual and combined treatments were provided using the application use rates (Fl. oz/Ac) as specified in Tables 54 and 55. The betaine-HCl and the humectant application use rates for the soil drench were 1,000 times greater than the application use rate of the anti-respirant in Table 54. In Table 55, the application use rates for all three components were the same.

Corn seed (Beck's hybrid 5828 YH) was planted directly into 39.7 cm³ pots containing a planting mix of 2:1 topsoil to course paver sand to create the desired mixture for a sandy loam soil consisting of 1.5% organic matter, 70% sand, 17.5% silk, and 12.5% clay with a soil pH of 7.5. Seeds were planted at a depth of 2.54 cm, with two seeds per pot. After planting, seeds were supplied with 50 mL of the each of the treatments (as described in Tables 54 and 55) at room temperature and added to the soil in each pot as a soil drench provided at an equivalent application use rate as specified. Each drench treatment was supplied to 48 seeds total (24 planted pots) placed in a growth room under conditions consisting of a 13/11 light/day cycle using fluorescent lighting providing approximately 200-300 mol m⁻² s⁻¹ (light photons) and temperatures of 21° C. day/15° C. night. At day 3 (three days after planting, DAP), when all of the seeds had germinated, 50 mL soil drench of each of the treatments was applied to the seedlings. After application of the second drench, the plants were left un-watered to induce and simulate droughted conditions that may occur during early seedling establishment. Plant height (cm) was measured at 11 days for each plant grown under the drought-induced conditions (from 3 to 11 DAP). At 11 days after planting, plant height was determined for each plant in the various treatments. Corn plants provided with treatments as described in Table 55 received an additional 50 mL of water at 11 days after planting. Plant height was re-measured at the end of the 14th day (14 days after planting). A comparison of plant growth that occurs during the transition from V2-V3 stage is reported in Table 55.

TABLE 54
Soil drench treatments using a osmoprotectant, a surfactant and a
humectant to promote growth of corn seedlings under droughted
conditions

| | | | Plant | % Δ in |
|---|---|---|---|---|
| | | Soil Drench Final | Height | Plant |
| | | Concentration | (cm) | Height |
| | | (Application Use | Measured | Compared |
| Treatment | | Rate (mL per | at | to |
| Composition | Components | hectare) | 11 DAP | Control |
| Water-Only | — | — | 9.06 | — |
| Control | | | | |
| Surfactant- | Alkyl | 1:1600 | 8.98 | −1% |
| Only | polyglucoside | (438.5 mL/hectare) | | |
| Control | esters | | | |
| Composition | Betaine-HCl | 83.49 mM | 9.52 | +5% |
| 37 | | (455,000 mL/hectare) | | |
| | Glycerol | 1% | | |
| | | (455,000 mL/hectare) | | |
| Composition | Betaine-HCl | 83.49 mM | 10.96 | +21% |
| 38 | | (455,000 mL/hectare) | | |
| | Alkyl | 1:1600 | | |
| | polyglucoside | (438.5 mL/hectare) | | |
| | ester | | | |
| | Glycerol | 1% | | |
| | | (438.5 mL/hectare) | | |

Plant height (cm) was determined as a measure of plant growth. The average change in plant height is reported in Table 54 as a percentage change in plant height compared to the height of plants that were grown in soil that received a water-only treatment control. Application of the surfactant-only control resulted in corn plants that had on average a slight decrease in plant height (−1%) as compared to the plants grown in soil that received the water-only control drench treatment. The osmoprotectant (betaine-HCl) and humectant (glycerol) combination treatment (composition 37) provided a rapid increase in early seedling plant growth as shown in plants at 11 days after planting, a +5% increase compared to plants grown in soil that received the water-only control drench treatment. Corn seeds planted in soil that had been treated with a humectant (glycerol) were able to germinate more rapidly and then establish and develop due to favorable moisture conditions in the soil. The osmoprotectant, surfactant and humectant treatment (composition 38) resulted in plants that had the greatest increase in growth in the early V stages. Composition 38 resulted in plants that had an average of a +21% increase in plant height as compared to plants grown from soil that received the water-only control drench treatment. This large increase in growth of corn plants at the early V stages suggests a synergistic effect for the triple combination treatment (composition 38) over the treatment containing only betaine-HCl and glycerol (composition 37).

TABLE 55
Soil drench treatments using a osmoprotectant, a surfactant and a
humectant to promote growth during the V2-V3 transition of corn
seedlings under droughted conditions

| | | | Plant | |
|---|---|---|---|---|
| | | | Growth | |
| | | | during | |
| | | | the | |
| | | | transition | |
| | | | of | % Δ |
| | | Soil | V2-V3 | in Plant |
| | | Drench | stage | Height |
| | | Application | (11 DAP | Compared |
| | | Use Rate | to | to |
| Composition | Components | mL/hectare | 14 DAP) | Control |
| Water-Only | — | — | 2.89 | — |
| Control | | | | |
| Surfactant- | Alkyl | 1:1600 | 2.82 | −2% |
| Only Control | polyglucoside | (438.5 mL/ | | |
| | ester | hectare) | | |
| Humectant- | Glycerol | 1% | 2.98 | +3% |
| Only Control | | (438.5 mL/ | | |
| | | hectare) | | |
| Osmoprotectant- | Betaine-HCl | 83.49 mM | 3.11 | +8% |
| Only Control | | (438.5 mL/ | | |
| | | hectare) | | |
| Composition | Betaine-HCl | 83.49 mM | 3.15 | +9% |
| 38 | | (438.5 mL/ | | |
| | | hectare) | | |
| | Alkyl | 1:1600 | | |
| | polyglucoside | (438.5 mL/ | | |
| | esters | hectare) | | |
| | Glycerol | 1% | | |
| | | (438.5 mL/ | | |
| | | hectare) | | |

*The surfactant, humectant (glycerol) and the osmoprotectant (betaine-HCl) soil drench treatments were applied using an equivalent of 6 fluid ounces per acre (Fl. oz/Ac), an equivalent of 177.44 mL per acre or 438.45 mL per hectare.

Soil drench application of the osmoprotectant (betaine-HCl) provided in combination with and infiltration surfactant (alkyl polyglucoside ester) and a humectant (glycerol) was compared to osmoprotectant-only, surfactant-only, and humectant-only treatments applied as described in Table 55. The infiltration surfactant applied as soil drench to corn seed and again three days after planting resulted in corn plants that had on average a −2% decrease in plant height, or a lesser growth during the transition from the V2 to the V3 stage of development, as compared to the plants grown from soil that received the water-only control drench treatment. The humectant-only control resulted in corn plants that had an increase of +3% in plant height, or growth at the during the early seedling stage or between the transition stage from V2 to V3, compared to plants grown from soil that received a water-only treatment only. Plants grown from soil drenched with the osmoprotectant-only control exhibited on average a +8% increase in plant height in the transition stage from V2 to V3 as compared plants grown in the water-only control treated soil. Composition 38, containing the osmoprotectant, the irrigation surfactant, and the humectant, resulted in plants that had the greatest growth during the transition between the V2 to V3 growth stages and resulted in plants that had on average a+9% increase in plant height during this period as compared to plants grown from soil that received the water-only control treatment. The water-capturing capability of glycerol used as a humectant and provided in combination with betaine-HCl in the presence of an irrigation surfactant allowed the corn seedlings to establish more quickly with increased growth during early vegetative development.

When introducing elements of the present invention or the preferred embodiments(s) thereof, the articles “a” “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above compositions and methods without departing from the scope of the invention, it is intended that all matter contained in the above description and shown in the accompanying drawings shall be interpreted as illustrative and not in a limiting sense.

1-126. (canceled)

127. An agricultural composition comprising an osmoprotectant and an anti-desiccant, wherein:
the osmoprotectant comprises betaine; and
the anti-desiccant comprises a potassium salt selected from the group consisting of potassium phosphate monobasic, potassium phosphate dibasic, potassium phosphate tribasic, potassium acetate, potassium chloride, potassium nitrate, potassium sulfate, dipotassium phosphate, potassium ammonium phosphate, potassium bicarbonate, or a combination of any thereof, wherein when the composition is formulated as: a) a ready to use composition, betaine is present in a concentration of from 0.00015% to 0.5%, and the potassium salt is present from 0.002% to 20%, b) when the composition is formulated as a concentrate, betaine is present from 0.05% to 8.5%, and the potassium salt is present from 1% to 67% based on the total weight pervolume (w/v) of the composition, or c) when the composition is formulated in solid form, betaine and the potassium salt are present from 5% to 98% based on the total weight (w/w) of the composition.

128. The agricultural composition of claim 127, wherein the composition further comprises an anti-respirant, and the anti-respirant comprises a non-ionic surfactant.

129. The agricultural composition of claim 128, further comprising a second osmoprotectant, the first and second osmoprotectants being different from one another.

130. The composition of claim 128, wherein the betaine comprises glycine betaine, glycine betaine aldehyde, β-alanine betaine, betaine hydrochloride, cetyl betaine, proline betaine, choline-O-sulfate betaine, cocaamidopropyl betaine, oleyl betaine, sulfobetaine, lauryl betaine, octyl betaine, caprylamidopropyl betaine, lauramidopropyl betaine, isostearamidopropyl betaine, or a combination of any thereof.

131. The composition of claim 129, wherein:
the second osmoprotectant comprises proline, wherein the proline comprises L-proline, D-proline, hydroxyproline, proline betaine, or a combination of any thereof; or
the second osmoprotectant comprises trehalose.

132. The composition of claim 128, wherein the potassium salt of the anti-desiccant is derived from a fertilizer composition.

133. The composition of claim 128, wherein the anti-respirant comprises:
a polyvinyl alcohol, polyvinylpyrrolidone, a copolymer of polyvinyl alcohol and polyvinylpyrrolidone, polyoxyalkylene, an alkoxypolyoxyalkylene, a C₈-C₃₀ alkyl polyoxyalkylene, or a combination of any thereof; or
an alkylene glycol, and the alkylene glycol comprises ethylene glycol, polyethylene glycol, alkyl and alkyl lauryl polyoxyethylene glycol, an alkyl polysaccharide, an alkyl polyglucoside ester, polyethylene-polypropylene glycol, polyoxyethylene-polyoxypropylene and polyethylene glycol, hexylene glycol, or a combination of any thereof; or
a polyoxyalkylene or derivative thereof, and the polyoxyalkylene or derivative thereof comprises alkyl polyoxyethylene, methoxypolyoxyethylene, octyl polyoxyethylene, nonyl polyoxyethylene, decyl polyoxyethylene, undecyl polyoxyethylene, lauryl polyoxyethylene, tridecyl polyoxyethylene, tetradecyl polyoxyethylene, pentadecyl polyoxyethylene, hexadecyl polyoxyethylene, heptadecyl polyoxyethylene, octadecyl polyoxyethylene, coco polyoxyethylene, tallow polyoxyethylene, alkyl polyoxyethoxylate ether, alkyl phenol ethoxylate, a polyoxyethylene-polyoxypropylene block copolymer, or a combination of any thereof; or
succinic acid, an alphahydroxy acid, sucrose, urea, or polyethylene glycol (PEG).

134. The composition of claim 128, wherein:
the osmoprotectant comprises betaine hydrochloride, the anti-desiccant comprises potassium phosphate tribasic, and the anti-respirant comprises alkyl and alkyl lauryl polyoxyethylene glycol; or
the osmoprotectant comprises betaine hydrochloride, the anti-desiccant comprises potassium phosphate tribasic, and the anti-respirant comprises alkyl polyoxyethylene; or
the osmoprotectant comprises betaine hydrochloride, the anti-desiccant comprises potassium phosphate tribasic, and the anti-respirant comprises alkyl polyoxyethoxylate ether; or
the osmoprotectant comprises glycine betaine, the anti-desiccant comprises potassium phosphate dibasic, and the anti-respirant comprises polyvinylpyrrolidone
the osmoprotectant comprises betaine hydrochloride and the anti-respirant comprises alkyl and alkyl lauryl polyoxyethylene glycol; or
the osmoprotectant comprises glycine betaine, and the anti-desiccant comprises potassium phosphate dibasic; or
the osmoprotectant comprises betaine hydrochloride, and the anti-desiccant comprises potassium phosphate tribasic; or
the osmoprotectant comprises betaine hydrochloride and L-proline and the anti-respirant comprises alkyl and alkyl lauryl polyoxyethylene glycol.

135. The composition of claim 128, wherein:
the ready to use composition comprises the betaine in a concentration of from about 0.00015% to about 0.5%, from about 0.0016% to about 0.05%, from about 0.01% to about 0.05%, or from to about 0.00016% to about 0.032%, based on the total weight/volume (w/v) of the composition; or
the ready to use composition comprises the proline in a concentration of from about 0.001% to 0.020%, from about 0.015% to about 0.030%, from about 0.01% to about 0.05% or from about 0.05% to about 1.0%, based on the total weight/volume (w/v) of the composition; or
the ready to use composition comprises the proline in a concentration of from about 10 μM to about 42 μM, from about 30 μM to about 424 μM, or from about 400 μM to about 1270 μM; or
the ready to use composition comprises the anti-desiccant in a concentration of from about 0.002% to about 0.5%, from about 0.002% to about 0.005%, or from about 0.005% to about 0.5%, based on the total weight/volume (w/v) of the composition.

136. The composition of claim 128, wherein the composition is in concentrate form.

137. The composition of claim 136, wherein the concentrate composition comprises:
the betaine in a concentration of from about 5 mM to about 500 mM, from about 10 mM to about 100 mM, from about 150 mM to about 400 mM, or from about 400 mM to about 500 mM; or
the anti-desiccant in a concentration of from about 50 mM to about 3 M, from about 50 mM to about 300 mM, from about 50 mM to about 225 mM, from about 85 mM to about 200 mM, from about 200 mM to about 300 mM, or from about 200 mM to about 3 M; or
the osmoprotectant in an amount of from about 0.05% to about 8.5%, from about 0.0% to about 8.23%, from about 0.08% to about 0.27%, from about 0.85% to about 3.17%, or from about 5.66% to about 8.23%, based on the total weight/volume (w/v) of the concentrate composition; or
the anti-desiccant in an amount of from about 0.5% to about 100%, from about 1.0% to about 67%, or from about 2% to about 25%, based on the total weight/volume (w/v) of the composition; or
the anti-respirant in an amount of from about 1.0% to about 99.8%, from about 1.0% to about 75%, from about 1.0% to about 50%, from about 1.0% to about 46%, from about 3.0% to about 40%, or from about 30% to about 38%, based on the total weight/volume (w/v) of the concentrate composition.

138. The composition of claim 128, wherein the composition further comprises:
a wetting agent, an antifoaming agent, a buffering agent, a fixing agent, a microbiostat, a preservative, an antioxidant, a surfactant, a chelating agent, or a combination thereof; or
a pesticide, a fertilizer, a plant growth regulator, a bio-control agent, a bio-stimulant, seaweed extract, or a combination of any thereof.

139. The composition of claim 138, wherein the pesticide comprises a fungicide, an insecticide, an acaricide, an herbicide, a bactericide, a nematicide, or a combination of any thereof; or
the fertilizer comprises a nitrogen fertilizer, a phosphorous fertilizer, a manganese fertilizer, or a combination of any thereof.

140. The composition of claim 138, wherein the fungicide comprises:
a strobilurin, a conazole, or a combination thereof; or
pyraclostrobin, metconazole, or a combination thereof; or
azoxystrobin; or
trifloxystrobin, prothioconazole, or a combination thereof.

141. The composition of claim 128, wherein the composition is in the form of a dry powder or a water dispersible granule.

142. A method for increasing crop productivity of a plant by increasing protection against drought, wherein the method comprises exogenously applying to the plant a composition comprising an osmoprotectant, an anti-desiccant, and an anti-respirant within a treatment period, wherein the osmoprotectant comprises betaine, the anti-desiccant comprises potassium phosphate monobasic, potassium phosphate dibasic, potassium phosphate tribasic, potassium acetate, potassium chloride, potassium nitrate, potassium sulfate, dipotassium phosphate, potassium ammonium phosphate, potassium bicarbonate, or a combination of any thereof, and the antiperspirant comprises a non-ionic surfactant.

143. The method of claim 142, further comprising:
applying the osmoprotectant in an amount from about 29.57 to about 1774.41 mL per hectare, or from about 29.57 to about 739.34 mL per hectare; or
applying the betaine in an amount of from about 29.57 to about 1774.41 mL per hectare, from about 29.57 to about 414.03 mL per hectare, or from about 207.02 to about 739.34 mL per hectare; or
applying the antiperspirant in an amount of from about 29.57 to about 1478.68 mL per hectare, or from about 29.57 to about 739.34 mL per hectare.

144. The method of claim 142, further comprising:
applying the betaine in an amount from about 0.94 grams per hectare to about 30 grams per hectare; or
applying the anti-desiccant in an amount from about 0.9 grams per hectare to about 28.3 grams per hectare.

145. The method of claim 142, wherein:
the composition is applied one or more times during a growing season; or
the composition is applied more than one time during the growing season, and wherein the first administration occurs at or before the V8 stage of development and subsequent administrations occur before the plant flowers; or
the composition is applied as a seed treatment, or as a soil treatment applied to the area surrounding a plant, plant part or seed; or
the composition is applied exogenously to plants or plant parts as a foliar spray, an in-furrow spray, a drench, or impregnated on soil or soilless particle or matrix which allows for direct contact to a plant, a plant part, or a plant seed; or
the composition is applied as an aqueous solution, an emulsion, a suspension, a granular composition, or a powder; or
the treatment period is from about V2 to about R8, from about V3 to about V8, from about VT to about R2, from about R2 to about R8, from before the VE stage of development to about R8, or from before the VE stage of development to about V3; or
applying to a seed of the plant a seed treatment comprising a pesticide prior to applying the composition to the plant.

146. The method of claim 142, wherein the composition further comprises a proline, a sugar alcohol or a carbohydrate.

147. The method of claim 146, wherein:
proline is applied in an amount of from about 8.87 to about 2365.88 mL per hectare, or from about 236.59 to about 709.76 mL per hectare; or
proline is applied in an amount from about 1.4 grams per hectare to about 44.1 grams per hectare; or
the proline comprises L-proline, D-proline, hydroxyproline, proline betaine, or a combination of any thereof.

148. The method of claim 142, wherein the betaine comprises glycine betaine, glycine betaine aldehyde, β-alanine betaine, betaine hydrochloride, cetyl betaine, proline betaine, choline-O-sulfate betaine, cocaamidopropyl betaine, oleyl betaine, sulfobetaine, lauryl betaine, octyl betaine, caprylamidopropyl betaine, lauramidopropyl betaine, isostearamidopropyl betaine, or a combination of any thereof.

149. The method of claim 146, wherein:
the composition comprises betaine hydrochloride and L-proline; or
the composition comprises glycine-betaine and L-proline; or
the composition comprises betaine hydrochloride and proline betaine;
the composition comprises betaine hydrochloride and trehalose;
the composition comprises the betaine and sucrose.

150. The method of claim 142, wherein the anti-respirant comprises:
a polyvinyl alcohol, a polyvinylpyrrolidone, a copolymer of polyvinyl alcohol and polyvinylpyrrolidone, polyoxyalkylene, an alkoxypolyoxyalkylene, a C8-C30 alkyl polyoxyalkylene, or a combination of any thereof; or
an alkylene glycol, and the alkylene glycol comprises ethylene glycol, polyethylene glycol, alkyl and alkyl lauryl polyoxyethylene glycol, an alkyl polysaccharide, an alkyl polyglucoside ester, polyethylene-polypropylene glycol, polyoxyethylene-polyoxypropylene and polyethylene glycol, hexylene glycol, or a combination of any thereof; or a polyoxyalkylene, and the polyoxyalkylene comprises alkyl polyoxyethylene, methoxypolyoxyethylene, octyl polyoxyethylene, nonyl polyoxyethylene, decyl polyoxyethylene, undecyl polyoxyethylene, lauryl polyoxyethylene, tridecyl polyoxyethylene, tetradecyl polyoxyethylene, pentadecyl polyoxyethylene, hexadecyl polyoxyethylene, heptadecyl polyoxyethylene, octadecyl polyoxyethylene, coco polyoxyethylene, tallow polyoxyethylene, alkyl polyoxyethoxylate ether, alkyl phenol ethoxylate, a polyoxyethylene-polyoxypropylene block copolymer, or a combination of any thereof; or
succinic acid, an alphahydroxy acid, sucrose, urea, or polyethylene glycol (PEG).

151. The method of claim 142, wherein:
the osmoprotectant comprises betaine hydrochloride, the anti-desiccant comprises potassium phosphate tribasic, and the anti-respirant comprises alkyl and alkyl lauryl polyoxyethylene glycol; or
the osmoprotectant comprises betaine hydrochloride and L-proline, the anti-desiccant comprises potassium phosphate tribasic, and the anti-respirant comprises alkyl and alkyl lauryl polyoxyethylene glycol; or
the osmoprotectant comprises betaine hydrochloride, the anti-desiccant comprises potassium phosphate tribasic, and the anti-respirant comprises alkyl polyoxyethylene; or
the osmoprotectant comprises betaine hydrochloride, the anti-desiccant comprises potassium phosphate tribasic, and the anti-respirant comprises alkyl polyoxyethoxylate ether; or
the osmoprotectant comprises glycine betaine, the anti-desiccant comprises potassium phosphate dibasic, and the anti-respirant comprises polyvinylpyrrolidone;
the osmoprotectant comprises betaine hydrochloride and L-proline, the anti-desiccant comprises potassium phosphate tribasic, and the anti-respirant comprises alkyl polyoxyethoxylate ether; or
the osmoprotectant comprises betaine hydrochloride and the anti-respirant comprises alkyl and alkyl lauryl polyoxyethylene glycol; or
the osmoprotectant comprises betaine hydrochloride and L-proline and the anti-respirant comprises alkyl and alkyl lauryl polyoxyethylene glycol; or
the osmoprotectant comprises betaine hydrochloride and L-proline, the anti-desiccant comprises potassium phosphate tribasic, and the anti-respirant comprises alkyl polyoxyethylene; or
the osmoprotectant comprises glycine betaine, and the anti-desiccant comprises potassium phosphate dibasic; or
the osmoprotectant comprises betaine hydrochloride, and the anti-desiccant comprises potassium phosphate tribasic; or
the osmoprotectant comprises betaine hydrochloride and L-proline, the anti-desiccant comprises potassium acetate, and the anti-respirant comprises alkyl and alkyl lauryl polyoxyethylene glycol.

152. The method of claim 146, wherein:
the sugar alcohol comprises D-mannitol, D-sorbitol, maltitol, erythritol, L-arabitol, xylitol, 1D-chiro-inositol, inositol, myo-inositol, galactinol, L-quebrachitol, D-pinitol, Dononitol, D-myo-inositol-1,3-diphosphate, galactinol, or a combination of any thereof; or
the carbohydrate comprises alpha-D-galactose, alpha-D-mannose, beta-D-mannose, beta-D-glucose, alpha-D-glucose, aldehydo-D-altrose, sucrose, D-fructose, trehalose, stachyose, raffinose, melibiose, beta-palatinose, beta-gentiobiose, beta-turanose, beta-maltose, alphamaltose, cellobiose, or a combination of any thereof.

153. The method of claim 142, wherein the ready to use composition comprises:
the osmoprotectant in a concentration of from about 0.00010% to about 17%, from about 0.00010% to about 0.05%, 0.00015% to about 0.05%, from about 0.01% to about 0.02%, from about 0.022% to about 0.032%, from about 0.05% to about 0.25%, from about 1.5% to about 6.0%, or from about 6.5% to about 17%, based on the total weight/volume (w/v) of the composition; or
the betaine in a concentration of from about 0.00015% to about 0.5%, from about 0.0016% to about 0.05%, from about 0.01% to about 0.05%, or from to about 0.00016% to about 0.032%, based on the total weight/volume (w/v) of the composition; or
the anti-desiccant in a concentration of from about 0.002% to about 0.5%, from about 0.002% to about 0.005%, or from about 0.005% to about 0.5%, based on the total weight/volume (w/v) of the composition.

154. The method of claim 142, wherein the concentrate composition comprises:
the betaine in a concentration of from about 5 mM to about 500 mM, from about 10 mM to about 100 mM, from about 150 mM to about 400 mM, or from about 400 mM to about 500 mM; or
the anti-desiccant in a concentration of from about 50 mM to about 3 M, from about 50 mM to about 300 mM, from about 50 mM to about 225 mM, from about 85 mM to about 200 mM, from about 200 mM to about 300 mM, or from about 200 mM to about 3 M; or
the osmoprotectant in an amount of from about 0.05% to about 8.5%, from about 0.08% to about 8.23%, from about 0.08% to about 0.27%, from about 0.85% to about 3.17%, or from about 5.66% to about 8.23%, based on the total weight/volume (w/v) of the composition; or
the anti-desiccant in an amount of from about 1.0% to about 67%, or from about 2% to about 25%, based on the total weight/volume (w/v) of the composition; or
the antiperspirant in an amount of from about 1.0% to about 50%, from about 1.0% to about 46%, from about 3.0% to about 40%, or from about 30% to about 38%, based on the total weight/volume (w/v) of the concentrate composition.

155. The method of claim 142, wherein the composition further comprises:
a wetting agent, an antifoaming agent, a buffering agent, a fixing agent, a microbiostat, a preservative, an antioxidant, a surfactant, a chelating agent, or a combination thereof; and/or
a pesticide, a fertilizer, a plant growth regulator, a bio-control agent, a bio-stimulant, seaweed extract, or a combination of any thereof; and/or
a fungicide, an insecticide, an acaricide, an herbicide, a bactericide, a nematicide, or a combination of any thereof; and/or
a fertilizer, and the fertilizer comprises a nitrogen fertilizer, a phosphorous fertilizer, a manganese fertilizer, or a combination of any thereof.

156. The method of claim 155, wherein the fungicide comprises:
a strobilurin, a conazole, or a combination thereof; or
pyraclostrobin, metconazole, or a combination thereof; or
azoxystrobin; or
trifloxystrobin, prothioconazole, or a combination thereof.
